(19) United States
(12) Patent Application Publication
(10) Pub. No.: US 2019/0316036 A1
(43) Pub. Date: Oct. 17, 2019

(54) OPTICALLY ISOTROPIC LIQUID CRYSTAL MEDIUM AND OPTICAL DEVICE

(71) Applicants: JNC CORPORATION, Tokyo (JP); JNC PETROCHEMICAL CORPORATION, Tokyo (JP)

(72) Inventors: Hitoshi TOBATA, Chiba (JP); Eiji OKABE, Chiba (JP)

(73) Assignees: JNC CORPORATION, Tokyo (JP); JNC PETROCHEMICAL CORPORATION, Tokyo (JP)

(21) Appl. No.: 16/313,467

(22) PCT Filed: Jun. 22, 2017
(86) PCT No.: PCT/JP2017/023049

§ 371 Date: Dec. 27, 2018

(30) Foreign Application Priority Data
Jun. 27, 2016 (JP) 2016-126652

(51) Int. Cl. C09K 19/34; C09K 19/58; C09K 19/54; G02F 1/1343; G02F 1/1333

(52) U.S. Cl. CPC C09K 19/3402; C09K 19/586; C09K 2019/0466; G02F 1/134309; G02F 1/133365; C09K 19/542

(57) ABSTRACT

A liquid crystal composition that contains achiral component T including at least one compound selected from the group of compounds represented by formula (1) and at least one compound selected from the group of compounds represented by formula (2), and a chiral agent to develop an optically isotropic liquid crystal phase. In formulas (1) and (2), R¹ and R² are independently alkoxyalkyl; Z¹¹, Z¹², Z²¹ and Z²² are independently a single bond; L¹¹ to L¹³, L²¹ and L²² are independently fluorine; and Y¹ and Y² are independently fluorine, for example.

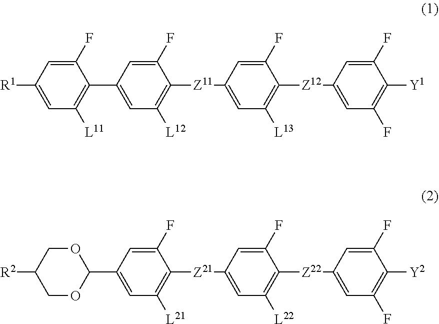

### TECHNICAL FIELD

The invention relates to a liquid crystal compound useful as a material for an optical device, for example, a liquid crystal composition, an optical device in which the liquid crystal composition is used, and so forth.

### BACKGROUND ART

A liquid crystal display device in which a liquid crystal composition is used is widely used in a display of a watch, a calculator, a cellular phone, a personal computer, a television and so forth. The liquid crystal display devices utilize refractive index anisotropy or dielectric anisotropy of a liquid crystal compound, or the like. As an operating mode of the liquid crystal display device, a twisted nematic (TN) mode, a super twisted nematic (STN) mode, a bistable twisted nematic (BTN) mode, an electrically controlled birefringence (ECB) mode, an optically compensated bend (OCB) mode, an in-plane switching (IPS) mode, a vertical alignment (VA) mode or the like in which an image is displayed mainly by using one or more polarizing plates is known. Further, a research has been recently conducted on a mode in which an electric field is applied thereto in an optically isotropic liquid crystal phase to develop electric birefringence (Patent literature Nos. 1 to 9 and Non-patent literature Nos. 1 to 3).

Further, proposals have been made on a wavelength variable filter, a wavefront control device, a liquid crystal lens, an aberration correction device, an aperture control device, an optical head apparatus and so forth in which electric birefringence in a blue phase that is one of optically isotropic liquid crystal phases is utilized (Patent literature Nos. 7 to 9).

A classification based on a driving mode in the device includes a passive matrix (PM) and an active matrix (AM). The passive matrix (PM) is classified into static, multiplex and so forth, and the AM is classified into a thin film transistor (TFT), a metal insulator metal (MIM) and so forth according to a kind of a switching device thereof.

### CITATION LIST

### Patent Literature

Patent literature No. 1: WO 2010/058681 A.
Patent literature No. 2: WO 2010/089092 A.
Patent literature No. 3: WO 2012/100809 A.
Patent literature No. 4: US 20130135544 A.
Patent literature No. 5: WO 2013/156113 A.
Patent literature No. 6: WO 2014/097952 A.
Patent literature No. 7: JP 2005-157109 A.
Patent literature No. 8: WO 2005/80529 A.
Patent literature No. 9: JP 2006-127707 A.

### Non-Patent Literature

Non-patent literature No. 1: Nature Materials, 1, 64, (2002).
Non-patent literature No. 2: Adv. Mater., 17, 96, (2005).
Non-patent literature No. 3: Journal of the SID, 14, 551, (2006).

### SUMMARY OF INVENTION

### Technical Problem

Under the situations described above, a liquid crystal medium having stability to heat, light and so forth, a wide liquid crystal phase temperature range and significantly large dielectric anisotropy to develop an optically isotropic liquid crystal phase is required. Moreover, various optical devices that can be used in a wide temperature range, and have a short response time, a large contrast ratio and a low driving voltage are required.

### Solution to Problem

The invention provides a liquid crystal compound, a liquid crystal medium (a liquid crystal composition, a polymer-liquid crystal composite material or the like), a mixture of a polymerizable monomer and the liquid crystal composition, an optical device including the liquid crystal medium or the like as described below, for example.

The invention provides a compound, the liquid crystal medium (the liquid crystal composition or the polymer-liquid crystal composite material) and the optical device including the liquid crystal medium, or the like as described below.

Item 1. A liquid crystal composition that contains achiral component T including at least one compound selected from the group of compounds represented by formula (1) and at least one compound selected from the group of compounds represented by formula (2), and a chiral agent to develop an optically isotropic liquid crystal phase:

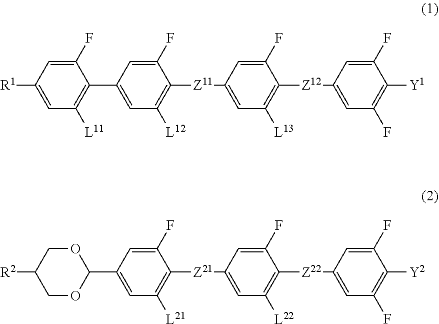

wherein, in formulas (1) and (2), R¹ and R² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12, in which at least one of R¹ and R² is alkoxyalkyl in which a total of the number of carbons is 1 to 12; Z¹¹, Z¹², Z²¹ and Z²² are independently a single bond, —COO— and —CF₂O—, in which one of Z¹¹ and Z¹² is —CF₂O— or —COO—, and the other is a single bond, and one of Z²¹ and Z²² is —CF₂O— or —COO—, and the other is a single bond; L¹¹ to L¹³, L²¹ and L²² are independently hydrogen, fluorine or chlorine; and Y¹ and Y² are independently fluorine, chlorine, —CF₃ or —OCF₃.

Item 2. The liquid crystal composition according to item 1, wherein a proportion of the compound represented by formula (1) is in the range of 5% by weight to 65% by weight, and a proportion of the compound represented by formula (2) is in the range of 25% by weight to 90% by weight, based on the weight of the liquid crystal composition.

Item 3. The liquid crystal composition according to item 1 or 2, containing at least one compound selected from the group of compounds represented by formula (1′) as a first component, at least one compound selected from the group of compounds represented by formula (2′) as a second component and at least one compound selected from the group of compounds represented by formula (3) as a third component:

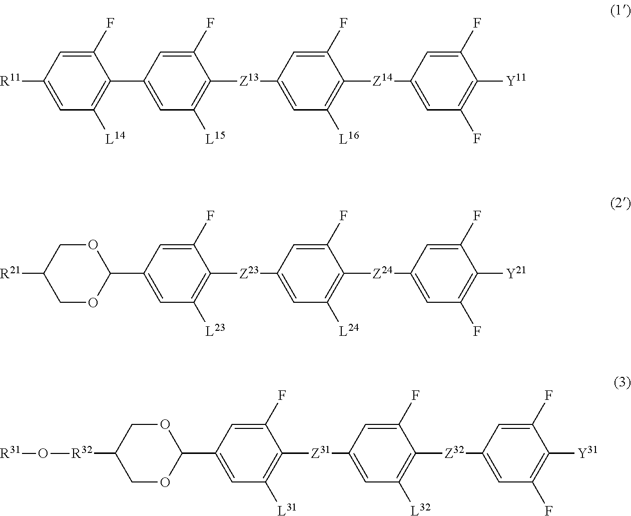

wherein, in formulas (1′), (2′) and (3), R¹¹ and R²¹ are independently alkyl having 1 to 12 carbons, alkenyl having 2 to 12 carbons, alkynyl having 2 to 12 carbons or alkoxy having 1 to 11 carbons; R³¹ is independently alkyl having 1 to 12 carbons, alkenyl having 2 to 12 carbons, alkynyl having 2 to 12 carbons or alkoxy having 1 to 11 carbons; R³² is alkylene having 1 to 5 carbons, alkenylene having 2 to 5 carbons or alkynylene having 2 to 5 carbons; Z¹³, Z¹⁴, Z²³, Z²⁴, Z³¹ and Z³² are independently a single bond, —COO— and —CF₂O—, in which one of Z¹³ and Z¹⁴ is —CF₂O— or —COO—, and the other is a single bond, one of Z²³ and Z²⁴ is —CF₂O— or —COO—, and the other is a single bond, and one of Z³¹ and Z³² is —CF₂O— or —COO—, and the other is a single bond; L¹⁴ to L¹⁶, L²³, L²⁴, L³¹ and L³² are independently hydrogen, fluorine or chlorine; and Y¹¹, Y²¹ and Y³¹ are independently fluorine, chlorine, —CF₃ or —OCF₃.

Item 4. The liquid crystal composition according to item 3, wherein a proportion of the compound represented by formula (1′) is in the range of 5% by weight to 65% by weight, a proportion of the compound represented by formula (2′) is in the range of 15% by weight to 80% by weight, and a proportion of the compound represented by formula (3) is in the range of 2% by weight to 40% by weight, based on the weight of the liquid crystal composition.

Item 5. The liquid crystal composition according to item 3 or 4, containing at least one compound selected from the group of compounds represented by formula (1′-1), and at least one compound selected from the group of compounds represented by formula (1′-2) as the first component:

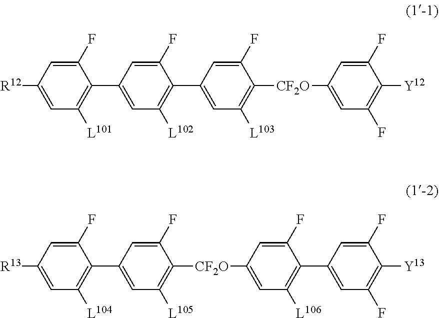

wherein, in formulas (1′-1) and (1′-2), R¹² and R¹³ are independently alkyl having 1 to 12 carbons, alkenyl having 2 to 12 carbons, alkynyl having 2 to 12 carbons or alkoxy having 1 to 11 carbons; L¹⁰⁵ to L¹⁰⁵, and L¹⁰⁶ are independently hydrogen, fluorine or chlorine; and Y¹² and Y¹³ are independently fluorine, chlorine, —CF₃ or —OCF₃.

Item 6. The liquid crystal composition according to item 5, containing at least one compound selected from the group of compounds represented by formulas (1′-1-1) to (1′-1-3), and at least one compound selected from the group of compounds represented by formulas (1′-2-1) to (1′-2-6) as the first component:

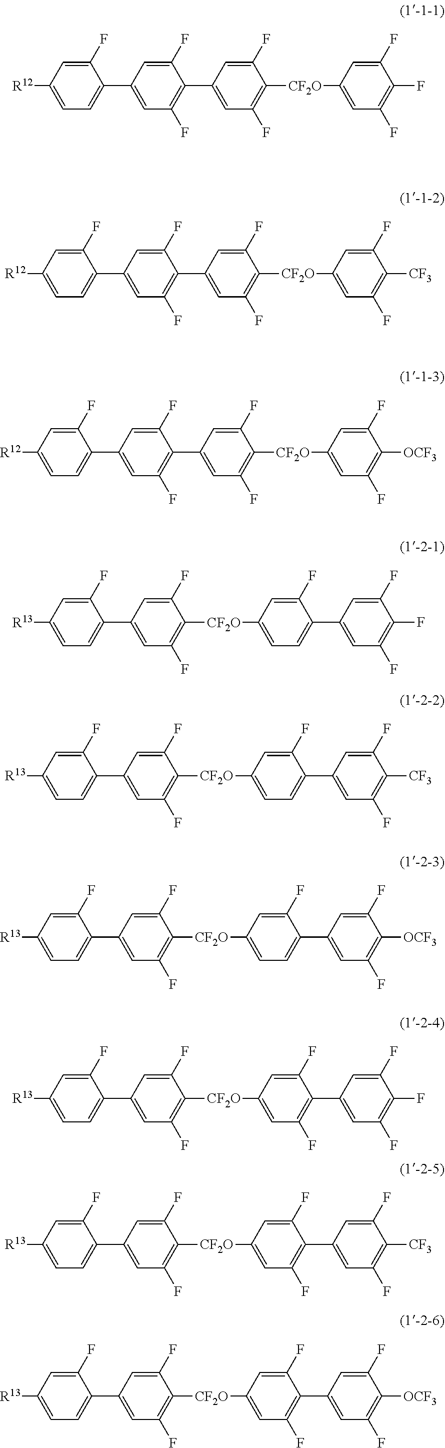

wherein, in the formulas, R¹² and R¹³ are independently alkyl having 1 to 12 carbons, alkenyl having 2 to 12 carbons, alkynyl having 2 to 12 carbons or alkoxy having 1 to 11 carbons.

Item 7. The liquid crystal composition according to any one of items 3 to 6, containing at least one compound selected from the group of compounds represented by formula (2′-1), and at least one compound selected from the group of compounds represented by formula (2′-2) as the second component:

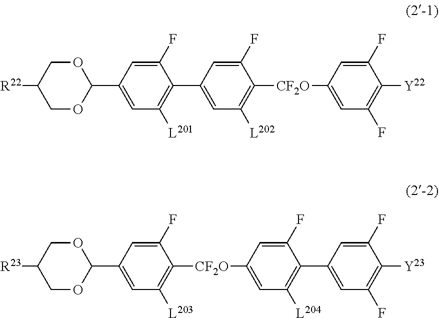

wherein, in formulas (2′-1) and (2′-2), R²² and R²³ are independently alkyl having 1 to 12 carbons, alkenyl having 2 to 12 carbons, alkynyl having 2 to 12 carbons or alkoxy having 1 to 11 carbons; L²⁰¹ to L²⁰³ and L²⁰⁴ are independently hydrogen, fluorine or chlorine; and Y²² and Y²³ are independently fluorine, chlorine, —CF₃ or —OCF₃.

Item 8. The liquid crystal composition according to item 7, containing at least one compound selected from the group of compounds represented by formulas (2′-1-1) to (2′-1-3), and at least one compound selected from the group of compounds represented by formulas (2′-2-1) to (2′-2-6) as the second component:

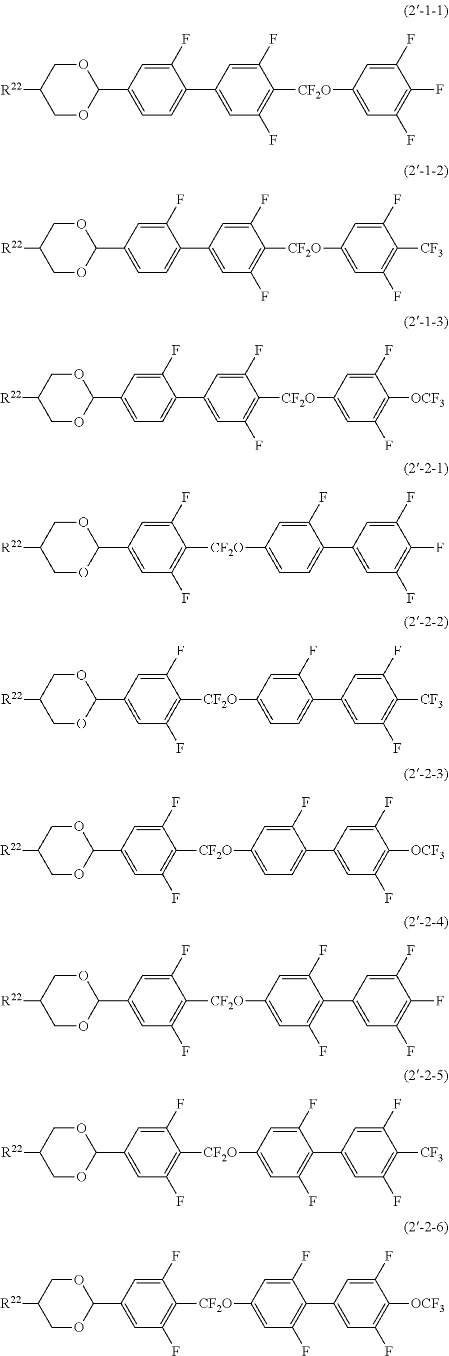

wherein, in the formulas, R²² and R²³ are independently alkyl having 1 to 12 carbons, alkenyl having 2 to 12 carbons, alkynyl having 2 to 12 carbons or alkoxy having 1 to 11 carbons.

Item 9. The liquid crystal composition according to any one of items 3 to 8, containing at least one compound selected from the group of compounds represented by formulas (3-1) and (3-2) as the third component:

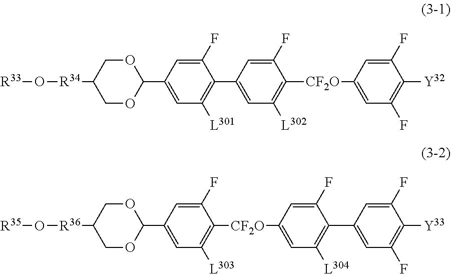

wherein in formulas (3-1) and (3-2), R³³ and R³⁵ are independently alkyl having 1 to 12 carbons, alkenyl having 2 to 12 carbons, alkynyl having 2 to 12 carbons or alkoxy having 1 to 11 carbons, and O atoms are not directly connected with each other; R³⁴ and R³⁶ are independently alkylene having 1 to 5 carbons, alkenylene having 2 to 5 carbons or alkynylene having 2 to 5 carbons; L³⁰ to L³⁰³ and L³⁰⁴ are independently hydrogen, fluorine or chlorine; and Y³² and Y³³ are independently fluorine, chlorine, —CF₃ or —OCF₃.

Item 10. The liquid crystal composition according to item 9, containing at least one compound selected from the group of compounds represented by formulas (3-1-1) to (3-1-3), and formulas (3-2-1) to (3-2-6) as the third component:

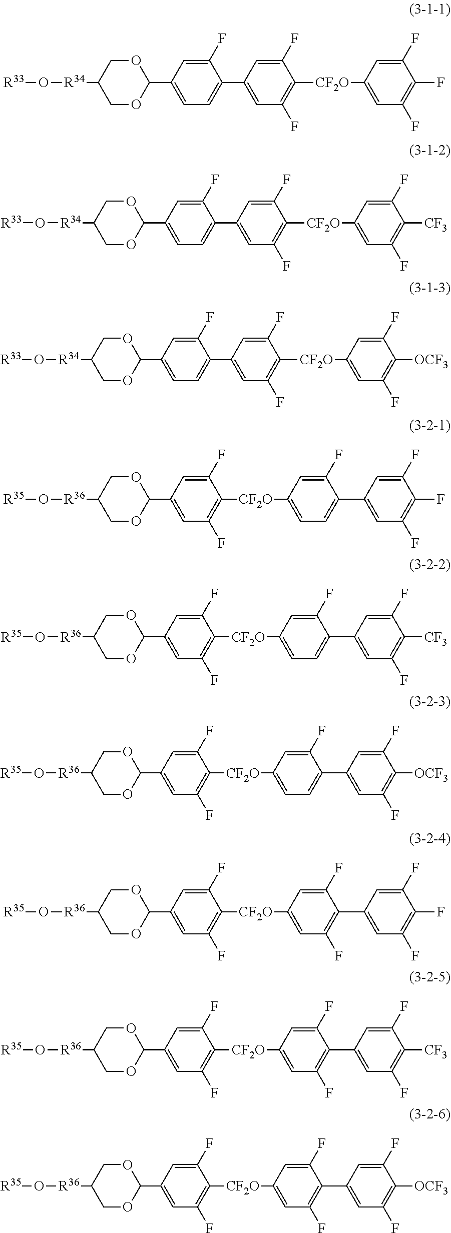

wherein, in the formulas, R³³ and R³⁵ are independently alkyl having 1 to 12 carbons, alkenyl having 2 to 12 carbons, alkynyl having 2 to 12 carbons or alkoxy having 1 to 11 carbons, and O atoms are not directly connected with each other; and R³⁴ and R³⁶ are independently alkylene having 1 to 12 carbons, alkenylene having 2 to 12 carbons or alkynylene having 2 to 12 carbons.

Item 11. The liquid crystal composition according to any one of items 1 to 10, further containing at least one compound selected from the group of compounds represented by formulas (4) and (5):

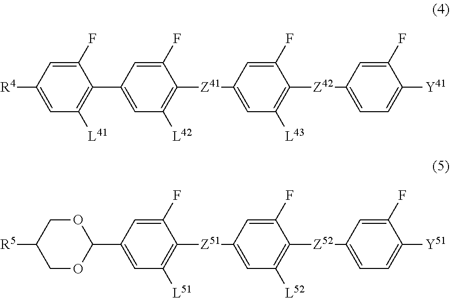

wherein, in formulas (4) and (5), R⁴ and R⁵ are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; Z⁴¹, Z⁴², Z⁵¹ and Z⁵² are independently a single bond, —COO— and —CF₂O—, in which one of Z⁴¹ and Z⁴² is —CF₂O— or —COO—, and the other is a single bond, and one of Z⁵¹ and Z⁵² is —CF₂O— or —COO—, and the other is a single bond; L⁴¹ to L⁴³, L⁵¹ and L⁵² are independently hydrogen, fluorine or chlorine; and Y⁴¹ and Y⁵¹ are independently fluorine, chlorine, —CF₃ or —OCF₃.

Item 12. The liquid crystal composition according to item 11, wherein a proportion of the compound represented by formulas (4) and (5) is in the range of 1% by weight to 25% by weight based on the weight of the liquid crystal composition.

Item 13. The liquid crystal composition according to item 11 or 12, containing at least one compound selected from the group of compounds represented by formulas (4-1), (4-2), (5-1) and (5-2):

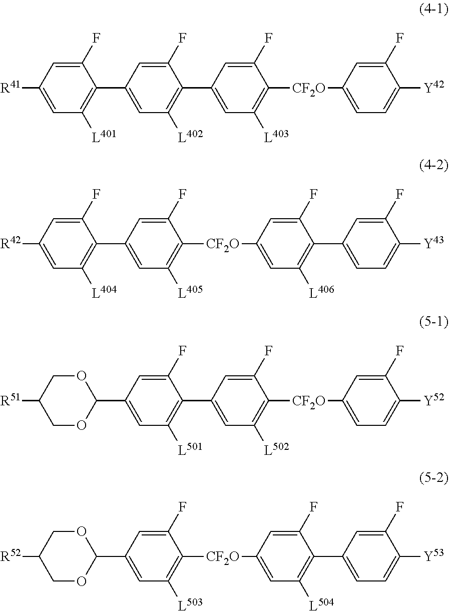

wherein, in formulas (4-1), (4-2), (5-1) and (5-2), R⁴¹, R⁴², R⁵¹ and R⁵² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; L⁴⁰¹ to L⁴⁰⁶, L⁵⁰¹ to L⁵⁰³ and L⁵⁰⁴ are independently hydrogen, fluorine or chlorine; and Y⁴², Y⁴³, Y⁵² and Y⁵³ are independently fluorine, chlorine, —CF₃ or —OCF₃.

Item 14. The liquid crystal composition according to item 13, containing at least one compound selected from the group of compounds represented by formulas (4-1-1) to (4-1-3), formulas (4-2-1) to (4-2-6), formulas (5-1-1) to (5-1-3) and formulas (5-2-1) to (5-2-6):

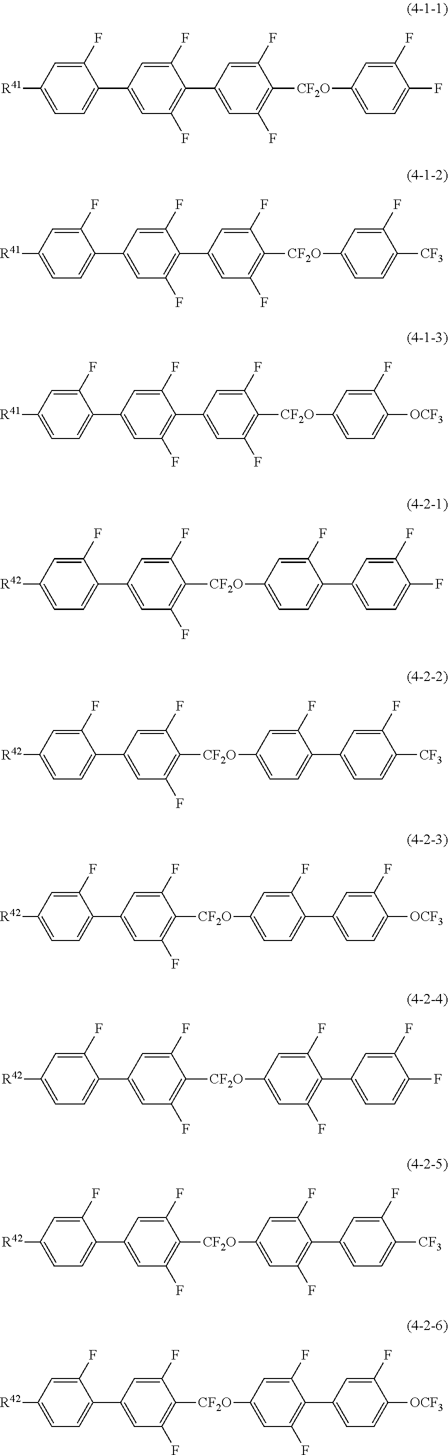

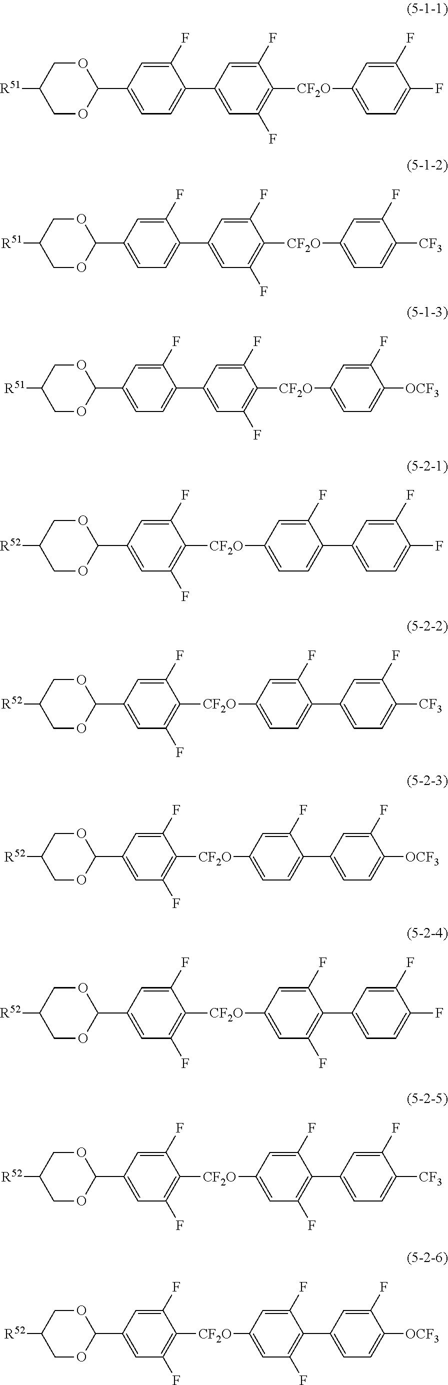

wherein, in the formulas, R⁴¹, R⁴², R⁵¹ and R⁵² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12.

Item 15. The liquid crystal composition according to any one of items 1 to 14, further containing at least one compound selected from the group of compounds represented by formulas (6) and (7):

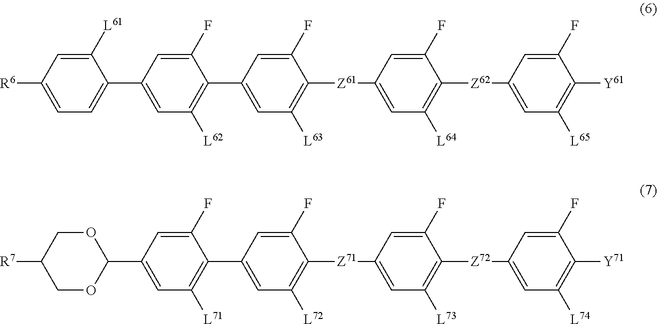

wherein, in formulas (6) and (7), R⁶ and R⁷ are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; Z⁶¹, Z⁶², Z⁷¹ and Z⁷² are independently a single bond, —COO— and —CF₂O—, in which one of Z⁶¹ and Z⁶² is —CF₂O— or —COO—, and the other is a single bond, and one of Z⁷¹ and Z⁷² is —CF₂O— or —COO—, and the other is a single bond; L⁶¹ to L⁶⁵, L⁷¹ to L⁷³ and L⁷⁴ are independently hydrogen, fluorine or chlorine; and Y⁶¹ and Y⁷¹ are independently fluorine, chlorine, —CF₃ or —OCF₃.

Item 16. The liquid crystal composition according to item 15, wherein a proportion of the compound represented by formulas (6) and (7) is in the range of 0.1% by weight to 20% by weight based on the weight of the liquid crystal composition.

Item 17. The liquid crystal composition according to item 15 or 16, containing at least one compound selected from the group of compounds represented by formulas (6-1), (6-2), (7-1) and (7-2):

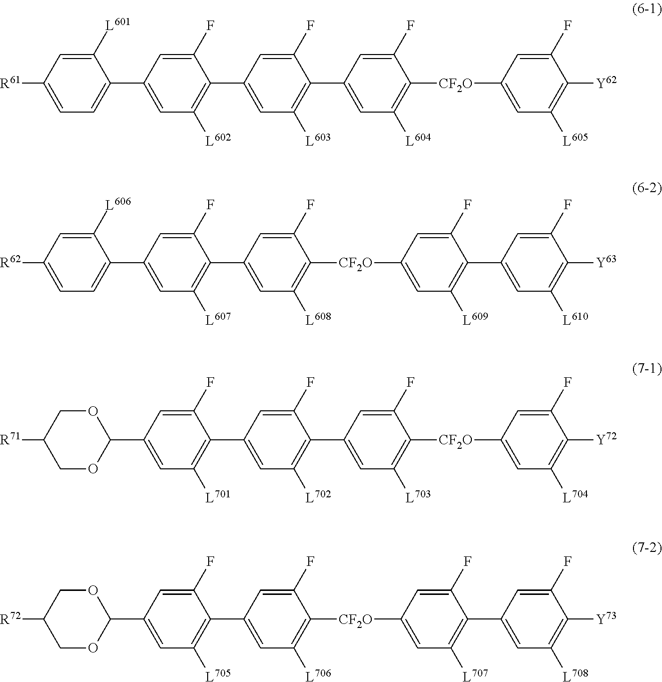

wherein, in formulas (6-1), (6-2), (7-1) and (7-2), R⁶¹, R⁶², R⁷¹ and R⁷² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; L⁶⁰¹ to L⁶¹⁰, L⁷⁰¹ to L⁷⁰⁷ and L⁷⁰⁸ are independently hydrogen, fluorine or chlorine; and Y⁶², Y⁶³, Y⁷² and Y⁷³ are independently fluorine, chlorine, —CF₃ or —OCF₃.

Item 18. The liquid crystal composition according to item 17, containing at least one compound selected from the group of compounds represented by formulas (6-1-1) to (6-1-6), formulas (6-2-1) to (6-2-6), formulas (7-1-1) to (7-1-6) and formulas (7-2-1) to (7-2-6):

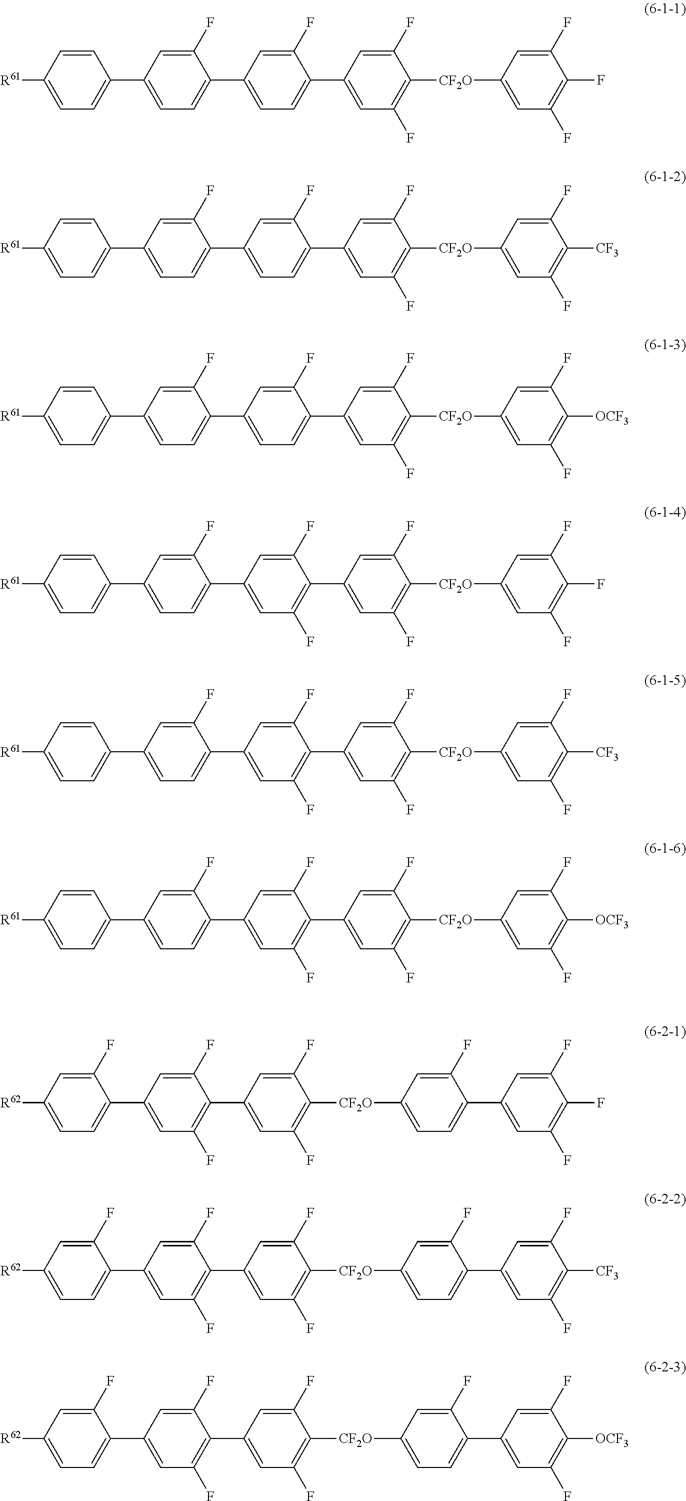

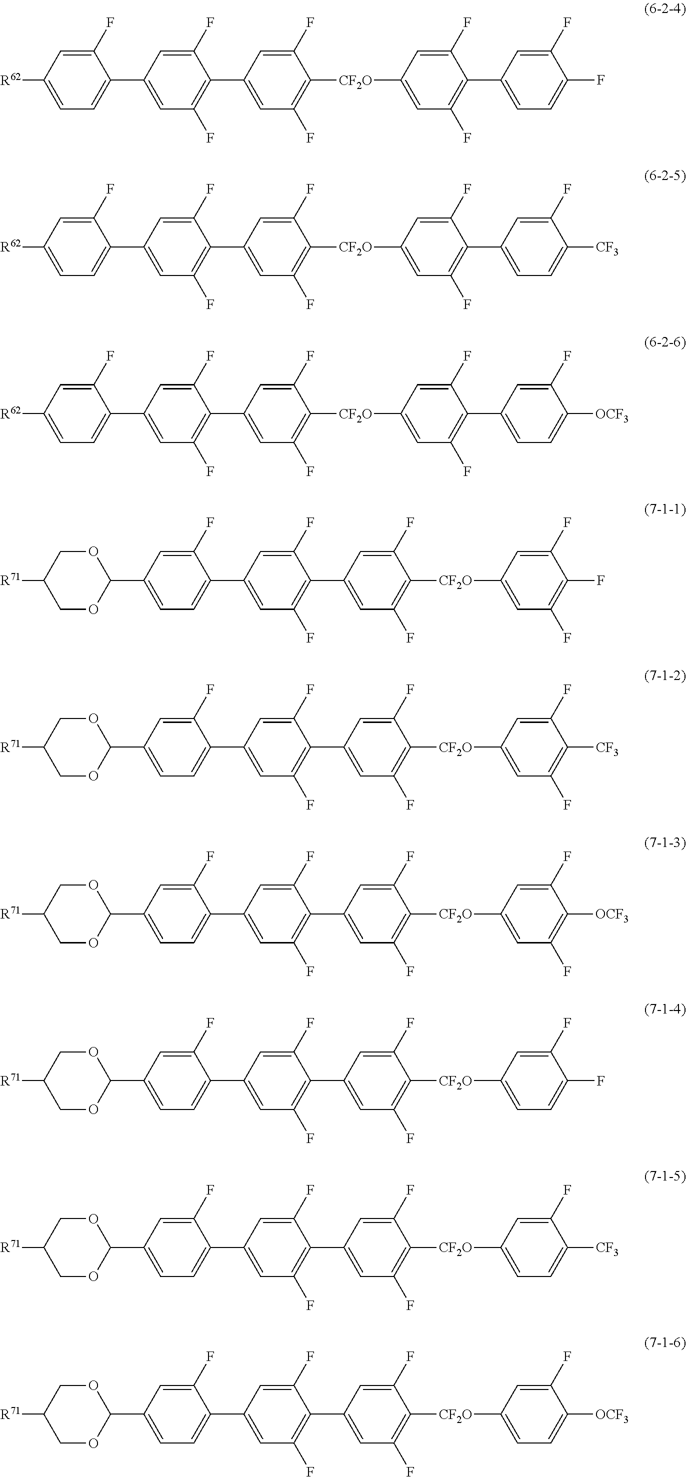

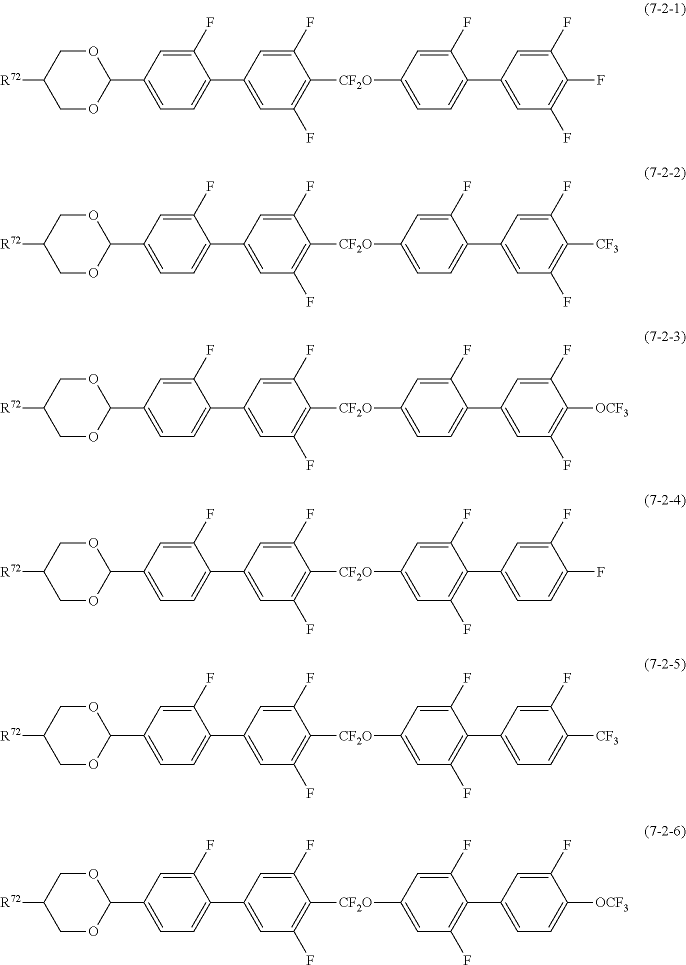

wherein, in the formulas, R⁶¹, R⁶², R⁷¹ and R⁷² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12.

Item 19. The liquid crystal composition according to any one of items 1 to 18, further containing at least one compound selected from the group of compounds represented by formula (8):

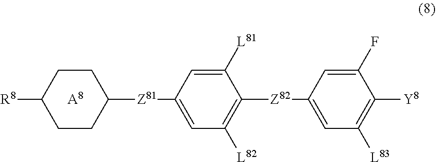

wherein, in formula (8), R⁸ is alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; ring A⁸ is 1,4-cyclohexylene, 1,4-phenylene, 2-fluoro-1,4-phenylene, 3-fluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl; Z⁸¹ and Z⁸² are independently a single bond, —COO—, —CH₂CH₂—, —CH₂O— and —CF₂O—; L⁸¹, L⁸² and L⁸³ are independently hydrogen, fluorine or chlorine; and Y⁸ is fluorine, chlorine, —CF₃ or —OCF₃.

Item 20. The liquid crystal composition according to item 19, wherein a proportion of the compound represented by formula (8) is in the range of 0.1% by weight to 15% by weight based on the weight of the liquid crystal composition.

Item 21. The liquid crystal composition according to item 19 or 20, containing at least one compound selected from the group of compounds represented by formulas (8-1) to (8-11):

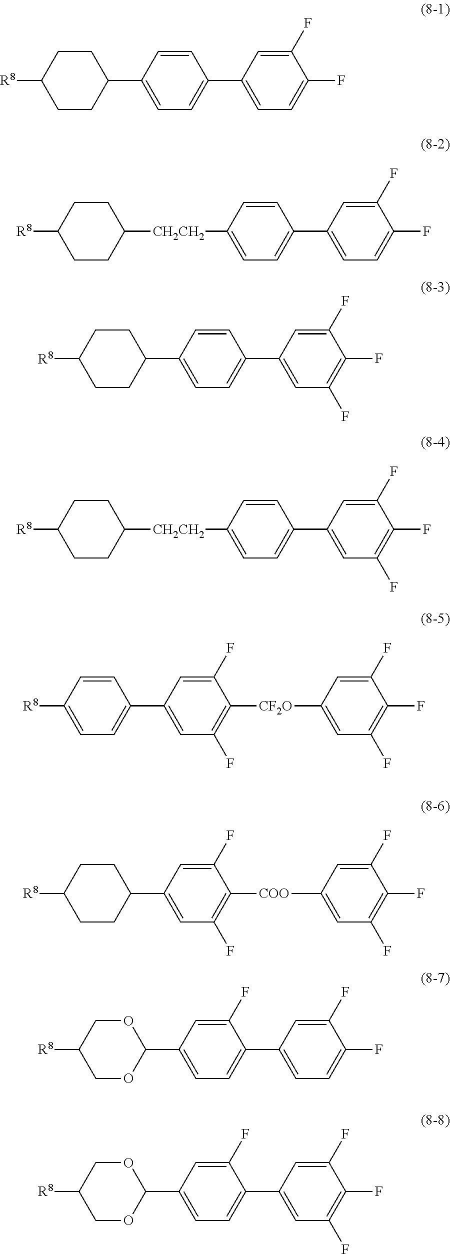

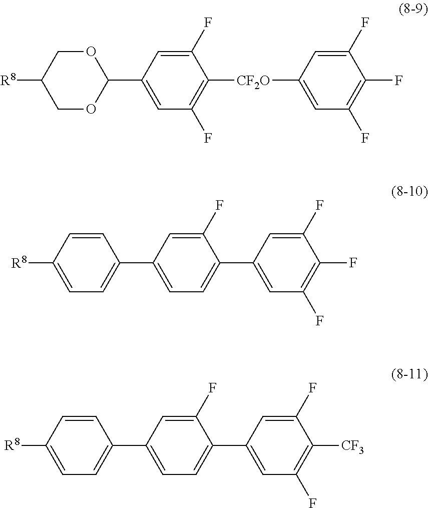

wherein, in the formulas, R⁸ is independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12.

Item 22. The liquid crystal composition according to any one of items 1 to 21, wherein the chiral agent is at least one compound selected from the group of compounds represented by formulas (K1) to (K6):

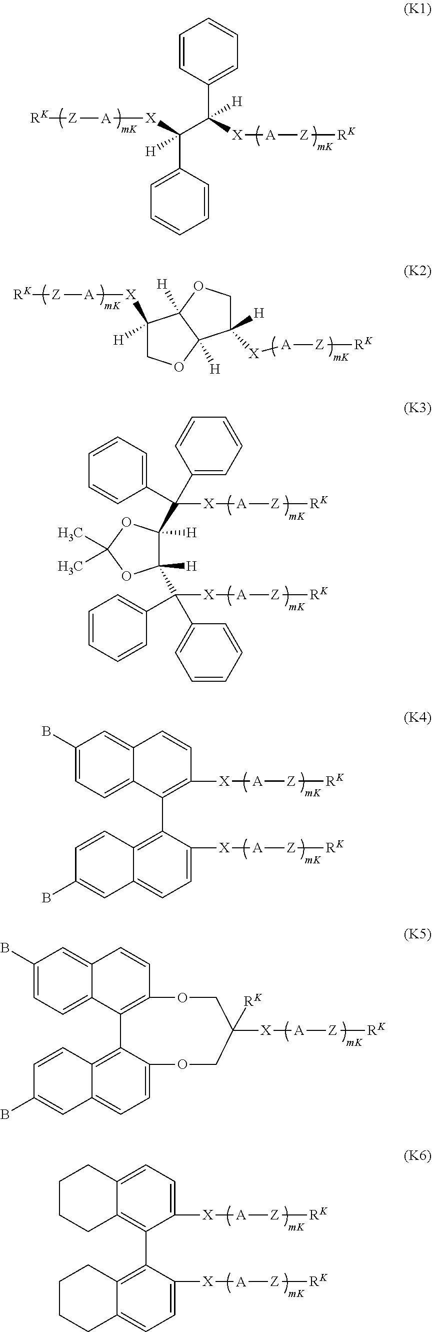

wherein, in the formulas, R^{K} is each independently hydrogen, halogen, —C≡N, —N═C═O, —N═C═S or alkyl having 1 to 20 carbons, and at least one —CH₂— in the alkyl may be replaced by —O—, —S—, —COO— or —OCO—, at least one —CH₂—CH₂— in the alkyl may be replaced by —CH═CH—, —CF═CF— or —C≡C—, and at least one hydrogen in the alkyl may be replaced by fluorine or chlorine;

A is each independently an aromatic 6-membered to 8-membered ring, a non-aromatic 3-membered to 8-membered ring or a fused ring having 9 or more carbons, and at least one hydrogen in the rings may be replaced by halogen, or alkyl or haloalkyl each having 1 to 3 carbons, —CH₂— in the rings may be replaced by —O—, —S— or —NH—, and —CH═ may be replaced by —N═;

B is each independently hydrogen, halogen, alkyl having 1 to 3 carbons, haloalkyl having 1 to 3 carbons, an aromatic 6-membered to 8-membered ring, a non-aromatic 3-membered to 8-membered ring or a fused ring having 9 or more carbons, and at least one hydrogen in the rings may be replaced by halogen, or alkyl or haloalkyl each having 1 to 3 carbons, —CH₂— in the alkyl may be replaced by —O—, —S— or —NH—, and —CH═ may be replaced by —N═;

Z is each independently a single bond and alkylene having 1 to 8 carbons, and at least one —CH₂— in the alkylene may be replace by —O—, —S—, —COO—, —OCO—, —CSO—, —OCS—, —N═N—, —CH═N— or —N═CH—, at least one —CH₂—CH₂— in the alkylene may be replaced by —CH═CH—, —CF═CF— or —C≡C—, and at least one hydrogen in the alkylene may be replaced by halogen;

X is each independently a single bond, —COO—, —OCO—, —CH₂O—, —OCH₂—, —CF₂O—, —OCF₂— or —CH₂CH₂—; and

mK is each independently an integer from 1 to 4.

Item 23. The liquid crystal composition according to any one of items 1 to 22, exhibiting a chiral nematic phase in any temperature from −20° C. to 70° C., and having a helical pitch of 700 nanometers or less in at least part of the temperature range.

Item 24. A mixture, containing the liquid crystal composition according to any one of items 1 to 23 and a polymerizable monomer.

Item 25. A polymer-liquid crystal composite material, obtained by polymerizing the mixture according to item 24 and used in a device driven in an optically isotropic liquid crystal phase.

Item 26. An optical device, having electrodes arranged on one or both of substrates, and having a liquid crystal medium arranged between the substrates, and an electric field applying means for applying an electric field to the liquid crystal medium through the electrodes, wherein the liquid crystal medium is the liquid crystal composition according to any one of items 1 to 23, or the polymer-liquid crystal composite material according to item 25.

Item 27. Use of the liquid crystal composition according to any one of items 1 to 23 or the polymer-liquid crystal composite material according to item 25 in an optical device.

A term “liquid crystal compound” herein represents a compound having a mesogen, and is not limited to a compound of developing a liquid crystal phase. Specifically, the term is a generic term for a compound of developing the liquid crystal phase such as a nematic phase and a smectic phase, and a compound having no liquid crystal phase but being useful as a component of the liquid crystal composition.

A term “liquid crystal medium” is a generic term for the liquid crystal composition and the polymer-liquid crystal composite.

A term“achiral component” means an achiral mesogen compound, and a component containing neither an optically active compound nor a compound having a polymerizable functional group.

Accordingly, “achiral component” does not include a chiral agent, a monomer, a polymerization initiator, an antioxidant, an ultraviolet light absorbent, a curing agent, a stabilizer or the like.

A term “chiral agent” means an optically active compound, and a component added for providing the liquid crystal composition with desired twisted molecular arrangement.

A term “liquid crystal display device” is a generic term for a liquid crystal display panel and a liquid crystal display module.

Moreover, a term “optical device” means various devices that exerts a function of optical modulation, optical switching or the like by utilizing an electro-optic effect, and specific examples include an optical modulator used in a display device (liquid crystal display device), an optical communication system, optical information processing and various sensor systems. With regard to the optical modulation that utilizes a change of a refractive index by applying voltage to an optically isotropic liquid crystal medium, a Kerr effect is known. The Kerr effect means a phenomenon in which a value of electric birefringence Δn (E) is proportional to a square of electric field E, and an equation: Δn (E)=KλE² holds in a material exhibiting the Kerr effect (K: Kerr coefficient (Kerr constant), λ: wavelength). Here, the value of electric birefringence means a value of refractive index anisotropy induced when the electric field is applied to an isotropic medium.

“Liquid crystal compound,” “liquid crystal composition” and “liquid crystal display device” may be occasionally abbreviated as “compound,” “composition” and “device,” respectively.

Moreover, for example, a maximum temperature of the liquid crystal phase is a phase transition temperature between the liquid crystal phase and an isotropic phase, and may be occasionally abbreviated simply as a clearing point or maximum temperature. A minimum temperature of the liquid crystal phase may be occasionally abbreviated simply as minimum temperature. A compound represented by formula (1) may be occasionally abbreviated as compound 1. The abbreviation may occasionally apply also to a compound represented by formula (2) or the like. In formula (8), symbol A⁸ or the like surrounded by a hexagonal shape corresponds to ring A⁸ or the like, respectively. An amount of compound expressed in terms of percentage is expressed in terms of weight percentage (% by weight) based on the total weight of the composition. A plurality of identical symbols such as ring A and Z are described in identical formulas or different formulas, but the symbols may be identical or different.

Alkyl herein may have a straight chain or a branched chain, and specific examples of the alkyl include —CH₃, —C₂H₅, —C₃H₇, —C₄H₉, —C₅H₁₁, —C₆H₁₃, —C₇H₁₅, —C₈H₁₇, —C₉H₉, —C₁₀H₂₁, —C₁₁H₂₃ and —C₁₂H₂₅.

Alkoxy herein may have a straight chain or a branched chain, and specific examples of the alkoxy include —OCH₃, —OC₂H₅, —OC₃H₇, —OC₄H₉, —OCH₁₁, —OC₆H₁₃, —OC₇H₁₅, —OC₈H₁₇, —OC₉H₁₉, —OC₁₀H₂₁ and —OC₁₁H₂₃.

Alkylene herein may have a straight chain or a branched chain, and specific examples of the alkylene include —CH₂—, —C₂H₄—, —C₃H₆—, —C₄H₈—, —C₅H₁₀—, —C₆H₁₂—, —C₇H₁₄—, —C₈H₁₆—, —C₉H₁₈—, —C₁₀H₂O—, —C₁₁H₂₂— and —C₁₂H₂₄—.

Alkoxyalkyl herein may have a straight chain or a branched chain, and specific examples of the alkoxyalkyl include —CH₂OCH₃, —CH₂OC₂H₅, —CH₂OC₃H₇, —CH₂OC₄H₉, —CH₂OC₅H₁₁, —(CH₂)₂—OCH₃, —(CH₂)₂—OC₂H₅, —(CH₂)₂—OC₃H₇, —(CH₂)₃—OCH₃, —(CH₂)₄—OCH₃ and —(CH₂)₅—OCH₃.

Alkenyl herein may have a straight chain or a branched chain, and specific examples of the alkenyl include —CH═CH₂, —CH═CHCH₃, —CH₂CH═CH₂, —CH═CHC₂H₅, —CH₂CH═CHCH₃, —(CH₂)₂—CH═CH₂, —CH═CHC₃H₇, —CH₂CH═CHC₂H₅, —(CH₂)₂—CH═CHCH₃ and —(CH₂)₃—CH═CH₂.

A preferred configuration of —CH═CH— herein depends on a position of a double bond. A trans configuration is preferred in alkenyl having the double bond in an odd-numbered position, such as —CH═CHCH₃, —CH═CHC₂H₅, —CH═CHC₃H₇, —CH═CHC₄H₉, —C₂H₄CH═CHCH₃ and —C₂H₄CH═CHC₂H₅. A cis configuration is preferred in alkenyl having the double bond in an even-numbered position, such as —CH₂CH═CHCH₃, —CH₂CH═CHC₂H₅ and —CH₂CH═CHC₃H₇.

An alkenyl compound having the preferred configuration has high maximum temperature or a wide temperature range of the liquid crystal phase. A detailed description is found in Mol. Cryst. Liq. Cryst., 1985, 131, 109 and Mol. Cryst. Liq. Cryst., 1985, 131, 327. Moreover, as a position of an alkenyl group, a position in which no conjugation is formed with a benzene ring is preferred.

Alkenylene herein may have a straight chain or a branched chain, and specific examples of the alkenylene include —CH═CH—, CH═CHCH₂—, —CH₂CH═CH—, —CH═CHC₂H₄—, —CH₂CH═CHCH₂—, —(CH₂)₂—CH═CH—, —CH═CHC₃H₆—, —CH₂CH═CHC₂H₄—, —(CH₂)₂—CH═CHCH₂— and —(CH₂)₃—CH═CH—.

Alkenyloxy herein may have a straight chain or a branched chain, and specific examples of the alkenyloxy include —OCH₂CH═CH₂, —OCH₂CH═CHCH₃ and —OCH₂CH═CHC₂H₅.

Alkynyl herein may have a straight chain or a branched chain, and specific examples of the alkynyl include —C≡CH, —C≡CCH₃, —CH₂C≡CH, —C≡CC₂H₅, —CH₂C≡CCH₃, —(CH₂)₂—C≡CH, —C≡CC₃H₇, —CH₂C≡CC₂H₅, —(CH₂)₂—C≡CCH₃ and —C≡C(CH₂)₅.

Alkynylene herein may have a straight chain or a branched chain, and specific examples of the alkynylene include —C≡C—, —C≡CCH₂—, —CH₂C≡C—, —C⊙CC₂H₄—, —CH₂C≡CCH₂—, —(CH₂)₂—C≡C—, —C≡CC₃H₆—, —CH₂C≡CC₂H₄—, —(CH₂)₂—C≡CCH₂— and —C≡C(CH₂)₄—.

Specific examples of halogen herein include fluorine, chlorine, bromine and iodine.

R¹ herein preferably has a structure represented by formulas (CHN-1) to (CHN-4). R¹ further preferably has a structure represented by formula (CHN-1) or (CHN-2).

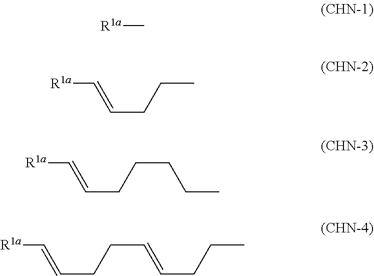

In the formulas, R^{1a} is hydrogen or alkyl having 1 to 12 carbons.

R², R¹¹, R²¹, R¹², R¹³, R²², R²³, R⁴, R⁵, R⁴¹, R⁴², R⁵¹, R⁵², R⁶, R⁷, R⁶¹, R⁶², R⁷¹, R⁷² and R⁸ herein are also defined in a manner similar to the definitions of R¹.

### Advantageous Effects of Invention

A preferred compound of the invention exhibits liquid crystallinity, and has a comparatively high clearing point, a wide nematic phase temperature range, and large dielectric anisotropy.

A preferred liquid crystal composition, a preferred polymer-liquid crystal composite material and so forth according to the invention exhibit stability to heat, light or the like, a high maximum temperature and a low minimum temperature of an optically isotropic liquid crystal phase, and have large dielectric anisotropy. Moreover, the polymer-liquid crystal composite material in a preferred aspect of the invention exhibits a high maximum temperature and a low minimum temperature of an optically isotropic liquid crystal phase, and has a low driving voltage in an optical device driven in the optically isotropic liquid crystal phase.

Moreover, the optical device driven in the optically isotropic liquid crystal phase in the preferred aspect of the invention can be used in a wide temperature range, driven at low voltage to allow a high-speed electro-optic response, and has a large contrast ratio.

### BRIEF DESCRIPTION OF DRAWINGS

FIG. 1 shows a comb-shaped electrode substrate used in Examples.

FIG. 2 shows an optical system used in the Examples.

### DESCRIPTION OF EMBODIMENTS

A liquid crystal composition having an optically isotropic liquid crystal phase according to the invention contains achiral component T and a chiral agent, and achiral component T includes at least one compound (1) and at least one compound (2). At least one compound selected from the group of compound (1) and compound (2) is a compound having alkoxyalkyl. Preferred achiral component T includes at least one compound (1′), at least one compound (2′) and at least one compound (3). An aspect of the liquid crystal composition of the invention is a composition containing compound (1), compound (2) and any other component a name of which is not particularly described herein. A further preferred aspect is a composition containing compound (1′), compound (2′), compound (3) and any other component a name of which is not particularly described herein. First, compound (1) and compound (2) will be described. Moreover, the liquid crystal composition of the invention may further contain a solvent, a monomer, a polymerization initiator, a curing agent, a stabilizer (an antioxidant, an ultraviolet light absorbent or the like) or the like in addition to the components described above.

### 1-1 Compound (1) and Compound (2)

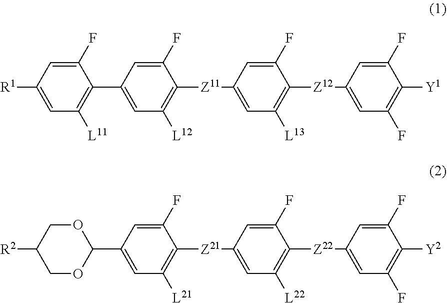

In compound (1) and compound (2), R¹ and R² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12, in which at least one of R¹ and R² is alkoxyalkyl in which a total of the number of carbons is 1 to 12.

Z¹¹, Z¹², Z²¹ and Z²² are independently a single bond, —COO— and —CF₂O—, in which one of Z¹¹ and Z¹² is —CF₂O— or —COO—, and the other is a single bond, and one of Z²¹ and Z²² is —CF₂O— or —COO—, and the other is a single bond, and at least one is preferably —CF₂O—.

L¹¹ to L¹³, L²¹ and L²² are independently hydrogen, fluorine or chlorine, and a compound in which L¹¹ is hydrogen, and L¹² and L¹³ are fluorine, a compound in which L¹² is fluorine, and L¹¹ and L¹³ are hydrogen, a compound in which L²¹ is hydrogen and L²² is fluorine, and a compound in which L²¹ is fluorine and L²² is hydrogen are preferred.

Y¹ and Y² are independently fluorine, chlorine, —CF₃ or —OCF₃, and preferably fluorine, —CF₃ or —OCF₃.

### 1-2 Properties of Compound (1) and Compound (2)

Compound (1) and compound 2 are significantly stable physically and chemically under conditions in which the device is ordinarily used, and have a high clearing point and comparatively good compatibility with other compounds. A composition containing the compound is stable under conditions in which the device is ordinarily used. Accordingly, if compound (1) and compound (2) in the liquid crystal composition are used, the temperature range of the liquid crystal phase can be extended, and the composition can be used in the form of the display device in a wide temperature range.

Compound (1) has comparatively large dielectric anisotropy and large refractive index anisotropy, and therefore is useful as a component for decreasing driving voltage of the liquid crystal composition driven in the optically isotropic liquid crystal phase. Compound (2) has significantly large dielectric anisotropy and medium refractive index anisotropy, and therefore is useful as a component for decreasing the driving voltage of the liquid crystal composition driven in the optically isotropic liquid crystal phase. Moreover, the compound (2) has excellent compatibility with other compounds.

### 1-3 Liquid Crystal Composition

The liquid crystal composition of the invention contains compound (1) and compound (2), and is a composition that develops an optically isotropic liquid crystal phase. Moreover, the optically isotropic liquid crystal composition contains a chiral agent, and may contain the antioxidant, the ultraviolet light absorbent, the stabilizer or the like in addition to achiral component T including a compound.

Achiral component T includes a case where the achiral component is composed of at least one compound (1) and at least one compound (2), and a case where the achiral component includes two or more compounds (1) or two or more compounds (2). Further, the achiral component may include one or more compounds selected from compound (4) to compound (8) when necessary. Compound (1) and compound (2) each are a liquid crystal compound.

Compound (1) and compound (2) simultaneously have a comparatively high clearing point, large dielectric anisotropy and comparatively good compatibility in low temperature, and therefore achiral component T using compound (1) and compound (2) also develops a wide liquid crystal phase temperature range or large dielectric anisotropy. Therefore, the optically isotropic liquid crystal composition using achiral component T is also useful as a composition used for an optical device.

Compound (1) is contained preferably in 5% by weight to 65% by weight in total, further preferably in 10% by weight to 60% by weight in total, and particularly preferably in 15% by weight to 55% by weight in total, based on the total weight of achiral component T. Compound (2) is contained preferably in 25% by weight to 90% by weight in total, further preferably in 35% by weight to 85% by weight in total, and particularly preferably in 45% by weight to 80% by weight in total, based thereon.

### 2-1-1 Compound (1′) and Compound (2′)

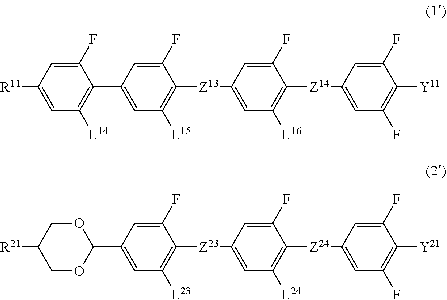

In compound (1′) and compound (2′), R¹¹ and R²¹ are independently alkyl having 1 to 12 carbons, alkenyl having 2 to 12 carbons, alkynyl having 2 to 12 carbons and alkoxy having 1 to 11 carbons, and O atoms are not connected with each other. R¹¹ and R²¹ are preferably independently alkyl having 1 to 12 carbons.

Z¹³, Z¹⁴, Z²³ and Z²⁴ are independently a single bond, —COO— and —CF₂O—, in which one of Z¹³ and Z¹⁴ is —CF₂O— or —COO—, and the other is a single bond, and one of Z²³ and Z²⁴ is —CF₂O— or —COO—, and the other is a single bond, and at least one is preferably —CF₂O—.

L¹⁴ to L¹⁶, L²³ and L²⁴ are independently hydrogen, fluorine or chlorine, and a compound in which L¹⁴ is hydrogen, and L¹⁵ and L¹⁶ are fluorine, a compound in which L¹⁵ is fluorine, and L¹⁴ and L¹⁶ are hydrogen, a compound in which L²³ is hydrogen and L²⁴ is fluorine, and a compound in which L²³ is fluorine and L²⁴ is hydrogen are preferred.

Y¹¹ and Y²¹ are independently fluorine, chlorine, —CF₃ or —OCF₃, and preferably fluorine, —CF₃ or —OCF₃.

As compound (1′) being a first component, compound (1′-1) or compound (1′-2) is preferred.

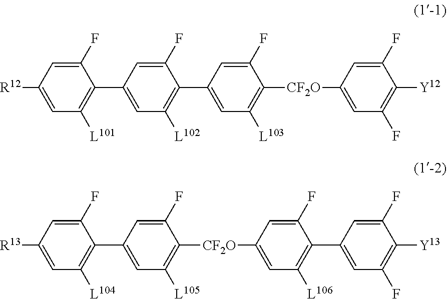

In compound (1′-1) and compound (1′-2), R¹² and R¹³ are independently alkyl having 1 to 12 carbons, alkenyl having 2 to 12 carbons, alkynyl having 2 to 12 carbons or alkoxy having 1 to 11 carbons, and preferably alkyl having 1 to 12 carbons.

L¹⁰¹ to L¹⁰⁵ and L¹⁰⁶ are independently hydrogen, fluorine or chlorine, and a compound in which L¹⁰¹ is hydrogen, and L¹⁰² and L¹⁰³ are fluorine, and a compound in which L¹⁰⁴ and L¹⁰⁶ are hydrogen and L¹⁰⁵ is fluorine are preferred.

Y¹² and Y¹³ are independently fluorine, chlorine, —CF₃ or —OCF₃, and preferably fluorine, —CF₃ or —OCF₃.

In compound (1′-1), compound (1′-1-1) to compound (1′-1-3) are preferably used, and compound (1′-1-1) or compound (1′-1-2) is further preferably used.

In compound (1′-2), compound (1′-2-1) to compound (1′-2-6) are preferably used, and compound (1′-2-1) is further preferably used.

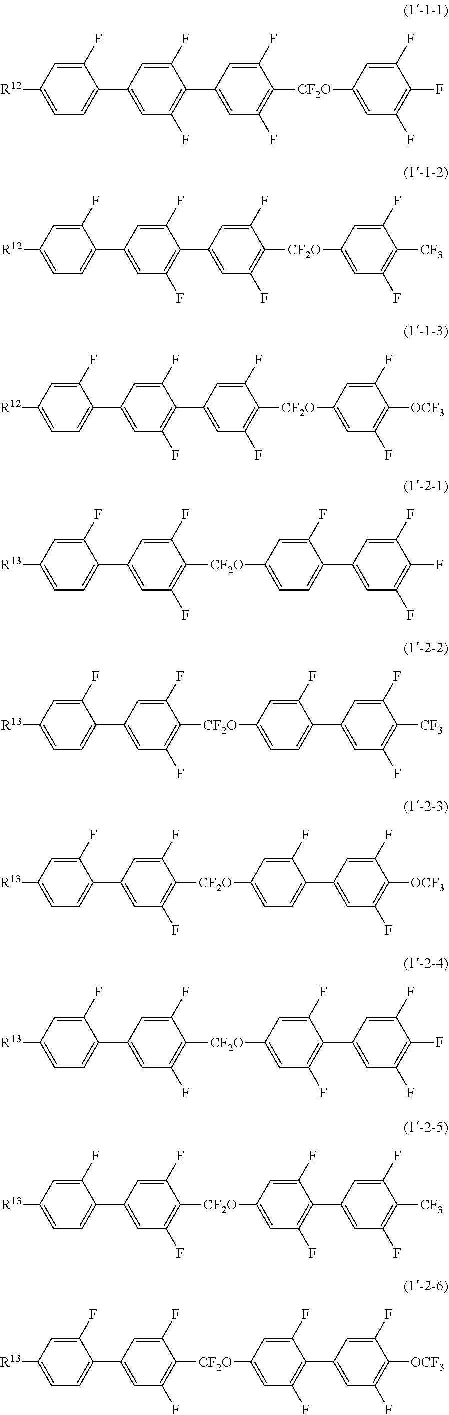

In the formulas, R¹² and R¹³ are defined in a manner identical with the definitions in compound (1′-1) and compound (1′-2).

### 2-1-2 Properties of Compound (1′)

Compound (1′) is significantly stable physically and chemically under conditions in which the device is ordinarily used, and has comparatively good compatibility with other liquid crystal compounds. A composition containing the compound is stable under conditions in which the device is ordinarily used.

Accordingly, if compound (1′) is used in the liquid crystal composition, the temperature range of the liquid crystal phase can be extended, and the composition can be used in the form of the display device in the wide temperature range. Compound (1′) has comparatively large dielectric anisotropy and large refractive index anisotropy, and therefore is useful as a component for decreasing the driving voltage of the liquid crystal composition driven in the optically isotropic liquid crystal phase.

As compound (2′) being a second component, compound (2′-1) or compound (2′-2) is preferred.

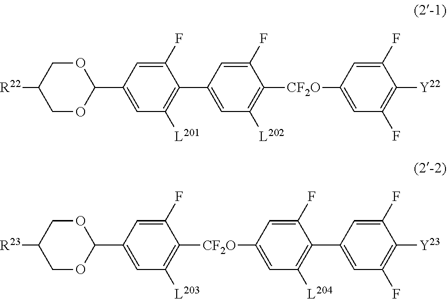

In compound (2′-1) and compound (2′-2), R²² and R²³ are independently alkyl having 1 to 12 carbons, alkenyl having 2 to 12 carbons, alkynyl having 2 to 12 carbons or alkoxy having 1 to 11 carbons, and preferably alkyl having 1 to 12 carbons.

L²⁰¹ to L²⁰³ and L²⁰⁴ are independently hydrogen, fluorine or chlorine, and a compound in which L²⁰¹ is hydrogen and L²⁰² is fluorine, and a compound in which L²⁰³ is fluorine and L²⁰⁴ is hydrogen are preferred.

Y²² and Y²³ are independently fluorine, chlorine, —CF₃ or —OCF₃, and preferably fluorine, —CF₃ or —OCF₃.

In compound (2′-1), compound (2′-1-1) to compound (2′-1-3) are preferably used, and compound (2′-1-1) or compound (2′-1-2) is further preferably used.

In compound (2′-2), compound (2′-2-1) to compound (2′-2-6) are preferably used, and compound (2′-2-1) is further preferably used.

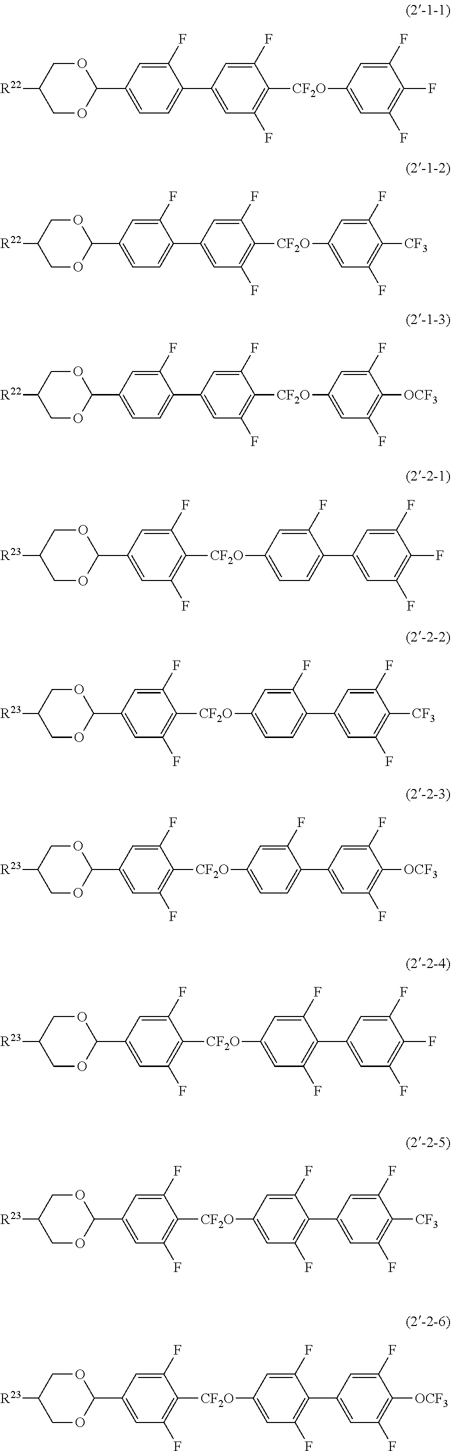

In the formulas, R²² and R²³ are defined in a manner identical with the definitions in compound (2′-1) and compound (2′-2).

### 2-2-1 Properties of Compound (2′)

Compound (2′) is significantly stable physically and chemically under conditions in which the device is ordinarily used, and has good compatibility with other liquid crystal compounds. A composition containing the compound is stable under conditions in which the device is ordinarily used. Accordingly, if compound (2′) is used in the liquid crystal composition, the temperature range of the liquid crystal phase can be extended, and the composition can be used in the form of the display device in the wide temperature range. Compound (2′) has large dielectric anisotropy and medium refractive index anisotropy, and therefore is useful as a component for decreasing the driving voltage of the liquid crystal composition driven in the optically isotropic liquid crystal phase.

### 2-3-1 Compound (3)

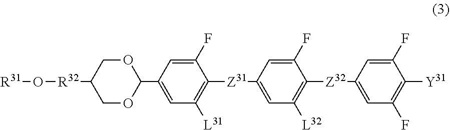

In compound (3), R³¹ is independently alkyl having 1 to 12 carbons, alkenyl having 2 to 12 carbons or alkynyl having 2 to 12 carbons; and R³² is alkylene having 1 to 5 carbons, alkenylene having 2 to 5 carbons or alkynylene having 2 to 5 carbons 2-5. Preferred R³¹ is alkyl having 1 to 12 carbons, and is further preferably alkyl having 1 to 5 carbons, and preferred R³² is alkylene having 1 to 5 carbons, and is further preferably alkylene having 1 to 3 carbons.

L³¹ and L³² are independently hydrogen, fluorine or chlorine, and a compound in which L³¹ is hydrogen and L³² is fluorine, and a compound in which L³¹ is fluorine and L³² is hydrogen are preferred.

Z³¹ and Z³² are independently a single bond, —COO— and —CF₂O—, in which one of Z³¹ and Z³² is —CF₂O— or —COO—, and the other is a single bond, and at least one is preferably —CF₂O—.

Y³¹ is independently fluorine, chlorine, —CF₃ or —OCF₃, and preferably fluorine, —CF₃ or —OCF₃.

In compound (3), compound (3-1) or compound (3-2) is preferred.

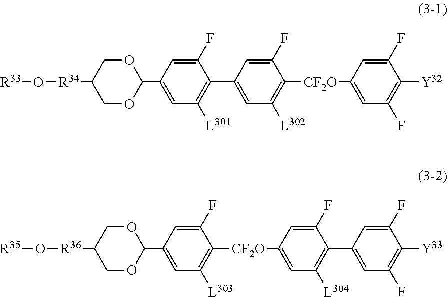

In compound (3-1) and compound (3-2), R³³ and R³⁵ are independently alkyl having 1 to 12 carbons, alkenyl having 2 to 12 carbons or alkynyl having 2 to 12 carbons; and R³⁴ and R³⁶ are independently alkylene having 1 to 5 carbons, alkenylene having 2 to 12 carbons or alkynylene having 2 to 12 carbons, and preferred R³³ and R³⁵ are alkyl having 1 to 12 carbons, and further preferably alkyl having 1 to 5 carbons, and preferred R³⁴ and R³⁶ are alkylene having 1 to 5 carbons, and further preferably alkylene having 1 to 3 carbons.

L³⁰¹ to L³⁰³ and L³⁰⁴ are independently hydrogen, fluorine or chlorine, and a compound in which L³⁰¹ is hydrogen and L³⁰² is fluorine, and a compound in which L³⁰³ is fluorine and L³⁰⁴ is hydrogen are preferred.

Y³² and Y³³ are independently fluorine, chlorine, —CF₃ or —OCF₃, and preferably fluorine, —CF₃ or —OCF₃.

In compound (3-1), compound (3-1-1) to compound (3-1-3) are preferably used, and compound (3-1-1) or compound (3-1-2) is further preferably used.

In compound (3-2), compound (3-2-1) to compound (3-2-6) are preferably used, and compound (3-2-1) or compound (3-2-2) is further preferably used.

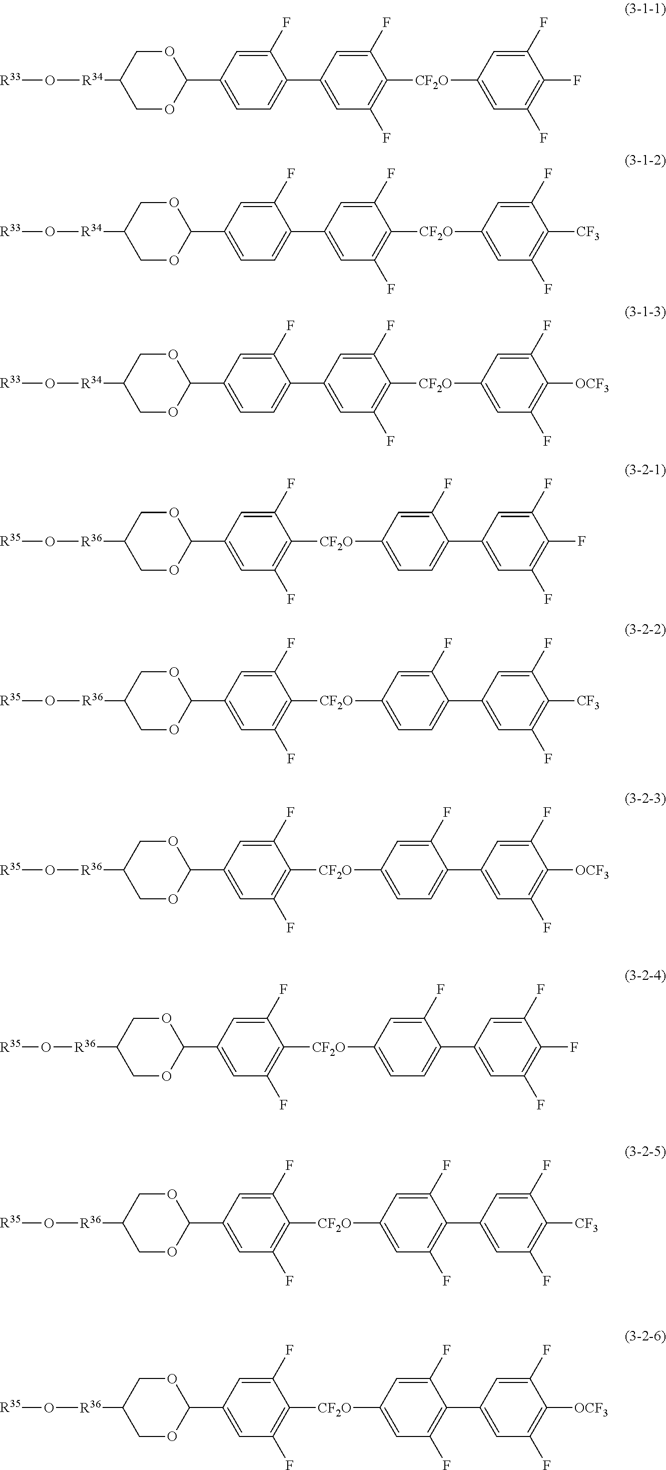

In the formulas, R³³ to R³⁶ are defined in a manner identical with the definitions in compound (3-1) and compound (3-2).

### 2-3-2 Properties of Compound (3)

Compound (3) is significantly stable physically and chemically under conditions in which the device is ordinarily used, and has good compatibility with other liquid crystal compounds. A composition containing the compound is stable under conditions in which the device is ordinarily used. Accordingly, if compound (3) is used in the liquid crystal composition, the temperature range of the liquid crystal phase can be extended, and the composition can be used in the form of the display device in the wide temperature range. Compound (3) has significantly large dielectric anisotropy and medium refractive index anisotropy, and therefore is useful as a component for decreasing the driving voltage of the liquid crystal composition driven in the optically isotropic liquid crystal phase.

### 2-3-3 Liquid Crystal Composition

The liquid crystal composition of the invention is a composition that contains compound (1′), compound (2′) and compound (3), and develops an optically isotropic liquid crystal phase. Moreover, the optically isotropic liquid crystal composition includes a chiral agent, and may further include the antioxidant, the ultraviolet light absorbent, the stabilizer or the like in addition to achiral component T including a compound.

Achiral component T preferably includes compound (1′), compound (2′) and compound (3), and further preferably includes compound (1′-1), compound (1′-2), compound (2′-1), compound (2′-2) and compound (3-1), or compound (1′-1), compound (1′-2), compound (2′-1), compound (2′-2) and compound (3-2). Moreover, according to properties to be required, compound (4) to compound (8) can be included. Compound (1) to compound (8) are liquid crystal compounds.

Compound (1′), compound (2′) and compound (3) simultaneously have comparatively high clearing point, large dielectric anisotropy and comparatively good compatibility in low temperature, and therefore achiral component T using compound (1′), compound (2′) and compound (3) also develops a wide liquid crystal phase temperature range or large dielectric anisotropy. Therefore, an optically isotropic liquid crystal composition using achiral component T is also useful as a composition used for an optical device.

Compound (1′) is contained preferably in 5% by weight to 65% by weight in total, further preferably in 10% by weight to 60% by weight in total, and particularly preferably in 15% by weight to 55% by weight in total, based on the total weight of achiral component T, and compound (2′) is contained preferably in 15% by weight to 80% by weight in total, further preferably in 25% by weight to 80% by weight in total, and particularly preferably in 30% by weight to 70% by weight in total, based thereon. Compound (3) is contained preferably in 2% by weight to 40% by weight in total, further preferably in 5% by weight to 35% by weight in total, and particularly preferably in 5% by weight to 25% by weight in total, based thereon.

### 2-4-1 Compound (4) and Compound (5)

The achiral component of the invention may further contain at least one of compound (4) and compound (5) in addition to compound (1′), compound (2′) and compound (3). More specifically, in achiral component T, the invention includes a case where compound (4) and compound (5) are composed of one compound, and also a case where compound (4) and compound (5) contain a plurality of compounds. Moreover, for example, the liquid crystal composition of the invention may further contain one or more compounds selected from the group of compound (6), compound (7) and compound (8) with compound (4) and compound (5), in addition to compound (1′), compound (2′) and compound (3).

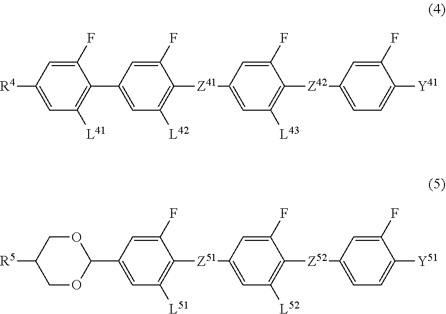

In compound (4) and compound (5), R⁴ and R⁵ are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12, and preferably alkyl having 1 to 12 carbons.

Z⁴¹, Z⁴², Z⁵¹ and Z⁵² are independently a single bond, —COO— and —CF₂O—, in which one of Z⁴¹ and Z⁴² is —CF₂O— or —COO—, and the other is a single bond, and one of Z⁵¹ and Z⁵² is —CF₂O— or —COO—, and the other is a single bond.

L⁴¹ to L⁴³, L⁵¹ and L⁵² are independently hydrogen, fluorine or chlorine, and a compound in which L⁴¹ and L⁴³ are hydrogen and L⁴² is fluorine, a compound in which L⁴¹ is hydrogen, and L⁴² and L⁴³ are fluorine, a compound in which L⁵¹ is fluorine and L⁵² is hydrogen, and a compound in which L⁵¹ and L⁵² are fluorine are preferred.

Y⁴¹ and Y⁵¹ are independently fluorine, chlorine, —CF₃ or —OCF₃, and preferably fluorine, —CF₃ or —OCF₃.

As compound (4), compound (4-1) or compound (4-2) is preferred, and as compound (5), compound (5-1) or compound (5-2) is preferred.

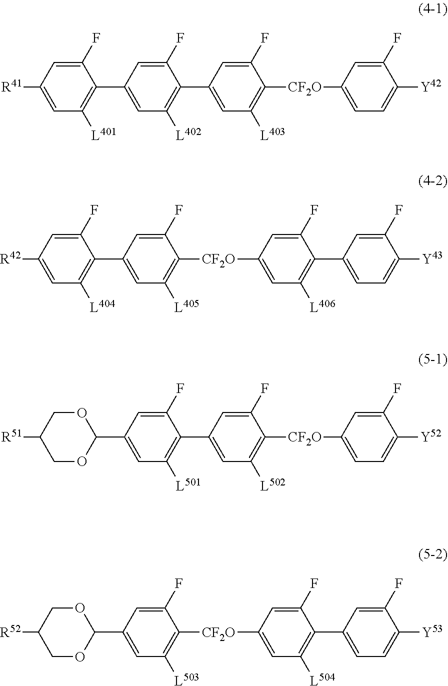

In compound (4-1), compound (4-2), compound (5-1) and compound (5-2), R⁴¹, R⁴², R⁵¹ and R⁵² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12, and preferably alkyl having 1 to 12 carbons.

L⁴⁰¹ to L⁴⁰⁶, L⁵⁰¹ to L⁵⁰³ and L⁵⁰⁴ are independently hydrogen, fluorine or chlorine, and a compound in which L⁴⁰⁴ and L⁴⁰⁶ are fluorine and L⁴⁰⁵ is hydrogen, a compound in which L⁴⁰⁴ is hydrogen, and L⁴⁰⁵ and L⁴⁰⁶ are fluorine, a compound in which L⁵⁰³ is fluorine and L⁵⁰⁴ is hydrogen, and a compound in which L⁵⁰³ and L⁵⁰⁴ are fluorine are preferred.

Y⁴², Y⁴³, Y⁵² and Y⁵³ are independently fluorine, chlorine, —CF₃ or —OCF₃, and preferably fluorine, —CF₃ or —OCF₃.

As compound (4-1) or compound (4-2), compound (4-1-1) to compound (4-1-3) or compound (4-2-1) to compound (4-2-6) are preferred, and compound (4-2-1) or compound (4-2-4) is further preferred.

As compound (5-1) or compound (5-2), compound (5-1-1) to compound (5-1-3) or compound (5-2-1) to compound (5-2-6) are preferred, and compound (5-2-1) or compound (5-2-4) is further preferred.

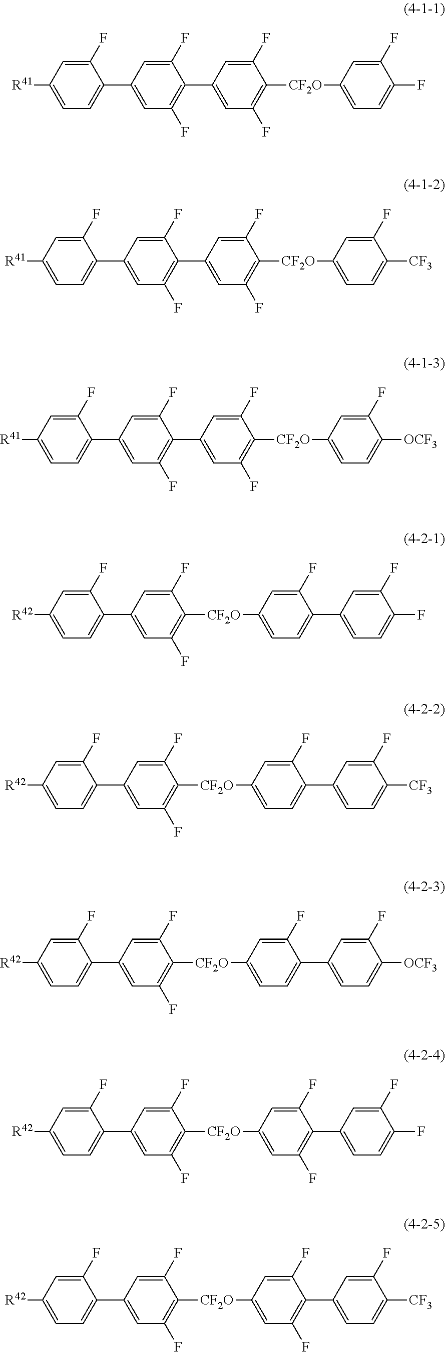

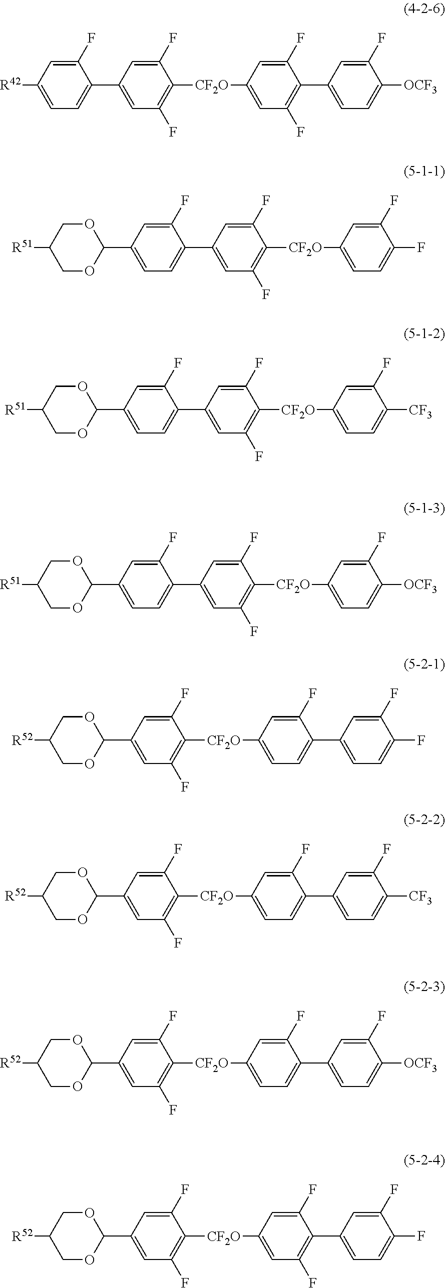

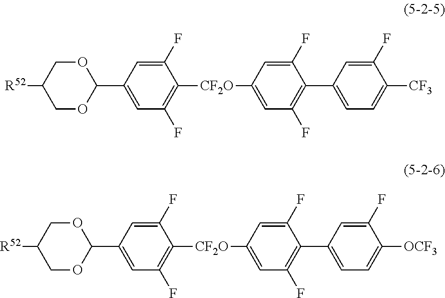

In the formulas, R⁴¹, R⁴², R⁵¹ and R⁵² are defined in a manner identical with the definitions in compound (4-1), compound (4-2) compound (5-1) and compound (5-2).

Compound (4) is contained preferably in 1% by weight to 25% by weight in total, further preferably in 5% by weight to 25% by weight in total, and particularly preferably in 5% by weight to 15% by weight in total, based on the total weight of achiral component T. Compound (5) is contained preferably in 1% by weight to 25% by weight in total, further preferably in 5% by weight to 25% by weight in total, and particularly preferably in 5% by weight to 15% by weight in total, based thereon.

### 2-4-2 Properties of Compound (4)

Compound (4) is significantly stable physically and chemically under conditions in which the device is ordinarily used, and has comparatively good compatibility with other liquid crystal compounds. A composition containing the compound is stable under conditions in which the device is ordinarily used. Accordingly, if compound 4 is used in the liquid crystal composition, the temperature range of the liquid crystal phase can be extended, and the composition can be used in the form of the display device in the wide temperature range. Compound (4) has relatively smaller dielectric anisotropy and large refractive index anisotropy, and therefore is useful as a component for decreasing the driving voltage while suppressing dielectric constant to be small by the liquid crystal composition driven by an isotropic optically liquid crystal phase.

### 2-5-1 Properties of Compound (5)

Compound (5) is significantly stable physically and chemically under conditions in which the device is ordinarily used, and has comparatively good compatibility with other liquid crystal compounds. A composition containing the compound is stable under conditions in which the device is ordinarily used. Accordingly, if compound (5) is used in the liquid crystal composition, the temperature range of the liquid crystal phase can be extended, and the composition can be used in the form of the display device in the wide temperature range. Compound (5) has comparatively smaller dielectric anisotropy and medium refractive index anisotropy, and therefore is useful as a component for decreasing the driving voltage while suppressing dielectric constant to be small by the liquid crystal composition driven by an optically isotropic liquid crystal phase.

### 2-6-1 Compound (6) and Compound (7)

The achiral component of the invention may also contain at least one of compound (6) and compound (7) in addition to compound (1′), compound (2′) and compound (3). More specifically, in achiral component T, the invention includes a case where compound (6) and compound (7) are composed of one compound, and also a case where compound (6) and compound (7) contain a plurality of compounds. Moreover, for example, the liquid crystal composition of the invention may further contain one or more compounds selected from the group of compound (4), compound (5) and compound (8) with compound (6) and compound (7), in addition to compound (1′), compound (2′) and compound (3).

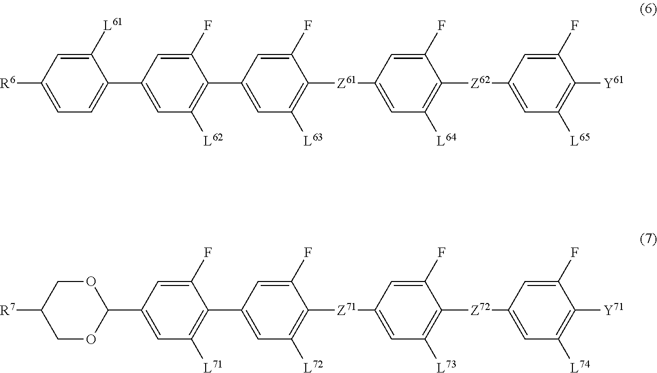

In compound (6) and compound (7), R⁶ and R⁷ are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12, and preferably alkyl having 1 to 12 carbons.

Z⁶¹, Z⁶², Z⁷¹ and Z⁷² are independently a single bond, —COO— and —CF₂O—, in which one of Z⁶¹ and Z⁶² is —CF₂O— or —COO—, and the other is a single bond, and one of Z⁷¹ and Z⁷² is —CF₂O— or —COO—, and the other is a single bond.

L⁶¹ to L⁶⁵, L⁷¹ to L⁷³ and L⁷⁴ are independently hydrogen, fluorine or chlorine, and a compound in which L⁶¹, L⁶² and L⁶³ are hydrogen, and L⁶⁴ and L⁶⁵ are fluorine, a compound in which L⁶¹, L⁶², L⁶³ and L⁶⁵ are fluorine and L⁶⁴ is hydrogen, a compound in which L⁷¹ is hydrogen, and L⁷², L⁷³ and L⁷⁴ are fluorine, and a compound in which L⁷¹ and L⁷³ are hydrogen, and L⁷² and L⁷⁴ are fluorine are preferred.

Y⁶¹ and Y⁷¹ are independently fluorine, chlorine, —CF₃ or —OCF₃, and preferably fluorine, —CF₃ or —OCF₃.

As compound (6), compound (6-1) or compound (6-2) is preferred, and as compound (7), compound (7-1) or compound (7-2) is preferred.

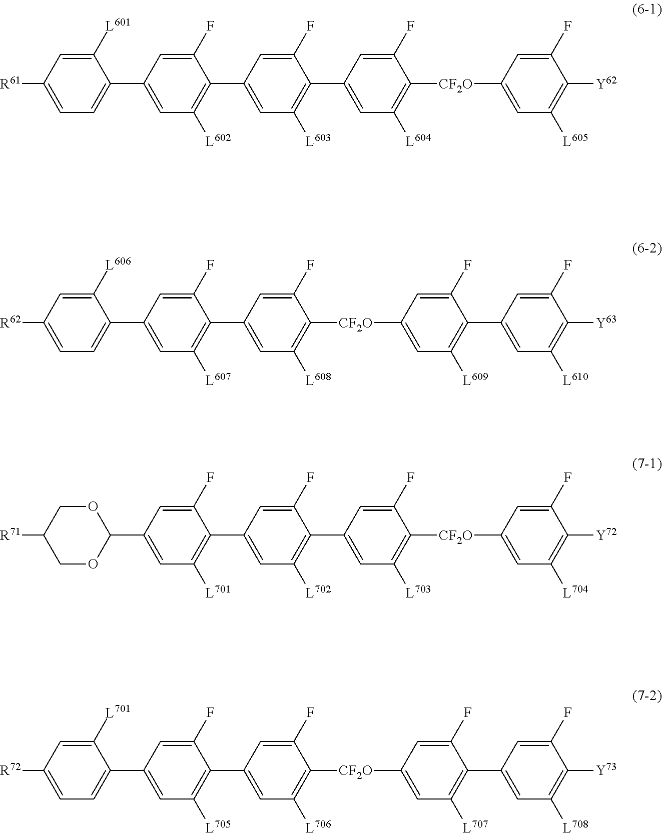

In compound (6-1), compound (6-2), compound (7-1) and compound (7-2), R⁶¹, R⁶², R⁷¹ and R⁷² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12, and preferably alkyl having 1 to 12 carbons.

L⁶⁰¹ to L⁶¹⁰, L⁷⁰¹ to L⁷⁰⁷ and L⁷⁰⁸ are independently hydrogen, fluorine or chlorine, and a compound in which L⁶⁰¹, L⁶⁰² and L⁶⁰³ are hydrogen, and L⁶⁰⁴ and L⁶⁰⁵ are fluorine, a compound in which L⁶⁰⁶, L⁶⁰⁷, L⁶⁰⁸ and L⁶¹⁰ are fluorine and L⁶⁰⁹ is hydrogen, a compound in which L⁷⁰¹ is hydrogen, and L⁷⁰², L⁷⁰³ and L⁷⁰⁴ are fluorine, and a compound in which L⁷⁰⁵ and L⁷⁰⁷ are hydrogen, and L⁷⁰⁶ and L⁷⁰⁷ are fluorine are preferred.

Y⁶², Y⁶³, Y⁷² and Y⁷³ are independently fluorine, chlorine, —CF₃ or —OCF₃, and preferably fluorine, —CF₃ or —OCF₃.

When compound (6-1) or compound (6-2) is used as compound (6), compound (6-1-1) to compound (6-1-6), or compound (6-2-1) to compound (6-2-6) is preferably used, and compound (6-1-1), compound (6-1-2), compound (6-2-1) or compound (6-2-2) is further preferably used. When compound (7-1) or compound (7-2) is used as compound (7), compound (7-1-1) to compound (7-1-6), or compound (7-2-1) to compound (7-2-6) is preferably used, and compound (7-1-1), compound (7-1-2), compound (7-2-1) or compound (7-2-2) is further preferably used.

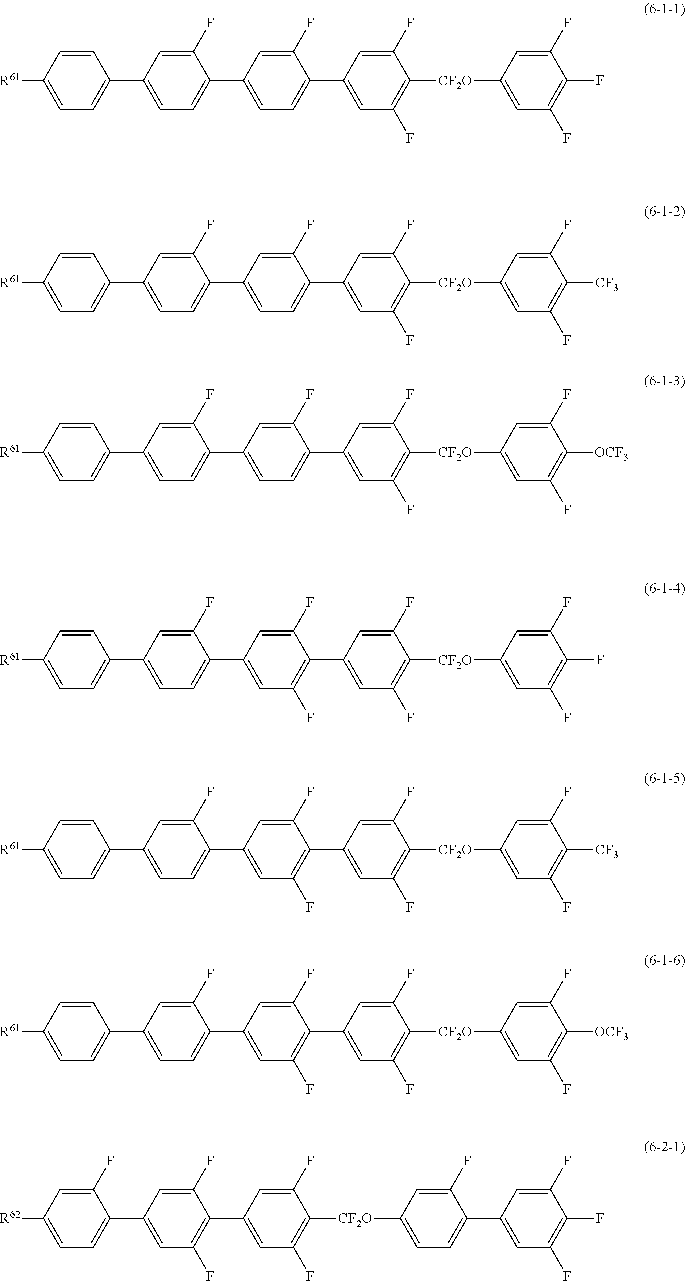

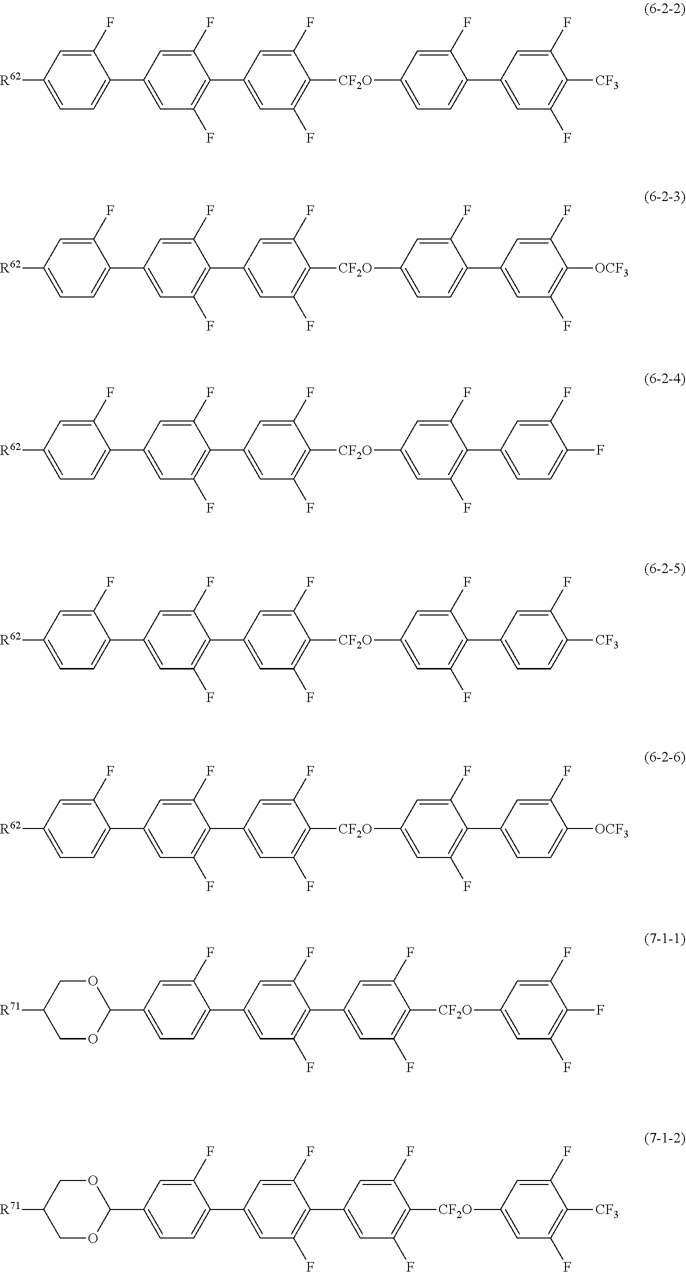

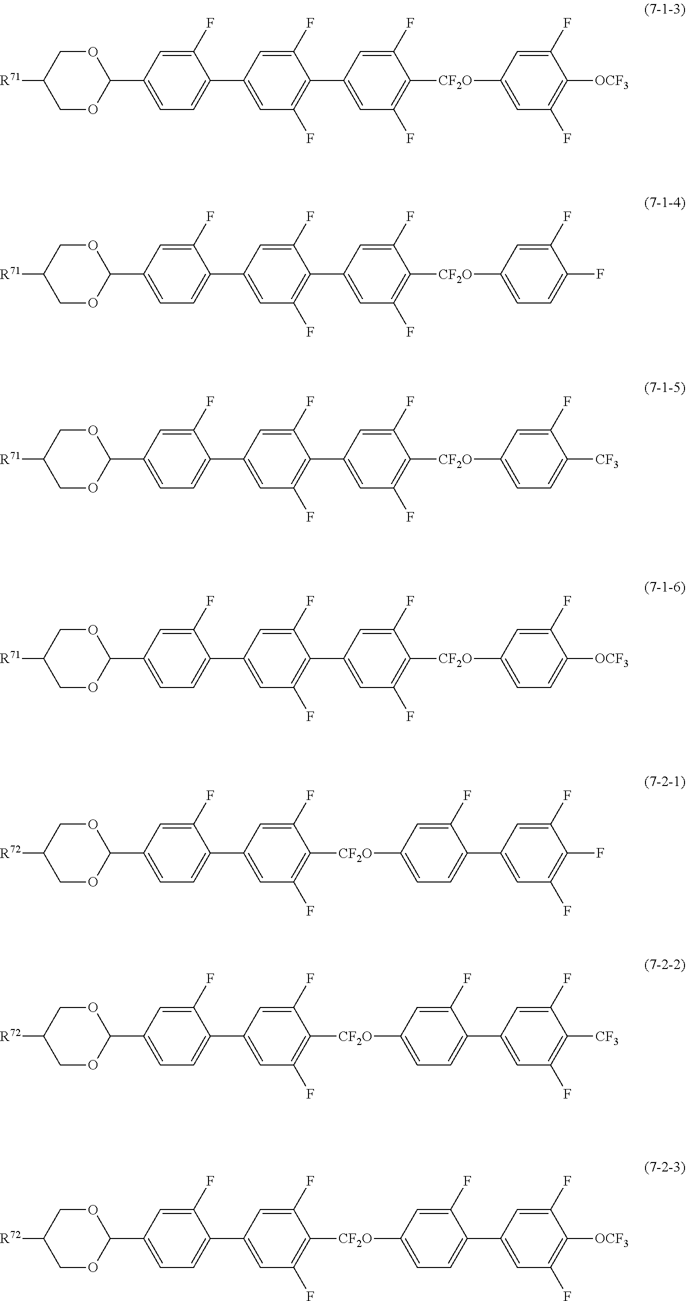

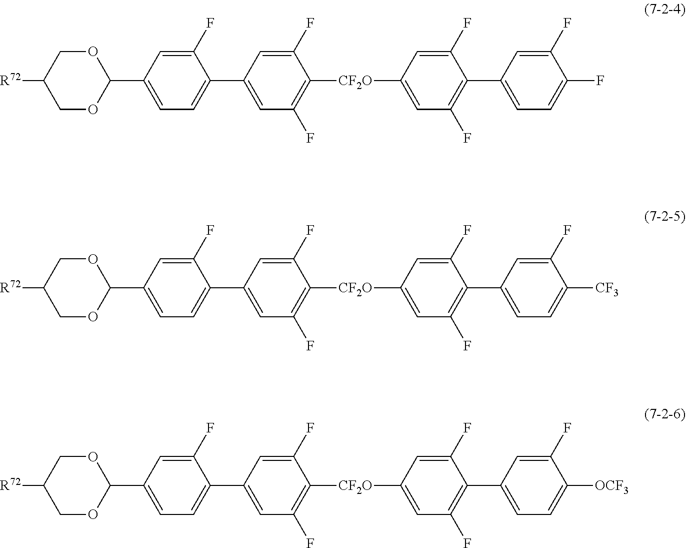

In the formulas, R⁶¹, R⁶², R⁷¹ and R⁷² are defined in a manner identical with the definitions in compound (6-1), compound (6-2), compound (7-1) and compound (7-2).

Compound (6) is contained preferably in 0.1% by weight to 20% by weight in total, further preferably in 0.5% by weight to 15% by weight in total, and particularly preferably in 0.5% by weight to 10% by weight in total, based on the total weight of achiral component T. Compound (7) is contained preferably in 0.1% by weight to 20% by weight in total, further preferably in 0.5% by weight to 15% by weight in total, and particularly preferably in 0.5% by weight to 10% by weight in total, based thereon.

### 2-6-2 Properties of Compound (6)

Compound (6) is significantly stable physically and chemically under conditions in which the device is ordinarily used, and a composition containing the compound is stable under conditions in which the device is ordinarily used. Compound (6) has comparatively large dielectric anisotropy, large refractive index anisotropy and significantly high clearing point, and therefore is useful as a component for increasing an upper limit of the range of driving temperature by the liquid crystal composition driven by an optically isotropic liquid crystal phase.

### 2-7-1 Properties of Compound (7)

Compound (7) is significantly stable physically and chemically under conditions in which the device is ordinarily used, and a composition containing the compound is stable under conditions in which the device is ordinarily used. Compound (7) has comparatively large dielectric anisotropy, medium refractive index anisotropy and significantly high clearing point, and therefore is useful as a component for increasing an upper limit of the range of driving temperature by the liquid crystal composition driven by an optically isotropic liquid crystal phase.

### 2-8-1 Compound (8)

The achiral component of the invention may further include at least one of compound (8) in addition to compound (1′), compound (2′) and compound (3). More specifically, in achiral component T, the invention also includes a case where compound (8) is composed of one compound, and also a case where compound (8) contains a plurality of compounds. Moreover, for example, the liquid crystal composition of the invention may further contain one or more compounds selected from the group of compound (4) to compound (7) with compound (8), in addition to compound (1′), compound (2′) and compound (3).

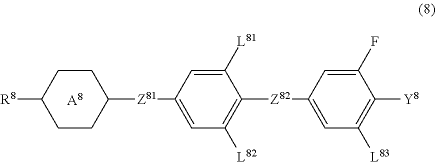

In compound (8), R⁸ is alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12, and preferably alkyl having 1 to 12 carbons.

Ring A⁸ is 1,4-cyclohexylene, 1,4-phenylene, 2-fluoro-1,4-phenylene, 3-fluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl, and preferably 1,4-cyclohexylene, 1,4-phenylene, 3-fluoro-1,4-phenylene, 3,5-difluoro-1,4-phenylene or 1,3-dioxane-2,5-diyl.

Z⁸¹ and Z⁸² are independently a single bond, —COO—, —CH₂CH₂—, —CH₂O— or —CF₂O—, and both are preferably a single bond, or at least one is —CF₂O—, and when compatibility with other liquid crystal compounds is realized to be important, at least one is —CF₂O—.

L⁸¹, L⁸² and L⁸³ are independently hydrogen, fluorine or chlorine, and a compound in which L⁸³ is fluorine is preferred.

Y⁸ is fluorine, chlorine, —CF₃ or —OCF₃, and preferably fluorine, —CF₃ or —OCF₃.

As compound (8), compound (8-1) to compound (8-11) are preferred.

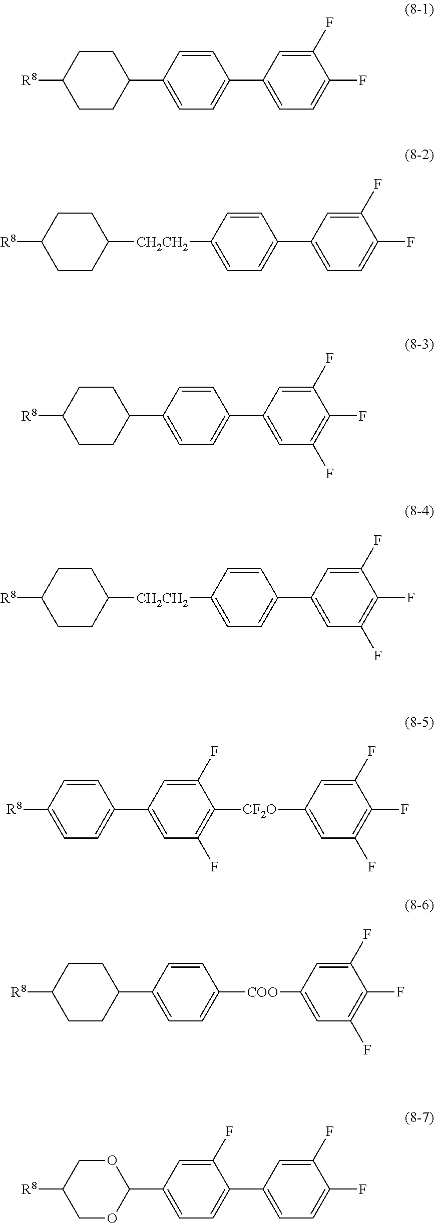

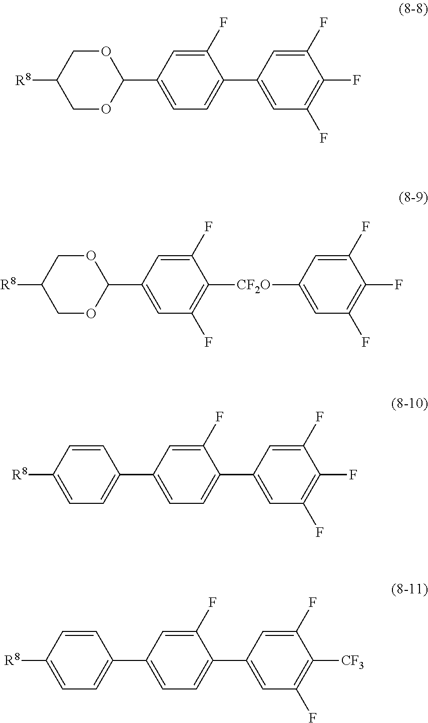

In the formulas, R⁸ is defined in a manner identical with the definitions in compound (8).

Compound (8) is contained preferably in 0.1% by weight to 15% by weight in total, further preferably in 0.5% by weight to 15% by weight in total, and particularly preferably in 0.5% by weight to 10% by weight in total, based on the total weight of achiral component T.

### 2-8-2 Properties of Compound (8)

Compound (8) is significantly stable physically and chemically under conditions in which the device is ordinarily used, and a composition containing the compound is stable under conditions in which the device is ordinarily used. Accordingly, if compound (8) is used in the liquid crystal composition, the temperature range of the liquid crystal phase can be extended, and the composition can be used in the form of the display device in the wide temperature range. Compound (8) has a compound showing comparatively large dielectric anisotropy and a wide range of refractive index anisotropy, and therefore is useful as a component for adjusting each value of physical properties by the liquid crystal composition driven by an optically isotropic liquid crystal phase.

### 3 Optically Isotropic Liquid Crystal Composition

The liquid crystal composition of the invention includes an aspect of a composition containing achiral component T and the chiral agent to develop the optically isotropic liquid crystal phase (optically isotropic liquid crystal composition).

### 3-1 Achiral Component T

Achiral component T contained in the optically isotropic liquid crystal composition according to the invention includes at least one compounds (1′), at least one compound (2′) and at least one compound (3), and includes one or more compounds selected from the group of compound (4) to compound (8) when necessary.

Compound (1′), compound (2′) and compound (3) simultaneously have comparatively high clearing point, large dielectric anisotropy, and comparatively good compatibility in low temperature, and therefore achiral component T using compound (1′), compound (2′) and compound (3) also develops a wide liquid crystal phase temperature range or large dielectric anisotropy. Therefore, the optically isotropic liquid crystal composition using achiral component T is also useful as a composition used for an optical device.

### 3-2 Chiral Agent

The chiral agent contained in the optically isotropic liquid crystal composition or the like according to the invention is an optically active compound, and preferably composed of a compound selected from compounds having no radically polymerizable group.

As the chiral agent used in the liquid crystal composition of the invention, a compound having large helical twisting power is preferred. In the compound having the large helical twisting power, an amount of addition required for obtaining a desired pitch can be minimized, and therefore a rise of the driving voltage can be suppressed, and such a compound is advantageous in practical use. Specifically, compounds represented by formulas (K1) to (K6) are preferred. In addition, in formulas (K4) to (K6), a binaphthyl group or an octahydronaphthyl group is an optically active moiety, and chirality of the chiral agent does not matter.

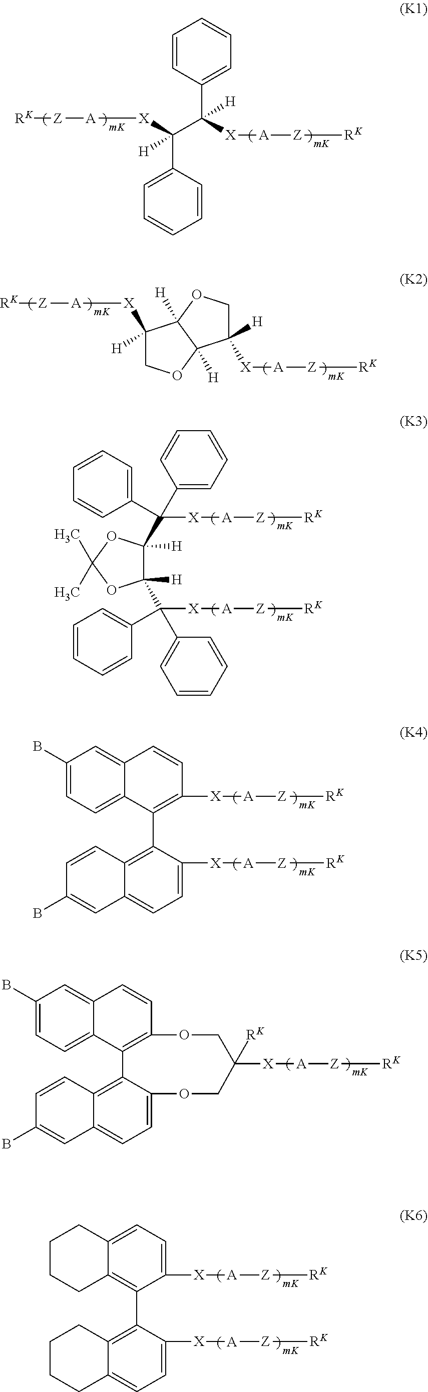

In the compounds, as the chiral agent to be added to the liquid crystal composition, formula (K4-1) to formula (K4-6) included in formula (K4), formula (K5-1) to formula (K5-3) included in formula (K5), and formula (K6-1) to formula (K6-6) included in formula (K6) are preferred, and formula (K4-5), formula (K5-1) to formula (K5-3) and formula (K6-5) to formula (K6-6) are further preferred.

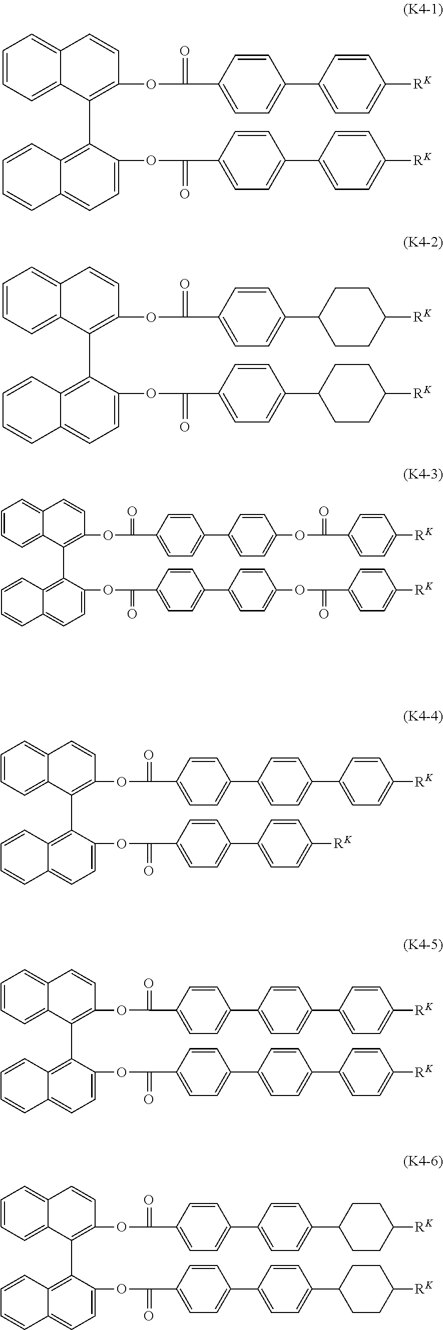

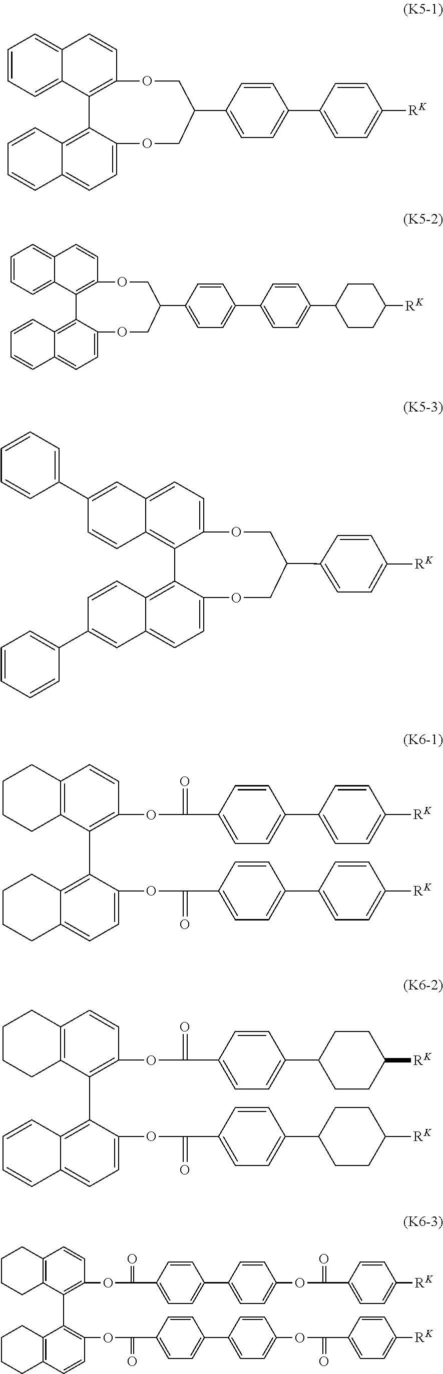

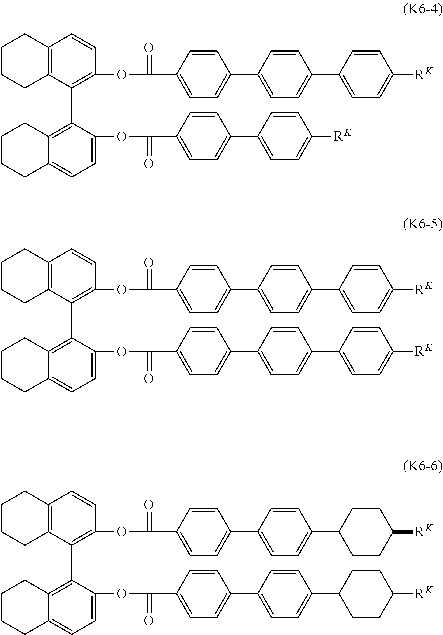

In the formulas, R^{K} is independently alkyl having 3 to 10 carbons or alkoxy having 3 to 10 carbons, and at least one or more pieces of —CH₂—CH₂— in the alkyl or the alkoxy may be replaced by —CH═CH—.

As the chiral agent to be contained in the liquid crystal composition, one compound may be used or a plurality of compounds may be used.

In order to facilitate development of the optically isotropic liquid crystal phase, the chiral agent is contained preferably in 1 to 40% by weight, further preferably in 3 to 25% by weight, and particularly preferably in 3 to 15% by weight, based on the total weight of the liquid crystal composition of the invention.

### 3-3 Optically Isotropic Liquid Crystal Phase

An expression “liquid crystal composition has optical isotropy” herein means that the liquid crystal composition exhibits the optical isotropy macroscopically because arrangement of liquid crystal molecules is isotropic, in which liquid crystal order is microscopically present. “Pitch based on the liquid crystal order of the liquid crystal composition microscopically (hereinafter, occasionally referred to simply as a pitch)” is preferably 700 nanometers or less, further preferably 500 nanometers or less, and most preferably 350 nanometers or less.

“Non-liquid crystal isotropic phase” herein means a generally defined isotropic phase, more specifically, a disorder phase, and an isotropic phase in which, even if a local area in which an order parameter is not zero is produced, the area is caused by a fluctuation. For example, an isotropic phase developed on a side of a higher temperature of the nematic phase corresponds to a non-liquid crystal isotropic phase herein. A similar definition is applied to chiral liquid crystals herein.

“Optically isotropic liquid crystal phase” herein represents a phase that develops the optically isotropic liquid crystal phase, and not by the fluctuation. One example includes a phase that develops a platelet texture (blue phase in a narrow sense).

Unless otherwise noted, the nematic phase herein means the nematic phase including no chiral nematic phase in the narrow sense.

In the optically isotropic liquid crystal composition of the invention, the platelet texture typical to the blue phase may not be occasionally observed under observation by means of a polarizing microscope although the liquid crystal composition has the optically isotropic liquid crystal phase. Then, a phase having the platelet texture developed herein is referred to as the blue phase, and the optically isotropic liquid crystal phase including the blue phase is referred to as the optically isotropic liquid crystal phase. More specifically, the blue phase is included in the optically isotropic liquid crystal phase.

In general, the blue phases are classified into three kinds, namely, blue phase I, blue phase II and blue phase III, and all of the three kinds of blue phases are optically active, and isotropic. In the blue phase of blue phase I or blue phase II, two or more kinds of diffracted light resulting from Bragg reflection from different lattice planes are observed. The blue phase is generally observed between the non-liquid crystal isotropic phase and a chiral nematic phase.

“State in which the optically isotropic liquid crystal phase does not exhibit diffracted light having two or more colors” means that the optically isotropic liquid crystal phase has almost monochrome in everywhere in which the platelet texture to be observed in blue phase I and blue phase II is not observed. In the optically isotropic liquid crystal phase that exhibits no diffracted light having two or more colors, uniformity of contrast in the plane is unnecessary.

The optically isotropic liquid crystal phase that exhibits no diffracted light having two or more colors has advantages in which intensity of reflected light by Bragg reflection is suppressed, or reflection is shifted to a side of a lower wavelength.

Moreover, in a liquid crystal medium that reflects visible light, color may occasionally become a problem in utilization in the form of the display device, but in liquid crystal phases that exhibit no diffracted light having two or more colors, a reflection wavelength is shifted to a lower wavelength, and therefore reflection of visible light can be allowed to disappear by a pitch longer than a pitch of the blue phase in the narrow sense (phase having the platelet texture developed).

In the liquid crystal composition containing achiral component T and the chiral agent according to the invention, the chiral agent is added preferably at a concentration to be 700 nanometers or less in the pitch. In addition, the composition that develops the nematic phase contains compound (1′), compound (2′) and compound (3), and when necessary, other components.

Moreover, the optically isotropic liquid crystal composition of the invention can also be obtained by adding the chiral agent to the composition having the chiral nematic phase and no optically isotropic liquid crystal phase. In addition, a composition having the chiral nematic phase and no optically isotropic liquid crystal contains compound (1′), compound (2′) compound (3) and the optically active compound, and when necessary, other components. On the above occasion, in order to allow no development of the optically isotropic liquid crystal phase, the chiral agent is added preferably at a concentration to be 700 nanometers or more in the pitch. Here, as the agent to be added, formulas (K1) to (K5) as the compound having large helical twisting power as described above can be used, and a compound represented by formulas (K2-1) to (K2-8), formulas (K4-1) to (K4-6), formulas (K5-1) to (K5-3) or formulas (K6-1) to (K6-6) is further preferably used.

The temperature range in which the liquid crystal composition of the preferred aspect according to the invention develops the optically isotropic liquid crystal phase can be extended by adding the chiral agent to the liquid crystal composition in which the temperature range of coexistence of the nematic phase or the chiral nematic phase and the isotropic phase is wide to develop the optically isotropic liquid crystal phase. For example, the composition that develops the optically isotropic liquid crystal phase in the wide temperature range can be prepared by mixing a liquid crystal compound having a high clearing point and a liquid crystal compound having a low clearing point to prepare a liquid crystal composition in which the temperature range of coexistence of the nematic phase and the isotropic phase is wide in the wide temperature range, and adding the chiral agent thereto.

As the liquid crystal composition having the wide temperature range of coexistence of the nematic phase or the chiral nematic phase and the isotropic phase, a liquid crystal composition in which a difference between the maximum temperature and the minimum temperature in which the chiral nematic phase and the non-liquid crystal isotropic phase coexist is 3 to 150° C. is preferred, and a liquid crystal composition in which a difference is 5 to 150° C. is further preferred. Moreover, a liquid crystal compound in which a difference between the maximum temperature and the minimum temperature in which the nematic phase and the non-liquid crystal isotropic phase coexist is 3 to 150° C. is also preferred.

If an electric field is applied to the liquid crystal medium of the invention in the optically isotropic liquid crystal phase, electric birefringence is caused, but the birefringence does not necessarily result from the Kerr effect.

Electric birefringence in the optically isotropic liquid crystal phase becomes larger as the pitch becomes longer, and therefore as long as requirements of other optical characteristics (transmittance, diffraction wavelength or the like) are satisfied, the electric birefringence can be increased by adjusting a kind and a content of the chiral agent and setting a long pitch.

### 3-4 any Other Component

The liquid crystal composition of the invention may further contain a solvent, a monomer, a polymer substance, a polymerization initiator, an antioxidant, an ultraviolet light absorbent, a curing agent, a stabilizer, a dichroic dye, a photochromic compound or the like within the range in which the characteristics of the composition are not significantly influenced.

Moreover, specific examples of the dichroic dye to be used in the liquid crystal composition of the invention include a merocyanine type, a styryl type, an azo type, an azomethine type, an azoxy type, a quinophthalone type, an anthraquinone type and a tetrazine type.

### 4 Optically Isotropic Polymer-Liquid Crystal Composite Material

### 4-1 Polymer-Liquid Crystal Composite Material

The polymer-liquid crystal composite material of the invention is a composite material containing the liquid crystal composition and the polymer to optically exhibit isotropy, and can be used in the optical device driven in the optically isotropic liquid crystal phase. The liquid crystal composition contained in the polymer-liquid crystal composite material of the invention is the liquid crystal composition of the invention.

“Polymer-liquid crystal composite material” herein is not particularly limited as long as the composite material contains both the liquid crystal composition and the polymer compound, but may be in a state in which the polymer is subjected to phase separation from the liquid crystal composition in a state in which the polymer is not partially or wholly dissolved into the liquid crystal composition, the solvent or the like.

The optically isotropic polymer-liquid crystal composite material according to the preferred aspect of the invention can develop the optically isotropic liquid crystal phase in the wide temperature range. Moreover, the polymer-liquid crystal composite material according to the preferred aspect of the invention has a significantly high response velocity. Moreover, the polymer-liquid crystal composite material according to the preferred aspect of the invention can be preferably used for the optical device such as the display device, based on the effects.

### 4-2 Polymer Compound

The composite material of the invention can also be manufactured by mixing the optically isotropic liquid crystal composition and the polymer obtained by allowing polymerization in advance, but is preferably manufactured by mixing a low molecular weight monomer, a macro monomer, an oligomer or the like (hereinafter, collectively referred to as “monomer or the like”) serving as a material of the polymer, and liquid crystal composition CLC, and then performing a polymerization reaction in the mixture. The mixture containing the monomer or the like and the liquid crystal composition is referred to as “polymerizable monomer-liquid crystal mixture” herein. “Polymerizable monomer-liquid crystal mixture” may contain, when necessary, a polymerization initiator, a curing agent, a catalyst, a stabilizer, a dichroic dye or a photochromic compound or the like as described later in the range in which advantageous effects of the invention are not adversely affected. For example, the polymerizable monomer-liquid crystal mixture of the invention may contain, when necessary, 0.1 to 20 parts by weight of the polymerization initiator based on 100 parts by weight of the polymerizable monomer. “Polymerizable monomer-liquid crystal mixture” is essentially the liquid crystal medium when the mixture is polymerized in the blue phase, but when the mixture is polymerized in the isotropic phase, the mixture is not necessarily the liquid crystal medium.

Polymerization temperature preferably includes temperature at which the polymer-liquid crystal composite material exhibits high transparency and isotropy. The polymerization temperature further preferably includes temperature at which the mixture of the monomer and the liquid crystal material develops the isotropic phase or the blue phase, and the polymerization is terminated in the isotropic phase or the optically isotropic liquid crystal phase. More specifically, the polymerization temperature is preferably adjusted to temperature at which, after the polymerization, the polymer-liquid crystal composite material does not substantially scatter light on a side of a wavelength longer than a wavelength of visible light and develops an optically isotropic state.

As a raw material of the polymer that constitutes the composite material of the invention, for example, the low molecular weight monomer, the macromonomer or the oligomer can be used, and a polymer raw material monomer herein is used in a meaning of including the low molecular weight monomer, the macromonomer and the oligomer. Moreover, the polymer obtained preferably has a three-dimensional crosslinking structure, and therefore a polyfunctional monomer having two or more polymerizable functional groups is preferably used as the raw material monomer of the polymer. The polymerizable functional group is not particularly limited, and specific examples include an acrylic group, a methacrylic group, a glycidyl group, an epoxy group, an oxetanyl group and a vinyl group, and preferably the acrylic group and the methacrylic group from a viewpoint of a rate of polymerization. Among the raw material monomers of the polymer, if a monomer having two or more polymerizable functional groups is contained in the monomer in 10% by weight or more, high-level transparency and isotropy are easily developed in the composite material of the invention, and therefore such a case is preferred.

Moreover, in order to obtain a preferred composite material, the polymer preferably has a mesogen moiety, and a raw material monomer having the mesogen moiety can be partially or wholly used as the raw material monomer of the polymer.

### 4-2-1 Monofunctional, Bifunctional or Trifunctional Monomer Having Mesogen Moiety

A monofunctional or bifunctional monomer having the mesogen moiety is not particularly limited structurally, and specific examples include a compound represented by formula (M1) or formula (M2) described below.

R^{a}—Y-A^{M}-Z^{M})ₘ₁-A^{M}-Y—R^{b} (M1)

R^{b}—Y-(A^{M}-Z^{M})ₘ₁-A^{M}-Y—R^{b} (M2)

In formula (M1), R^{a} is hydrogen, halogen, —C≡N, —N═C═O, —N═C═S or alkyl having 1 to 20 carbons, and in the alkyl, at least one —CH₂— may be replaced by —O—, —S—, —CO—, —COO— or —OCO—, and at least one —CH₂—CH₂— in the alkyl may be replaced by —CH═CH—, —CF═CF— or —C≡C—, and in the alkyl groups, at least one hydrogen in the group in which at least one —CH₂— in the alkyl is replaced by —O—, —S—, —COO— or —OCO—, or in the group in which at least one —CH₂—CH₂— in the alkyl is replaced by —CH═CH— or —C≡C— may be replaced by halogen or —C≡N. R^{b} is each independently a polymerizable group of formula (M3-1) to formula (M3-7).

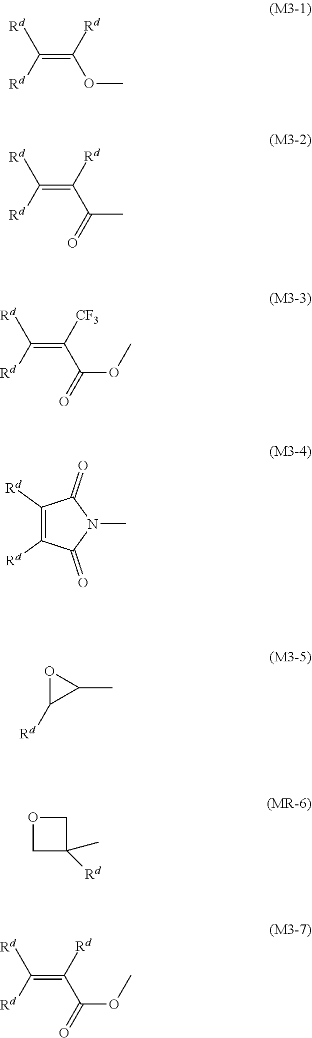

Preferred R^{a} is hydrogen, halogen, —C≡N, —CF₃, —CF₂H, —CFH₂, —OCF₃, —OCF₂H, alkyl having 1 to 20 carbons, alkoxy having 1 to 19 carbons, alkenyl having 2 to 21 carbons and alkynyl having 2 to 21 carbons. Particularly preferred R^{a} is —C≡N, alkyl having 1 to 20 carbons and alkoxy having 1 to 19 carbons.

In formula (M2), R^{b} is each independently a polymerizable group represented by formulas (M3-1) to (M3-7).

Here, R^{d} in formulas (M3-1) to (M3-7) is each independently hydrogen, halogen or alkyl having 1 to 5 carbons, and in the alkyl, at least one hydrogen may be replaced by halogen. Preferred R^{d} is hydrogen, halogen and methyl. Particularly preferred R^{d} is hydrogen, fluorine and methyl.

Moreover, the monomers represented by formula (M3-2), formula (M3-3), formula (M3-4) and formula (M3-7) are preferably polymerized by radical polymerization. The monomers represented by formula (M3-1), formula (M3-5) and formula (M3-6) are preferably polymerized by cationic polymerization. If a small amount of radicals or cation active species is generated in a reaction system in all, the polymerization starts. The polymerization initiator can be used for the purpose of accelerating generation of the active species. Light or heat can be used for generation of the active species, for example.

In formulas (M1) and (M2), A^{M} is each independently an aromatic or non-aromatic 5-membered ring or 6-membered ring, or a fused ring having 9 or more carbons, but —CH₂— in the ring may be replaced by —O—, —S—, —NH— or —NCH₃—, and —CH═ in the ring may be replaced by —N═, and a hydrogen atom on the ring may be replaced by halogen, and alkyl or alkyl halide having 1 to 5 carbons. Specific examples of preferred A^{M} include 1,4-cyclohexylene, 1,4-cyclohexenylene, 1,4-phenylene, naphthalene-2,6-diyl, tetrahydronaphthalene-2,6-diyl, fluorene-2,7-diyl or bicyclo[2.2.2]octane-1,4-diyl, and in the rings, at least one —CH₂— may be replaced by —O—, at least one —CH═ may be replaced by —N═, and in the rings, at least one hydrogen may be replaced by halogen, alkyl having 1 to 5 carbons or alkyl halide having 1 to 5 carbons.

In taking into account the stability of the compound, —CH₂—O—CH₂—O— in which oxygen and oxygen are not adjacent is preferred to —CH₂—O—O—CH₂— in which oxygen and oxygen are adjacent. A same rule applies also to sulfur.

Above all, particularly preferred A^{M} is 1,4-cyclohexylene, 1,4-cyclohexenylene, 1,4-phenylene, 2-fluoro-1,4-phenylene, 2,3-difluoro-1,4-phenylene, 2,5-difluoro-1,4-phenylene, 2,6-difluoro-1,4-phenylene, 2-methyl-1,4-phenylene, 2-trifluoromethyl-1,4-phenylene, 2,3-bis(trifluoromethyl-1,4-phenylene, naphthalene-2,6-diyl, tetrahydronaphthalene-2,6-diyl, fluorene-2,7-diyl, 9-methylfluorene-2,7-diyl, 1,3-dioxane-2,5-diyl, pyridine-2,5-diyl and pyrimidine-2,5-diyl. In addition, with regard to a configuration of the 1,4-cyclohexylene and the 1,3-dioxane-2,5-diyl, trans is preferred to cis.

Then, 2-fluoro-1,4-phenylene is structurally identical with 3-fluoro-1,4-phenylene, and therefore the latter is not illustrated. A same rule applies also to a relation between 2,5-difluoro-1,4-phenylene and 3,6-difluoro-1,4-phenylene, or the like.

In formulas (M1) and (M2), Y is each independently a single bond or alkylene having 1 to 20 carbons, and in the alkylene, at least one —CH₂— may be replaced by —O— or —S—, and at least one —CH₂—CH₂— in the alkyl may be replaced by —CH═CH—, —C≡C—, —COO— or —OCO—. Preferred Y is a single bond, —(CH₂)ₘ₂—, —O(CH₂)ₘ₂— and —(CH₂)ₘ₂O— (in the formulas, m2 is an integer from 1 to 20). Particularly preferred Y is a single bond, —(CH₂)ₘ₂—, —O(CH₂)ₘ₂— and —(CH₂)ₘ₂O— (in the formula, m2 is an integer from 1 to 10). In view of stability of the compound, —Y—R^{a} and —Y—R^{b} do not have —O—O—, —O—S—, —S—O— or —S—S— in the groups, preferably.

In formulas (M1) and (M2), Z^{M} is each independently a single bond, —(CH₂)ₘ₃—, —O(CH₂)ₘ₃—, —(CH₂)ₘ₃O—, —O(CH₂)ₘ₃O—, —CH═CH—, —C≡C—, —COO—, —OCO—, —(CF₂)₂—, —(CH₂)₂—COO—, —OCO—(CH₂)₂—, —CH═CH—COO—, —OCO—CH═CH—, —C≡C—COO—, —OCO—C≡C—, —CH═CH—(CH₂)₂—, —(CH₂)₂—CH═CH—, —CF═CF—, —C≡C—CH═CH—, —CH═CH—C≡C—, —OCF₂—(CH₂)₂—, —(CH₂)₂—CF₂O—, —OCF₂— or —CF₂O— (in the formulas, m3 is an integer from 1 to 20).

Preferred Z^{M} is a single bond, —(CH₂)ₘ₃—, —O(CH₂)ₘ₃—, —(CH₂)ₘ₃O—, —CH═CH—, —C≡C—, —COO—, —OCO—, —(CH₂)₂—COO—, —OCO—(CH₂)₂—, —CH═CH—COO—, —OCO—CH═CH—, —OCF₂— and —CF₂O—.

In formulas (M1) and (M2), m1 is an integer from 1 to 6. Preferred m1 is an integer from 1 to 3. When m1 is 1, the formulas represent a bicyclic compound having two rings such as a 6-membered ring. When m1 is 2 and 3, the formulas represent a tricyclic compound and a tetracyclic compound, respectively. For example, when m1 is 1, two pieces of A^{M} may be identical or different. Moreover, for example, when m1 is 2, three pieces of A^{M} (or two pieces of Z^{M}) may be identical or different. When m1 is 3 to 6, a same rule applies also thereto. A same rule applies also to R^{a}, R^{b}, R^{d}, Z^{M}, A^{M} and Y.

Even if compound (M1) represented by formula (M1) and compound (M2) represented by formula (M2) contain an isotope such as ²H (deuterium) and ¹³C in an amount higher than natural abundance, compound (M1) and compound (M2) can be preferably used because of having similar characteristics.

Specific examples of further preferred compound (M1) and further preferred compound (M2) include compounds (M1-1) to (M1-41) and compounds (M2-1) to (M2-27) as represented by formulas (M1-1) to (M1-41) and formulas (M2-1) to (M2-27). In the compounds, definitions of R^{a}, R^{b}, R^{d}, Z^{M}, A^{M} and Y are identical with definitions thereof in formula (M1) and formula (M2) as described in the aspect of the invention.

Partial structure described below in compounds (M1-1) to (M1-41) and (M2-1) to (M2-27) will be described. Partial structure (a1) represents 1,4-phenylene in which at least one hydrogen is replaced by fluorine. Partial structure (a2) represents 1,4-phenylene in which at least one hydrogen may be replaced by fluorine. Partial structure (a3) represents 1,4-phenylene in which at least one hydrogen may be replaced by any one of fluorine or methyl. Partial structure (a4) represents fluorene in which hydrogen in 9-position may be replaced by methyl.

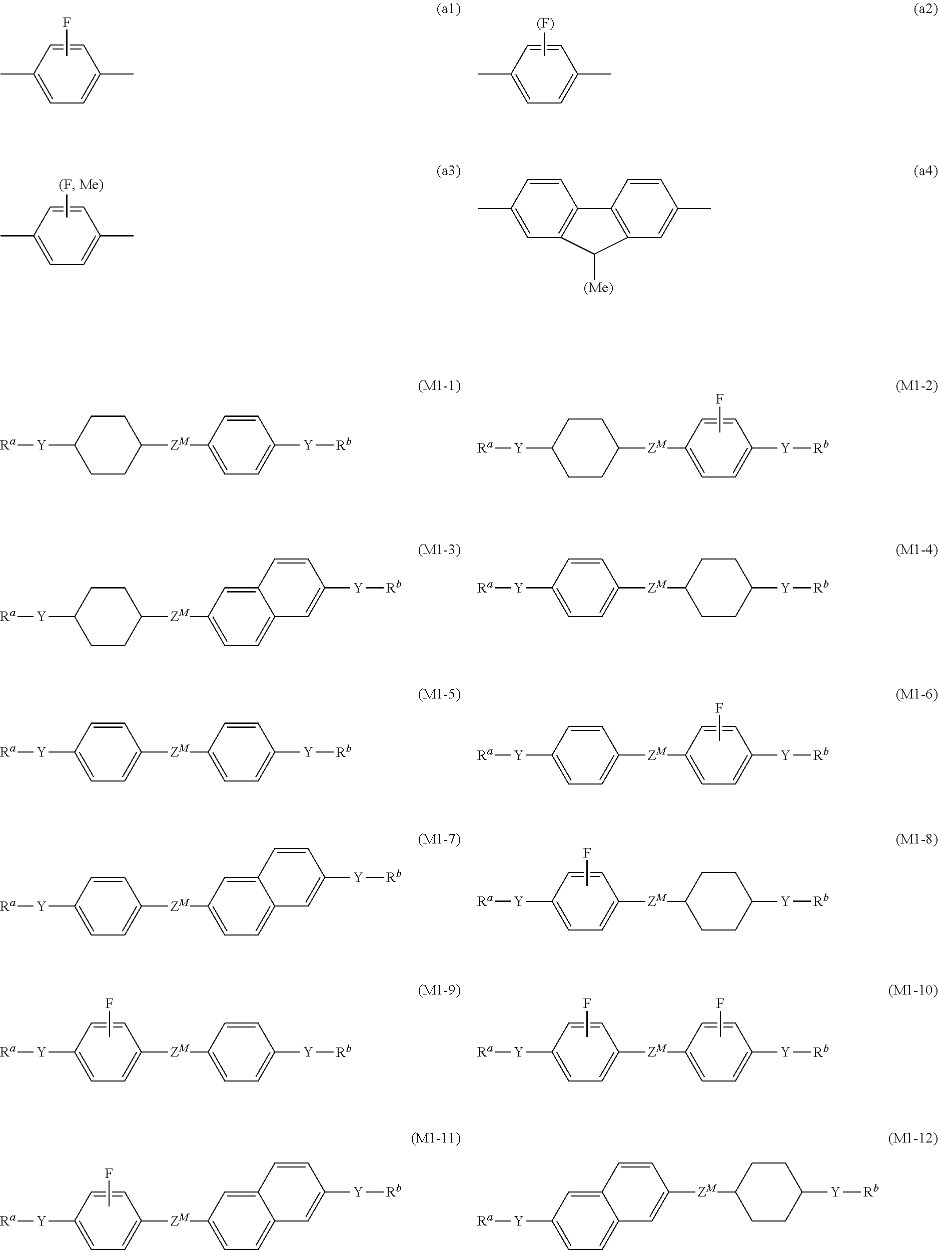

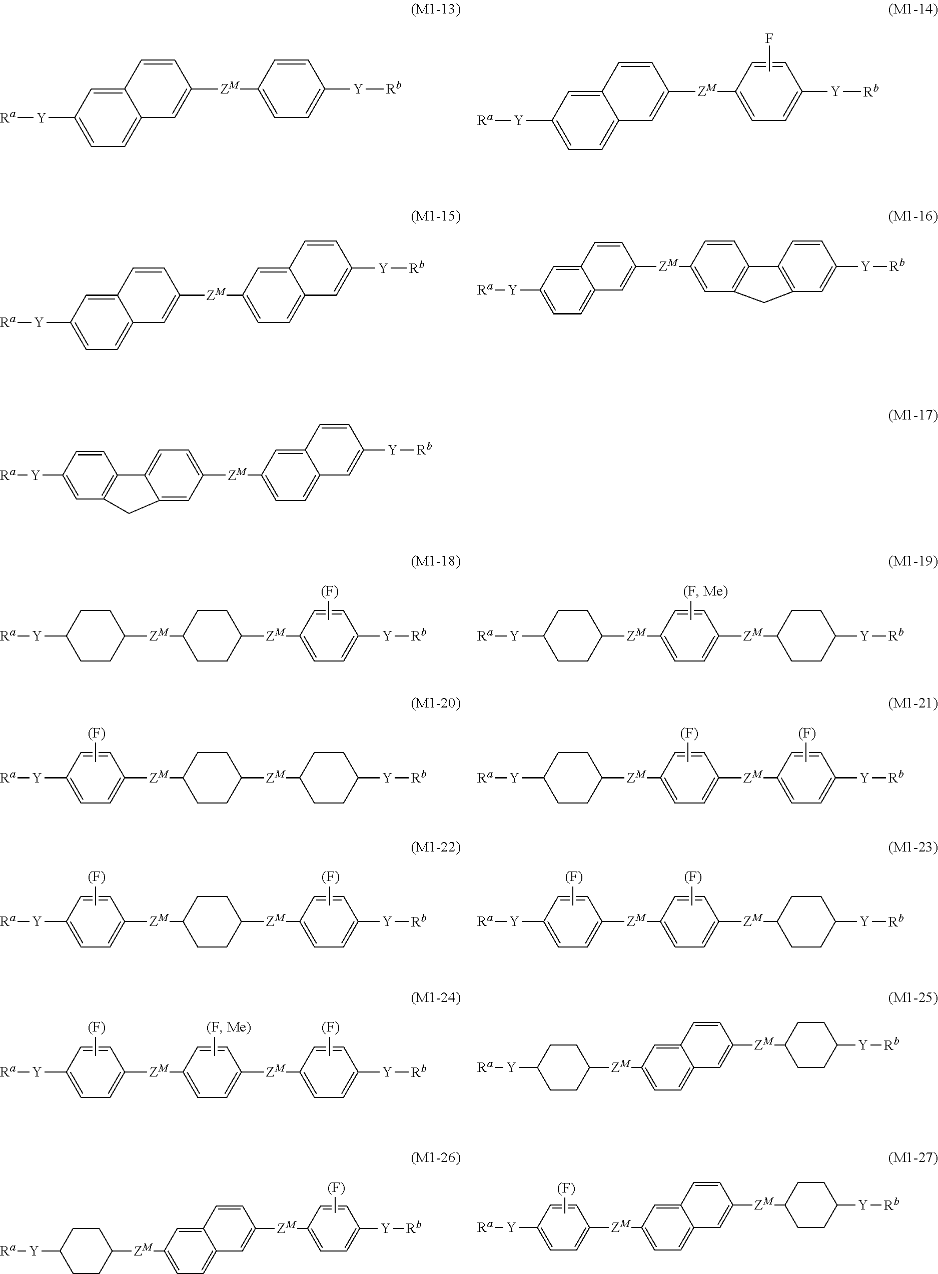

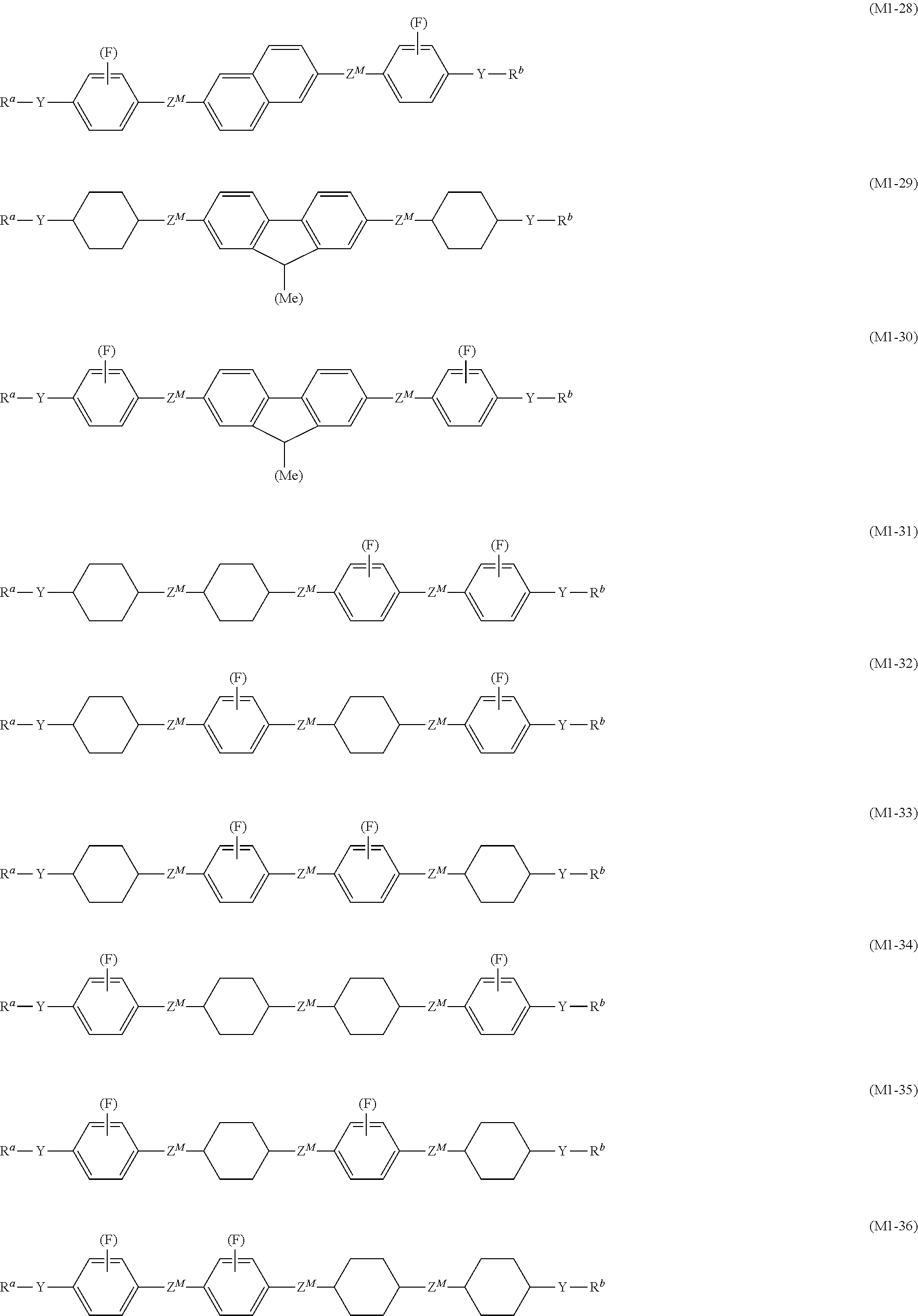

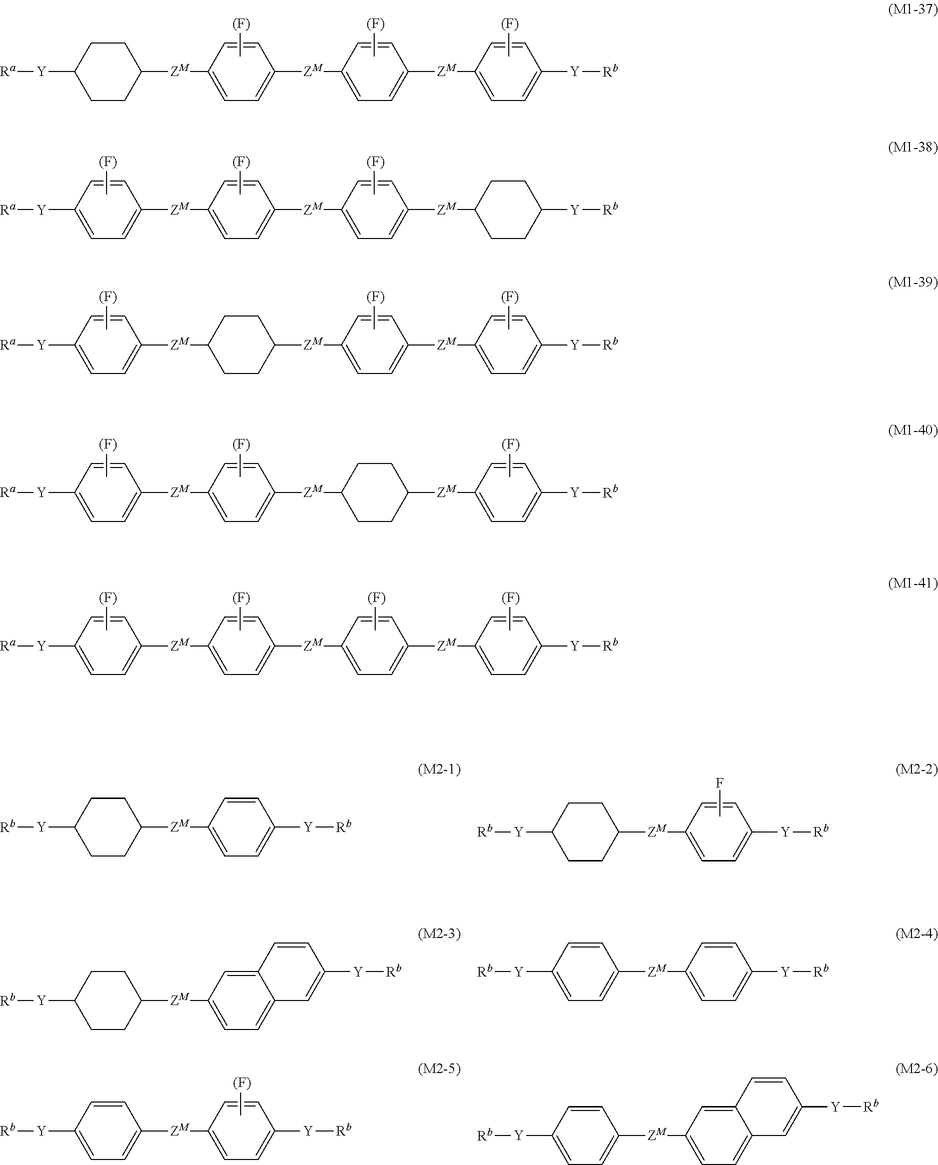

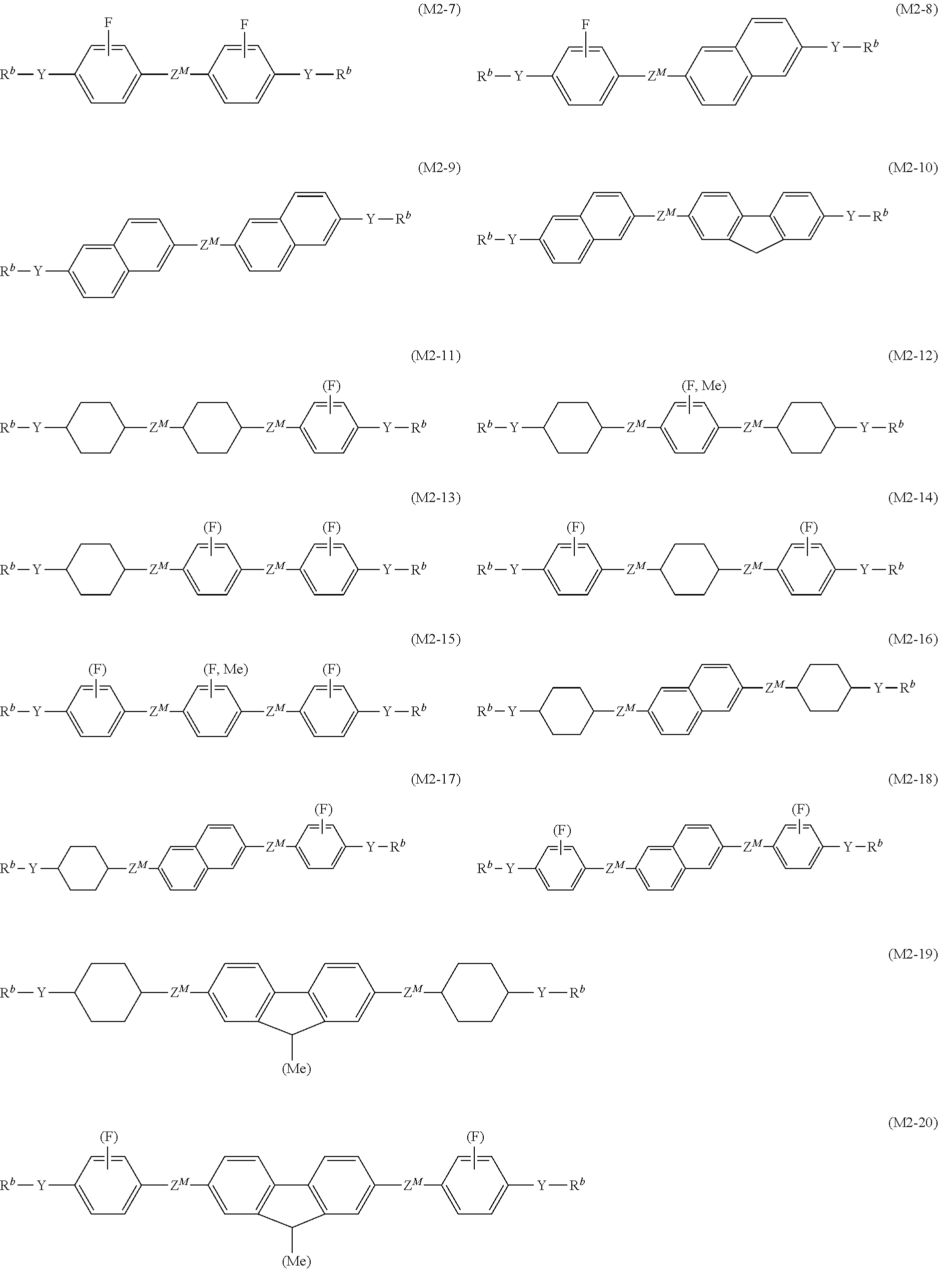

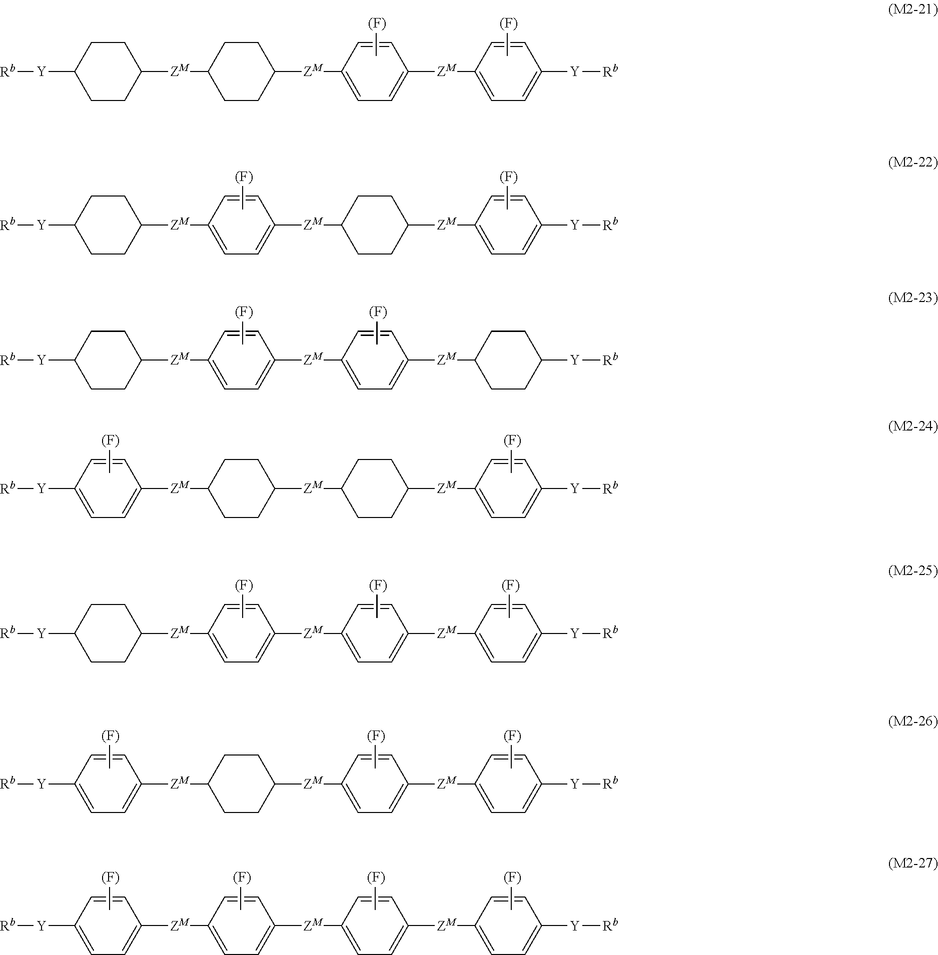

A monomer having no mesogen moiety and a polymerizable compound other than monomers (M1) and (M2) having the mesogen moiety as described above can be used when necessary.

For the purpose of optimizing the optical isotropy of the polymer-liquid crystal composite material of the invention, a monomer having a mesogen moiety and three or more polymerizable functional groups can also be used. As the monomer having the mesogen moiety and three or more polymerizable functional groups, a publicly known compound can be preferably used, and specific examples include (M4-1) to (M4-3), and further specific examples include compounds described in JP 2000-327632 A, JP 2004-182949 A and JP 2004-59772 A. However, in (M4-1) to (M4-3), R^{b}, Z^{M}, Y and (F) are defined in a manner identical with the definitions described above.

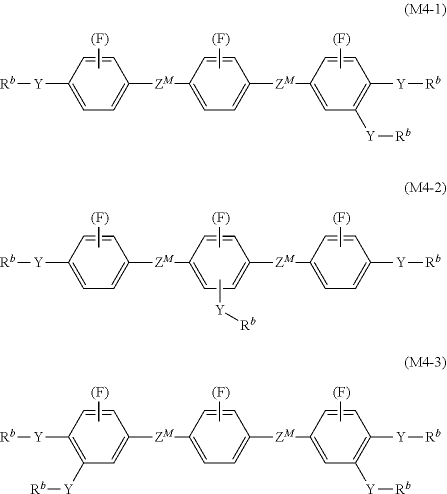

### 4-2-2 Monomer Having No Mesogen Moiety and Having Polymerizable Functional Group

Specific examples of a monomer having no mesogen moiety and having a polymerizable functional group include a straight-chain or branched-chain acrylate having 1 to 30 carbons, or a straight-chain or branched-chain diacrylate having 1 to 30 carbons, and specific examples of a monomer having three or more polymerizable functional groups include glycerol propoxylate (1 PO/OH) triacrylate, pentaerythritol propoxylate triacrylate, pentaerythritol triacrylate, trimethylolpropane ethoxylate triacrylate, trimethylolpropane propoxylate triacrylate, trimethylolpropane triacrylate, di(trimethylolpropane) tetraacrylate, pentaerythritol tetraacrylate, di(pentaerythritol) pentaacrylate, di(pentaerythritol) hexaacrylate and trimethylolpropane triacrylate, but are not limited thereto.

### 4-2-3 Polymerization Initiator

The polymerization reaction in manufacture of the polymer that constitutes the composite material of the invention is not particularly limited, and for example, photoradical polymerization, thermal radical polymerization, photocationic polymerization or the like is performed.

Specific examples of a photoradical polymerization initiator that can be used in the photoradical polymerization include DAROCUR 1173 and 4265 (trade names for both, BASF Japan, Ltd.), and IRGACURE 184, 369, 500, 651, 784, 819, 907, 1300, 1700, 1800, 1850 and 2959 (trade names for all, BASF Japan, Ltd.)

Specific examples of a preferred thermal radical polymerization initiator that can be used in the thermal radical polymerization include benzoyl peroxide, diisopropyl peroxydicarbonate, t-butyl peroxy-2-ethylhexanoate, t-butyl peroxypivalate, t-butyl peroxydiisobutyrate, lauroyl peroxide, 2,2′-azobis(methyl isobutyrate) (MAIB), di-t-butyl peroxide (DTBPO), azobisisobutyronitrile (AIBN) and azobis(cyclohexanecarbonitrile) (ACN).

Specific examples of a photocationic polymerization initiator that can be used in the photocationic polymerization include diaryliodonium salt (hereinafter, referred to as “DAS”) and a triarylsulfonium salt (hereinafter, referred to as “TAS”).

Specific examples of DAS include diphenyliodonium tetrafluoroborate, diphenyliodonium hexafluorophosphonate, diphenyliodonium hexafluoroarsenate, diphenyliodonium trifluoromethane sulfonate, diphenyliodonium trifluoroacetate, diphenyliodonium-p-toluene sulfonate, diphenyliodonium tetra(pentafluorophenyl)borate, 4-methoxyphenylphenyliodonium tetrafluoroborate, 4-methoxyphenylphenyliodonium hexafluorophosphonate, 4-methoxyphenylphenyliodonium hexafluoroarsenate, 4-methoxyphenylphenyliodonium trifluoromethane sulfonate, 4-methoxyphenylphenyliodonium trifluoroacetate and 4-methoxyphenylphenyliodonium-p-toluene sulfonate.

An improvement in sensitivity of DAS can also be achieved by adding a photosensitizer such as thioxanthone, phenothiazine, chlorothioxanthone, xanthone, anthracene, diphenylanthracene and rubrene to DAS.

Specific examples of TAS include triphenylsulfonium tetrafluoroborate, triphenylsulfonium hexafluorophosphonate, triphenylsulfonium hexafluoroarsenate, triphenylsulfonium trifluoromethanesulfonate, triphenylsulfonium trifluoroacetate, triphenylsulfonium p-toluenesulfonate, triphenylsulfonium tetra(pentafluorophenyl) borate, 4-methoxyphenyldiphenylsulfonium tetrafluoroborate, 4-methoxyphenyldiphenylsulfonium hexafluorophosphonate, 4-methoxyphenyldiphenylsulfonium hexafluoroarsenate, 4-methoxyphenyldiphenylsulfonium trifluoromethane sulfonate, 4-methoxyphenyldiphenylsulfonium trifluoroacetate and 4-methoxyphenyldiphenylsulfonium-p-toluene sulfonate.

Specific examples of the trade names of the photocationic polymerization initiator include Cyracure UVI-6990, Cyracure UVI-6974, and Cyracure UVI-6992 (trade names, respectively, UCC Corporation), ADEKA Optomer SP-150, SP-152, SP-170, SP-172 (trade names, respectively, ADEKA Corporation), Rhodorsil Photoinitiator 2074 (trade name, Rhodia Japan, Ltd.), IRGACURE 250 (trade name, BASF Japan, Ltd.) and UV-9380C (trade name, GE Toshiba Silicones, Co., Ltd.).

### 4-2-4 Curing Agent or the Like

In manufacture of the polymer that constitutes the composite material of the invention, in addition to the monomer or the like and the polymerization initiator, one kind or two or more kinds of other preferred components, for example, the curing agent, the catalyst and the stabilizer may be added thereto.

As the curing agent, a conventionally publicly known latent curing agent that has been ordinarily used as a curing agent for an epoxy resin can be used. Specific examples of the latent curing agent for the epoxy resin include an amine curing agent, a novolak resin curing agent, an imidazole curing agent and an acid anhydride curing agent. Specific examples of the amine curing agent include aliphatic polyamine such as diethylenetriamine, triethylenetetramine, tetraethylenepentamine, m-xylenediamine, trimethylhexamethylenediamine, 2-methylpentamethylenediamine and diethylaminopropylamine, alicyclic polyamine such as isophoronediamine, 1,3-bisaminomethylcyclohexane, bis(4-aminocyclohexyl)methane, norbornenediamine, 1,2-diaminocyclohexane and Laromin, and aromatic polyamine such as diaminodiphenylmethane, diaminodiphenylethane and m-phenylenediamine.

Specific examples of the novolak resin curing agent include a phenol novolak resin and a bisphenol novolak resin. Specific examples of the imidazole curing agent include 2-methylimidazole, 2-ethylhexilimidazole, 2-phenylimidazole and 1-cyanoethyl-2-phenylimidazolium trimellitate.

Specific examples of the acid anhydride curing agent include tetrahydrophthalic anhydride, hexahydrophthalic anhydride, methyltetrahydrophthalic anhydride, methylhexahydrophthalic anhydride, methylcyclohexene tetracarboxylic dianhydride, phthalic anhydride, trimellitic anhydride, pyromellitic anhydride and benzophenonetetracarboxylic dianhydride.

Moreover, a curing accelerator for promoting a curing reaction of the polymerizable compound having a glycidyl group, an epoxy group or an oxetanyl group and the curing agent may be further used. Specific examples of the curing accelerator include tertiary amines such as benzyldimethylamine, tris(dimethylaminomethyl)phenol and dimethylcyclohexylamine, imidazoles such as 1-cyanoethyl-2-ethyl-4-methylimidazole and 2-ethyl-4-methylimidazole, an organic phosphorus compound such as triphenylphosphine, quaternary phosphonium salts such as tetraphenylphosphonium bromide, diazabicycloalkenes such as 1,8-diazabicyclo[5.4.0]undecene-7 and an organic acid salt thereof, quaternary ammonium salts such as tetraethylammonium bromide and tetrabutylammonium bromide, and a boron compound such as boron trifluoride and triphenyl borate. The curing accelerators can be used alone or by mixing a plurality thereof.

Moreover, in order to prevent undesired polymerization during storage, for example, addition of the stabilizer is preferred. As the stabilizer, all the compounds known to those skilled in the art can be used. Typified examples of the stabilizer include 4-ethoxyphenol, hydroquinone and butylated hydroxytoluene (BHT).

### 4-3 Composition of Polymer-Liquid Crystal Composite Material

A content of the liquid crystal composition in the polymer-liquid crystal composite material of the invention is preferably as high as possible if the content is within the range in which the composite material can develop the optically isotropic liquid crystal phase. The reason is that a value of the electric birefringence of the composite material of the invention becomes larger as the content of the liquid crystal composition is higher.

In the polymer-liquid crystal composite material of the invention, the content of the liquid crystal composition is preferably 60 to 99% by weight, further preferably 60% by weight to 98% by weight, and particularly preferably 80% by weight to 97% by weight, based on the composite material. Moreover, in the polymer-liquid crystal composite material of the invention, a content of the polymer is preferably 1% by weight to 40% by weight, further preferably 2% by weight to 40% by weight, and particularly preferably 3% by weight to 20% by weight, based on the composite material.

### 5 Optical Device

The optical device of the invention includes an optical device driven in the optically isotropic liquid crystal phase including the liquid crystal composition or the polymer-liquid crystal composite material (hereinafter, the liquid crystal composition and the polymer-liquid crystal composite material of the invention may be occasionally referred to generically as the liquid crystal medium).

The liquid crystal medium is optically isotropic when no electric field is applied, but when the electric field is applied, the optical anisotropy is caused in the liquid crystal medium, and optical modulation by the electric field can be made.

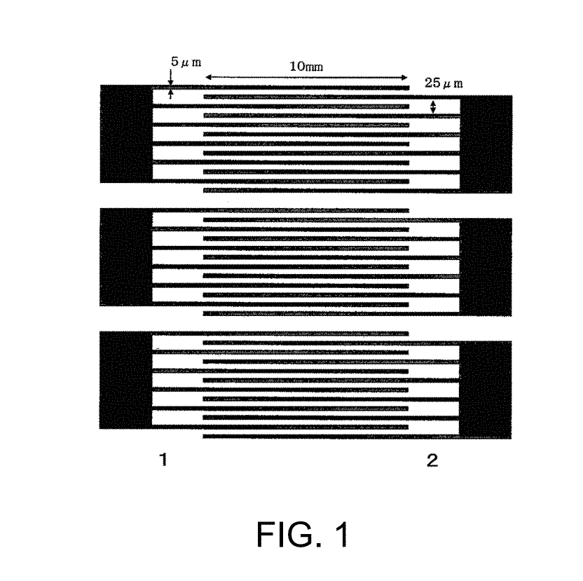

Specific examples of structure of a liquid crystal display device include, as shown in FIG. 1, the structure in which electrode 1 extended from a left side and electrode 2 extended from a right side are alternately arranged in electrodes of a comb-shaped electrode substrate. When a potential difference exists between electrode 1 and electrode 2, on the comb-shaped electrode substrate as shown in FIG. 1, if attention is paid to one electrode, a state in which electric fields in two directions, namely an upward direction and a downward direction on DRAWINGS exist, can be provided.

The liquid crystal composition of the invention can be used in the optical device. The liquid crystal composition of the invention exhibits a low driving voltage and a short response time, and therefore the optical device according to the preferred aspect of the invention can be driven at low voltage and allowed to provide a high speed response.

### EXAMPLES

The invention will be described in more detail by way of Examples below, but the invention is not limited by the Examples. In addition, unless otherwise noted, “%” means “% by weight.”

Moreover, a compound obtained was identified using a nuclear magnetic resonance spectrum obtained according to ¹H-NMR analysis, a gas chromatogram obtained according to gas chromatography (GC) analysis, or the like. Analytical methods were as described below.

### 1) Analytical Methods

### 1-1) ¹H-NMR Analysis

As a measuring apparatus, DRX-500 (trade name, made by Bruker BioSpin Corporation) was used. A sample prepared in Example or the like was dissolved in a deuterated solvent such as CDCl₃ in which the sample was soluble, and measurement was carried out under conditions of room temperature, 500 MHz and 24 times of accumulation. In addition, in explanation of a nuclear magnetic resonance spectrum obtained, s, d, t, q and m stand for a singlet, a doublet, a triplet, a quartet and a multiplet, respectively. Moreover, tetramethylsilane (TMS) was used as a reference material for a zero point of chemical shifts (δ values)

### 1-2) GC Analysis

As a measuring apparatus, GC-14B Gas Chromatograph made by Shimadzu Corporation was used. As a column, capillary column CBP1-M25-025 (length 25 m, bore 0.22 mm, film thickness 0.25 μm; and dimethylpolysiloxane as a stationary liquid phase; non-polar) made by Shimadzu Corporation were used. Helium was used as a carrier gas, and a flow rate was adjusted at 1 mL/min. A temperature of a sample vaporizing chamber and a temperature of a detector (FID) part were set to 300° C. and 300° C., respectively.

A sample was dissolved in toluene and prepared to be a 1 weight % solution, and then 1 microliter of the solution obtained was injected into the sample vaporizing chamber.

As a recorder, C-R6A Chromatopac made by Shimadzu Corporation or the equivalent thereof was used. In the gas chromatograms obtained, a retention time of a peak corresponding to each of component compounds and values of peak areas are shown.

In addition, as a solvent for diluting the sample, chloroform or hexane, for example, may be used. Moreover, as the column, capillary column DB-1 (length 30 m, bore 0.32 mm, film thickness 0.25 μm) made by Agilent Technologies Inc., HP-1 (length 30 m, bore 0.32 mm, film thickness 0.25 μm) made by Agilent Technologies Inc., Rtx-1 (length 30 m, bore 0.32 mm, film thickness 0.25 μm) made by Restek Corporation, BP-1 (length 30 m, bore 0.32 mm, film thickness 0.25 μm) made by SGE International Pty. Ltd., or the like may be used.

An area ratio of each peak in the gas chromatogram corresponds to a proportion of the component compounds. In general, weight percent of each of the component compounds in an analytical sample is not completely identical with a percentage of each of the peak areas in the analytical sample, but, when the column described above was used in the invention, the weight percent of each of the component compounds in the analytical sample substantially corresponds to the percentage of each of the peak areas in the analytical sample because a correction factor is essentially 1 (one). The reason is that no significant difference exists in the correction factor of the component in the liquid crystal compound. An internal standard method by the gas chromatograms is used in order to determine a composition ratio of the liquid crystal compounds in a liquid crystal composition more accurately by the gas chromatograms. Each liquid crystal compound component (test-component) weighed accurately in a fixed amount and a standard liquid crystal compound (standard reference material) are simultaneously measured according to gas chromatography, and the relative intensity of the ratio of the peak areas obtained between the test-component and the standard reference material is calculated in advance. When corrected based on the relative intensity of the peak area of each component relative to the standard reference material, the composition ratio of the liquid crystal compounds in the liquid crystal composition can be determined more accurately according to the gas chromatographic analysis.

### 1-3) Samples for Measuring Values of Physical Properties of Liquid Crystal Compound or the Like

A sample for measuring values of physical properties of a liquid crystal compound includes two types of cases: a case where the compound itself is used as the sample, and a case where the compound is mixed with a base liquid crystal to be used as the sample.

In the latter case where the sample prepared by mixing the compound with the base liquid crystal is used, measurement is carried out according to the method described below. First, the sample is prepared by mixing 15% of the liquid crystal compound obtained and 85% of the base liquid crystal. Then, according to an extrapolation method based on the calculation equation described below, extrapolated values are calculated from measured values of the sample obtained. The extrapolated values are taken as the values of physical properties of the compound.

[Extrapolated value]=(100×[measured value of a sample]−[% by weight of a base liquid crystal]×[measured value of the base liquid crystal])/[% by weight of a liquid crystal compound].

When a smectic phase or crystals precipitate at 25° C. even at the ratio of the liquid crystal compound to the base liquid crystal (15%:85%), a ratio of the liquid crystal compound to the base liquid crystal was changed in the order of (10%:90%), (5%:95%) and (1%:99%), the physical properties of the sample were measured at a composition in which no smectic phase or no crystals precipitated at 25° C., and the extrapolated values were determined according to the equation, and taken as the physical properties of the liquid crystal compound.

As the base liquid crystal used for measurements, a variety of kinds exist. For example, a composition (% by weight) of base liquid crystal A is as described below.

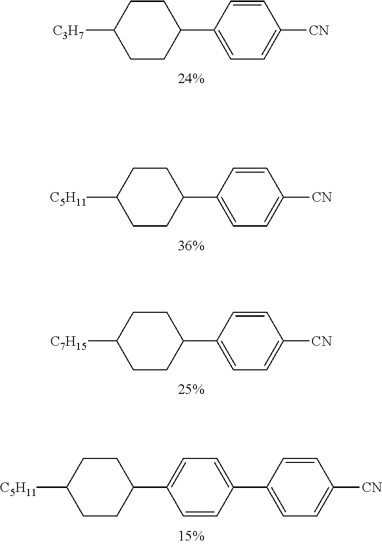

### 1-4) Methods for Measuring Values of Physical Properties of Liquid Crystal Compound or the Like

Measurement of values of physical properties was carried out according to the methods described below. Most of the measuring methods are described in EIAJ ED-2521A of the Standard of Electronic Industries Association of Japan, or modified thereon. Moreover, no TFT was attached to a TN device used for measurement.

Among measured values, in the case where the liquid crystal compound itself was used as the sample, the values obtained were described as experimental data. In the case where the mixture of the liquid crystal compound with the base liquid crystal was used as the sample, the values obtained according to the extrapolation method were described as experimental data.

### 1-4-1) Phase Structure and Phase Transition Temperature (° C.)

Measurement was carried out according to method (1) and method (2) described below.

(1) A compound was placed on a hot plate of a melting point apparatus (FP-52 Hot Stage made by Mettler Toledo International Inc.) equipped with a polarizing microscope, and a state of a phase and a change thereof were observed by the polarizing microscope while the compound was heated at a rate of 3° C./min, and a kind of a liquid crystal phase was specified.

(2) A sample was heated and then cooled at a rate of 3° C./min using a differential scanning calorimeter, DSC-7 System or Diamond DSC System, made by PerkinElmer, Inc., and a starting point of an endothermic peak or an exothermic peak caused by a change of phase of the sample was determined by extrapolation (on set), and thus a phase transition temperature was determined.

Hereinafter, the crystals were expressed as K, and when the crystals were further distinguishable, each of the crystals was expressed as K₁ or K₂. Moreover, the smectic phase was expressed as Sm, a nematic phase as N and a chiral nematic phase as N*. Liquid (isotropic) was expressed as I. When smectic B phase or smectic A phase were distinguishable in the smectic phase, each of the phases was expressed as SmB or SmA, respectively. Then, BP represents a blue phase or an optically isotropic liquid crystal phase. A state of coexistence of two phases may be occasionally represented in the forms of (N*+I) or (N*+BP).

Specifically, (N*+I) represents a phase in which a non-liquid crystal isotropic phase and the chiral nematic phase coexist, and (N*+BP) represents a phase in which a BP phase or the optically isotropic liquid crystal phase and the chiral nematic phase coexist. Then, Un represents an unidentified phase that is not optically isotropic. As an expression of the phase transition temperature, for example, “K 50.0 N 100.0 I” means 50.0° C. in a phase transition temperature from the crystals to the nematic phase (KN), and 100.0° C. in a phase transition temperature from the nematic phase to the liquid (NI). An expression “BP-I” means that the phase transition temperature from the blue phase or optically isotropic liquid crystal phase to a liquid (isotropic) cannot be determined, and an expression “N 83.0-83.4 I” means that a phase transition temperature from a nematic phase to a liquid (isotropic) has a range from 83.0° C. to 83.4° C. A same rule applies also to any other expression.

### 1-5) Maximum Temperature of Nematic Phase (T_{NI}; ° C.)

A sample (a mixture of the liquid crystal compound and the base liquid crystal) was placed on a hot plate of a melting point apparatus (FP52 Hot Stage made by Mettler Toledo International Inc.) equipped with a polarizing microscope, and was observed by the polarizing microscope while the sample was heated at a rate of 1° C./min. Temperature when part of the sample changed from a nematic phase to the isotropic liquid was taken as a maximum temperature of the nematic phase. Hereinafter, the maximum temperature of the nematic phase may be occasionally abbreviated simply as “maximum temperature.”

### 1-6) Compatibility at Low Temperature

Samples in which the base liquid crystal and the liquid crystal compound were mixed for the liquid crystal compound to be 20% by weight, 15% by weight, 10% by weight, 5% by weight, 3% by weight and 1% by weight were prepared, and placed in glass vials. After the glass vials were kept in freezers at −10° C. or −20° C. for a predetermined period of time, whether or not the crystals or the smectic phase precipitated was observed.

1-7) Viscosity (Bulk Viscosity; η; Measured at 20° C.; mPa·s)

The mixture of the liquid crystal compound and the base liquid crystal was measured by using a cone-plate (E type) viscometer.

### 1-8) Refractive Index Anisotropy (Δn)

Measurement was carried out by an Abbe refractometer with a polarizing plate mounted on an ocular by using light at a wavelength of 589 nm at a temperature of 25° C. A surface of a main prism was rubbed in one direction, and then a sample (a mixture of the liquid crystal compound and the base liquid crystal) was added dropwise onto the main prism. A refractive index (n∥) was measured when a direction of polarized light was parallel to a direction of rubbing. A refractive index (n⊥) was measured when the direction of polarized light was perpendicular to the direction of rubbing. A value of refractive index anisotropy (Δn) was calculated from an equation: Δn=n∥−n⊥.

### 1-9) Dielectric Anisotropy (Δε; Measured at 25° C.)

A sample (a mixture of the liquid crystal compound and the base liquid crystal) was put in a liquid crystal cell in which a distance (gap) between two glass substrates was about 9 micrometers and a twist angle was 80 degrees. A voltage of 20 V was applied to the cell, and a dielectric constant (ε∥) in the major axis direction of liquid crystal molecules was measured.

A voltage of 0.5 V was applied to the cell, and a dielectric constant (ε⊥) in the minor axis direction of the liquid crystal molecules was measured. A value of dielectric anisotropy was calculated from an equation:

Δε=ε∥−ε⊥.

### 1-10) Pitch (P; Measured at 25° C.; nm)

Pitch length was measured using selective reflection (Handbook of Liquid Crystals (Ekisho Binran in Japanese), page 196, issued in 2000, Maruzen Co., Ltd.). A relational formula: <n> p/λ=1 holds for selective reflection wavelength λ. Here, <n> represents an average refractive index and is given by the following formula: <n>={(n∥²+n⊥²)/2}^{1/2}. A selective reflection wavelength was measured by a microspectrophotometer (JEOL Ltd., trade name MSV-350). A pitch was determined by dividing obtained reflection wavelength by the average refractive index. Because the pitch of a cholesteric liquid crystal having a reflection wavelength in a region of wavelength longer than the wavelength of visible light is proportional to a reciprocal of a concentration of an optically active compound in a region in which the concentration of the optically active compound is low, the pitch was determined by measuring several pitch lengths of a liquid crystal having a selective reflection wavelength in a visible light region, and applying a linear extrapolation method. “Optically active compound” corresponds to a chiral agent of the invention.

In the invention, values of characteristic of the liquid crystal composition can be measured according to the method described below. Most of the methods are applied as described in EIAJ ED-2521A of the Standard of Electronic Industries Association of Japan, or as modified thereon. No TFT was attached to a TN device used for measurement.

### 1-11) Maximum Temperature of Nematic Phase (NI; ° C.):

A sample was placed on a hot plate in a melting point apparatus equipped with a polarizing microscope, and heated at a rate of 1° C./min. Temperature when part of the sample began to change from a nematic phase to isotropic liquid was measured. A maximum temperature of the nematic phase may be occasionally abbreviated as “maximum temperature.”

### 1-12) Minimum Temperature of Nematic Phase (T_{C}; ° C.)

Samples each having a nematic phase were kept in freezers at temperatures of 0° C., −10° C., −20° C., −30° C. and −40° C. for 10 days, and then liquid crystal phases were observed. For example, when the sample was maintained in the nematic phase at −20° C. and changed to crystals or a smectic phase at −30° C., T_{C} was expressed as T_{C}≤−20° C. A minimum temperature of the nematic phase may be occasionally abbreviated as “minimum temperature.”

### 1-13) Transition Temperature of Optically Isotropic Liquid Crystal Phase

A sample was put on a hot plate in a melting point apparatus equipped with a polarizing microscope, and in a crossed nicol state, the sample was first heated to a temperature at which the sample was changed to a non-liquid crystal isotropic phase, and then cooled at a rate of 1° C./min to allow a chiral nematic phase or an optically isotropic liquid crystal phase to completely appear. Temperature at which phase transition was caused in a temperature-decreasing process was measured, subsequently the temperature was increased at a rate of 1° C./min, and temperature at which the phase transition was caused in a temperature-increasing process was measured. In the invention, unless otherwise noted, the temperature at which the phase transition was caused in the temperature-increasing process was taken as a phase transition temperature. When discrimination of the phase transition temperature was difficult in a dark field under crossed nicols in the optically isotropic liquid crystal phase, the phase transition temperature was measured by shifting the polarizing plate by 1 to 10 degrees from the crossed nicol state.

1-14) Viscosity (Rotational Viscosity; γ1; Measured at 25° C.; mPa·s)

(1) Sample having positive dielectric anisotropy: Measurement was carried out according to a method described in M. Imai et al., Molecular Crystals and Liquid Crystals, Vol. 259, p. 37 (1995). A sample was put in a TN device in which a twist angle was 0 degrees and a distance (cell gap) between two glass substrates was 5 micrometers. Voltage was applied stepwise to the TN device in the range of 16 V to 19.5 V at an increment of 0.5 V. After a period of 0.2 second with no voltage application, voltage was repeatedly applied under conditions of only one rectangular wave (rectangular pulse; 0.2 second) and no voltage application (2 seconds). A peak current and a peak time of a transient current generated by the applied voltage were measured. A value of rotational viscosity was obtained from the measured values and a calculation equation (8) described on page 40 of the paper presented by M. Imai et al. A value of dielectric anisotropy required for the calculation was determined by the method of measuring the dielectric anisotropy as described below in the device used in measurement of the rotational viscosity.

(2) Sample having negative dielectric anisotropy: Measurement was carried out according to a method described in M. Imai et al., Molecular Crystals and Liquid Crystals, Vol. 259, p. 37 (1995). A sample was put in a VA device in which a distance (cell gap) between two glass substrates was 20 micrometers. Voltage was applied stepwise to the device in the range of 30 V to 50 V at an increment of 1 V. After a period of 0.2 second with no voltage application, voltage was repeatedly applied under conditions of only one rectangular wave (rectangular pulse; 0.2 second) and no voltage application (2 seconds). A peak current and a peak time of a transient current generated by the applied voltage were measured. A value of rotational viscosity was obtained from the measured values and a calculation equation (8) described on page 40 of the paper presented by M. Imai et al. As a value of dielectric anisotropy required for the calculation, a value measured by measuring method of the dielectric anisotropy described below was used.

### 1-15) Refractive Index Anisotropy (Δn; Measured at 25° C.)

Measurement was carried out by an Abbe refractometer with a polarizing plate mounted on an ocular, using light at a wavelength of 589 nanometers. A surface of a main prism was subjected to rubbing in one direction, and then a sample was added dropwise onto the main prism. A refractive index (n∥) was measured when a direction of polarized light was parallel to a direction of rubbing. A refractive index (n⊥) was measured when the direction of polarized light was perpendicular to the direction of rubbing. A value of refractive index anisotropy was calculated from an equation: Δn=n∥−n⊥. When a sample was a composition, the refractive index anisotropy was measured by the method described above.

### 1-16) Dielectric Anisotropy (Δε; Measured at 25° C.)

(1) Composition having positive dielectric anisotropy: A sample was put in a liquid crystal cell in which a distance (gap) between two glass substrates was 9 micrometers and a twist angle was 80 degrees. A voltage of 20 V was applied to the cell, and a dielectric constant (ε∥) in the major axis direction of liquid crystal molecules was measured. A voltage of 0.5 V was applied to the cell, and a dielectric constant (ε⊥) in the minor axis direction of the liquid crystal molecules was measured. A value of dielectric anisotropy was calculated from an equation:

Δε=ε∥−ε⊥.

(2) Composition having negative dielectric anisotropy: A sample was put in a liquid crystal cell processed into homeotropic alignment, and a dielectric constant (ε∥) was measured by applying a voltage of 0.5 V. A sample was put in a liquid crystal cell processed into homogeneous alignment, and a dielectric constant (ε⊥) was measured by applying a voltage of 0.5 V. A value of dielectric anisotropy was calculated from an equation:

Δε=ε∥−ε⊥.

### 1-17) Threshold Voltage (Vth; Measured at 25° C.; V)

1) Composition having positive dielectric anisotropy: A sample was put in a normally white mode liquid crystal display device in which a distance (gap) between two glass substrates was (0.5/Δn) μm and a twist angle was 80 degrees. Here, Δn represents a value of refractive index anisotropy measured by the method described above. Rectangular waves having a frequency of 32 Hz were applied to the device. A voltage of the rectangular wave was increased and a value of voltage when the transmittance of the light transmitted through the device became 90% was measured.

2) Composition having negative dielectric anisotropy: A sample was put in a normally black mode liquid crystal display device in which a distance (gap) between two glass substrates was about 9 micrometers, and which was processed into homeotropic alignment. Rectangular waves having a frequency of 32 Hz were applied to the device. A voltage of the rectangular wave was increased and a value of voltage when the transmittance of the light transmitted through the device became 10% was measured.

### 1-18) Voltage Holding Ratio (VHR; Measured at 25° C.; %)

A TN device used for measurement had a polyimide alignment film, and a distance (cell gap) between two glass substrates was 6 micrometers. A sample was put in the device, and then the device was sealed with an ultraviolet-polymerizable adhesive. A pulse voltage (60 microseconds at 5 V) was applied to the TN device and the device was charged. A decaying voltage was measured for 16.7 milliseconds with a high-speed voltmeter, and area A between a voltage curve and a horizontal axis in a unit cycle was determined. Area B is an area without decay. A voltage holding ratio is expressed in terms of a percentage of area A to area B.

### 1-19) Helical Pitch (Measured at 20° C.; μm)

A Cano wedge cell method was applied to measurement of a helical pitch. A sample was injected into a Cano wedge cell, and a distance (a; unit μm) between disclination lines observed from a cell was measured. Helical pitch (P) was calculated from a formula: P=2·a·tan θ. Here, θ is an angle between two glass plates in the wedge cell.

Alternatively, pitch length was measured using selective reflection (Handbook of Liquid Crystals (Ekisho Binran in Japanese), page 196, issued in 2000, Maruzen Co., Ltd.). A relational formula: <n> p/λ=1 holds for selective reflection wavelength λ. Here, <n> represents an average refractive index and is given by the following formula: <n>={(n∥²+n⊥²)/2}^{1/2}. A selective reflection wavelength was measured by a microspectrophotometer (JEOL Ltd., trade name MSV-350). A pitch was determined by dividing obtained reflection wavelength by the average refractive index.

Because the pitch of the cholesteric liquid crystal having the reflection wavelength in the region of the wavelength longer than the wavelength of visible light is proportional to the reciprocal of the concentration of the chiral agent in the region in which the concentration of the chiral agent is low, the pitch was obtained by measuring several pitch lengths of the liquid crystal having the selective reflection wavelength in the visible light region, and applying the linear extrapolation method.

### 1-20) Saturation Voltage (Measured at 25° C.; V)

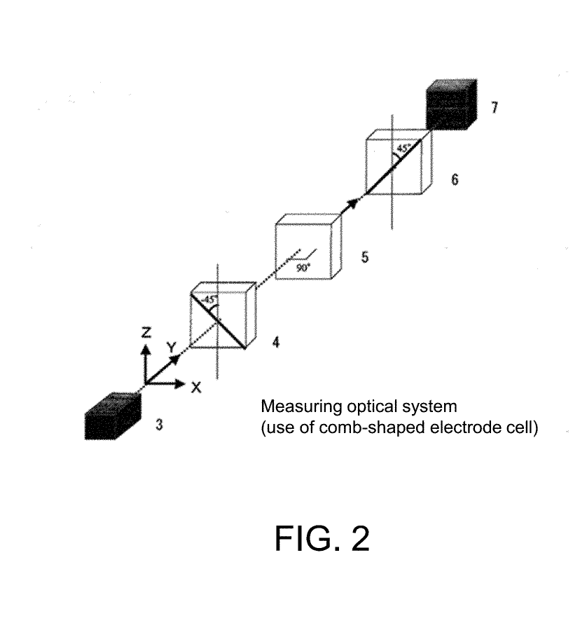

A cell in which the polymer-liquid crystal composite material was interposed therebetween was set in an optical system shown in FIG. 2. Specifically, a white light source for a polarizing microscope (ECLIPSE LV100POL, made by NIKON Corporation) was used as a light source to adjust an angle incident to the cell to be perpendicular to a cell plane, and the cell was set for polarizing plates of Polarizer and Analyzer to be in a crossed nicol state. The cell was set to be 45 degrees in a line direction of the comb-shaped electrode of the cell in which the polymer-liquid crystal composite material was interposed therebetween as shown in FIG. 1 relative to each polarizing plate, and intensity of light transmitted through the polarizing plates and the cell was measured by using an optical power meter (3298F made by YOKOGAWA Corporation). Voltage at a rectangular wave was applied to a cell in which the polymer-liquid crystal composite material was interposed therebetween, and applied voltage at maximum transmitted light intensity was taken as saturation voltage.

### 1-21) Contrast Ratio (Measured at Room Temperature)

A cell in which the polymer-liquid crystal composite material was interposed therebetween was set to an optical system shown in FIG. 2. Specifically, a white light source for a polarizing microscope (ECLIPSE LV100POL, made by NIKON Corporation) was used as a light source to adjust an angle incident to the cell to be perpendicular to a cell plane, and the cell was set for polarizing plates of Polarizer and Analyzer to be in a crossed nicol state. The cell was set to be 45 degrees in a line direction of the comb-shaped electrode of the cell in which the polymer-liquid crystal composite material was interposed therebetween as shown in FIG. 1 relative to each polarizing plate, and intensity of light transmitted through the polarizing plates and the cell was measured by using an optical power meter (3298F made by YOKOGAWA Corporation). Voltage at a rectangular wave was applied to the cells in which the polymer-liquid crystal composite materials were interposed therebetween, and a value obtained by dividing a value at maximum transmitted light intensity by a value at transmitted light intensity when the voltage was removed was taken as a contrast ratio.

### 1-22) Response Time (Measured at 25° C.; ms)

A cell in which the polymer-liquid crystal composite material was interposed therebetween was set in an optical system shown in FIG. 2. Specifically, a white light source for a polarizing microscope (ECLIPSE LV100POL, made by NIKON Corporation) was used as a light source to adjust an angle incident to the cell to be perpendicular to a cell plane, and the cell was set for polarizing plates of Polarizer and Analyzer to be in a crossed nicol state. The cell was set to be 45 degrees in a line direction of the comb-shaped electrode of the cell in which the polymer-liquid crystal composite material was interposed therebetween as shown in FIG. 1 relative to each polarizing plate, and intensity of light transmitted through the polarizing plates and the cell was measured by using an optical power meter (H5784 made by HAMAMATSU Corporation). Voltage at a pulse wave was applied to a cell in which the polymer-liquid crystal composite material was interposed therebetween and then a during which transmitted light intensity changed from 10% to 90% of a maximum value thereof was taken as “a response time during voltage application,” and the voltage was removed and then a time during which the transmitted light intensity changed from 90% to 10% of the maximum value thereof was taken as “a response time during voltage removal.”

A proportion (percentage) of the component or the liquid crystal compound is expressed in terms of weight percent (% by weight) based on the total weight of the liquid crystal compound. The composition is prepared by measuring the weight of the components such as liquid crystal compounds and then mixing the components. Accordingly, the weight percent of the component is easily calculated.

### Example 1 Preparation of Nematic Liquid Crystal Composition (NLC)

Nematic liquid crystal compositions NLC-1 to NLC-7 were prepared by mixing the compounds shown in Table 1. A numerical value in Table 1 is expressed in terms of a composition proportion (% by weight).

TABLE 1

| Single LC compounds | Formula | NLC-1 | NLC-2 | NLC-3 | NLC-4 | NLC-5 | NLC-6 | NLC-7 |
|---|---|---|---|---|---|---|---|---|
| 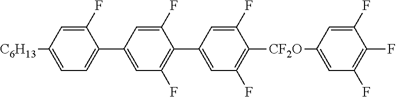 | 1′-1-1 | | | | 2.20 | 2.2 | 2.2 | |
| 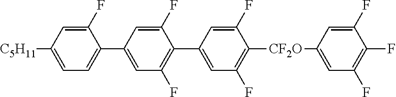 | 1′-1-1 | 2.07 | 2.07 | 2.07 | 2.20 | 2.20 | 2.20 | 2.07 |
| 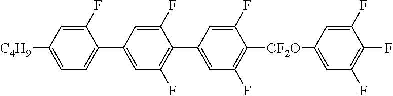 | 1′-1-1 | 2.07 | 2.07 | 2.07 | 2.20 | 2.20 | 2.20 | 2.07 |
| 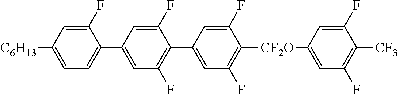 | 1′-1-2 | 3.38 | 3.38 | 3.38 | 3.80 | 3.80 | 3.80 | 3.38 |
| 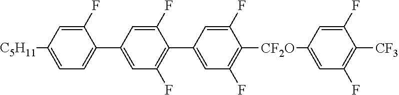 | 1′-1-2 | 3.38 | 3.38 | 3.38 | 3.80 | 3.80 | 3.80 | 3.38 |
| 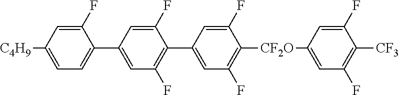 | 1′-1-2 | 3.38 | 3.38 | 3.38 | 3.80 | 3.80 | 3.80 | 3.38 |
| 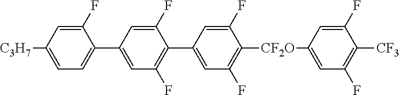 | 1′-1-2 | 3.38 | 3.38 | 3.38 | 3.80 | 3.80 | 3.80 | 3.38 |
| 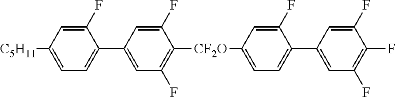 | 1′-2-1 | 2.70 | 2.70 | 2.70 | | | | 2.70 |
| 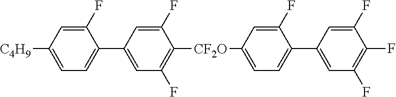 | 1′-2-1 | 2.70 | 2.70 | 2.70 | | | | 2.70 |
| 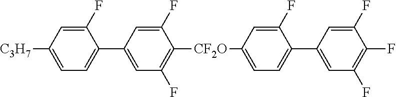 | 1′-2-1 | 2.70 | 2.70 | 2.70 | 10.00 | 10.00 | | 2.70 |
| 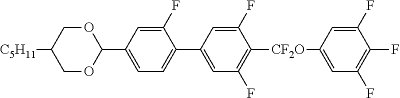 | 2′-1-1 | 8.10 | 8.10 | 8.10 | 11.00 | 10.00 | 11.00 | 8.10 |
| 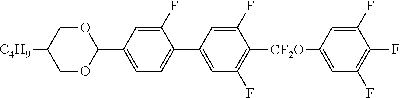 | 2′-1-1 | 8.10 | 8.10 | 8.10 | 11.00 | 10.00 | 11.00 | 8.10 |
| 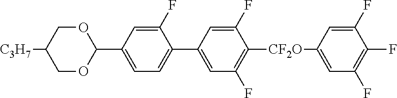 | 2′-1-1 | 7.56 | 7.56 | 7.56 | 11.00 | 10.00 | 11.00 | 7.56 |
| 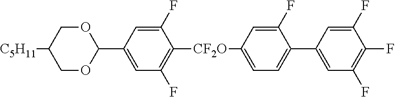 | 2′-2-1 | 13.49 | 13.49 | 13.49 | 10.00 | 15.00 | 15.00 | 13.49 |
| 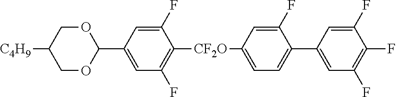 | 2′-2-1 | 13.49 | 13.49 | 13.49 | | | | 13.49 |
| 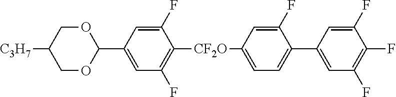 | 2′-2-1 | 13.50 | 13.50 | 13.50 | 10.00 | | | 13.50 |
| 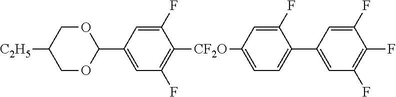 | 2′-2-1 | | | | 5.00 | 5.00 | 5.00 | |
| 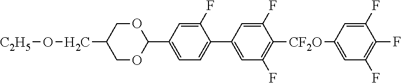 | 3-1-1 | | | | | 8.20 | | 10.00 |
| 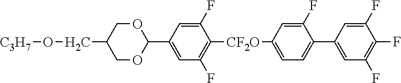 | 3-1-1 | 10.00 | | | | | | |
| 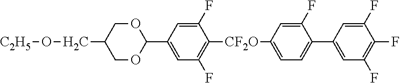 | 3-2-1 | | 10.00 | | 10.20 | 10.00 | 15.20 | |
| 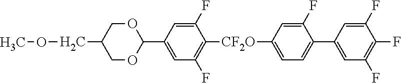 | 3-2-1 | | | 10.00 | | | | |
| 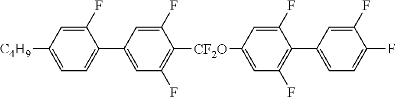 | 4-2-4 | | | | | | 5.00 | |
| 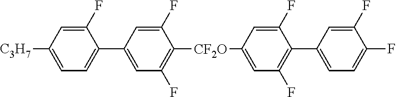 | 4-2-4 | | | | | | 5.00 | |
| Total | | 100.00 | 100.00 | 100.00 | 100.00 | 100.00 | 100.00 | 100.00 |

A phase transition temperature of nematic liquid crystal compositions NLC-1 to NLC-7 is as shown in Table 2.

TABLE 2

| | Phase transition temperature/° C. |
|---|---|
| NLC-1 | N 83.0-83.4 I |
| NLC-2 | N 83.8-84.1 I |
| NLC-3 | N 86.2-86.3 I |
| NLC-4 | N 87.0-87.2 I |
| NLC-5 | N 87.0-87.2 I |
| NLC-6 | N 86.2-86.4 I |
| NLC-7 | N 87.7-88.1 I |

### Example 2 Preparation of Chiral Liquid Crystal Composition (CLC)

Next, chiral liquid crystal compositions CLC-1 to CLC-7 were prepared by mixing each nematic liquid crystal composition NLC-1 to NLC-7 shown in Table 1 with chiral agent (CD1) described below. A composition of the chiral liquid crystal compositions is as shown in Table 3, and a phase transition temperature is as shown in Table 4.

TABLE 3

| | | | |
|---|---|---|---|
| CLC-1 | NLC-1 | 95.2% | by weight |
| | CD1 | 4.8% | by weight |
| CLC-2 | NLC-2 | 95.2% | by weight |
| | CD1 | 4.8% | by weight |
| CLC-3 | NLC-3 | 95.2% | by weight |
| | CD1 | 4.8% | by weight |
| CLC-4 | NLC-4 | 95.2% | by weight |
| | CD1 | 4.8% | by weight |
| CLC-5 | NLC-5 | 95.2% | by weight |
| | CD1 | 4.8% | by weight |
| CLC-6 | NLC-6 | 95.2% | by weight |
| | CD1 | 4.8% | by weight |
| CLC-7 | NLC-7 | 95.2% | by weight |
| | CD1 | 4.8% | by weight |

TABLE 4

| | Phase transition temperature/° C. | |
|---|---|---|
| CLC-1 | N* 75.0 N* + | BP 75.2 BP 77.0 I |
| CLC-2 | N* 76.1 N* + | BP 76.3 BP 77.8 I |
| CLC-3 | N* 78.0 N* + | BP 78.2 BP 79.2 I |
| CLC-4 | N* 78.7 N* + | BP 78.9 BP 81.3 I |
| CLC-5 | N* 78.9 N* + | BP 79.1 BP 81.4 I |
| CLC-6 | N* 77.9 N* + | BP 78.1 BP 79.9 I |
| CLC-7 | N* 79.1 N* + | BP 79.3 BP 80.9 I |

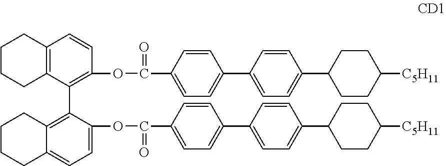

### Example 3 Preparation of Liquid Crystal Composition (MLC) being a Mixture with a Polymerizable Monomer

Liquid crystal compositions MLC-1 to MLC-7 were prepared by heating and mixing a mixture of each chiral liquid crystal composition (CLC) prepared in Example 2 and a polymerizable monomer in an isotropic phase. A composition of the liquid crystal compositions is as shown in Table 5, and a phase transition temperature is as shown in Table 6.

TABLE 5

| | | | |
|---|---|---|---|
| MLC-1 | CLC-1 | 88.4% | by weight |
| | n-hexadecyl acrylate | 6.2% | by weight |
| | LCA-12 | 5.0% | by weight |
| | DMPA | 0.4% | by weight |
| MLC-2 | CLC-2 | 88.4% | by weight |
| | n-hexadecyl acrylate | 6.2% | by weight |
| | LCA-12 | 5.0% | by weight |
| | DMPA | 0.4% | by weight |
| MLC-3 | CLC-3 | 88.4% | by weight |
| | n-hexadecyl acrylate | 6.2% | by weight |
| | LCA-12 | 5.0% | by weight |
| | DMPA | 0.4% | by weight |
| MLC-4 | CLC-4 | 87.2% | by weight |
| | n-hexadecyl acrylate | 6.9% | by weight |
| | LCA-12 | 5.5% | by weight |
| | DMPA | 0.4% | by weight |
| MLC-5 | CLC-5 | 87.0% | by weight |
| | n-hexadecyl acrylate | 7.0% | by weight |
| | LCA-12 | 5.6% | by weight |
| | DMPA | 0.4% | by weight |
| MLC-6 | CLC-6 | 87.4% | by weight |
| | n-hexadecyl acrylate | 6.8% | by weight |
| | LCA-12 | 5.4% | by weight |
| | DMPA | 0.4% | by weight |
| MLC-7 | CLC-7 | 88.4% | by weight |
| | n-hexadecyl acrylate | 6.2% | by weight |
| | LCA-12 | 5.0% | by weight |
| | DMPA | 0.4% | by weight |

TABLE 6

| | Phase transition temperature/° C. | |
|---|---|---|
| MLC-1 | N* 48.5 N* + | BP 48.9 BP 53.0 I |
| MLC-2 | N* 48.9 N* + | BP 49.3 BP 53.6 I |
| MLC-3 | N* 50.3 N* + | BP 50.8 BP 55.0 I |
| MLC-4 | N* 48.1 N* + | BP 48.7 BP 53.5 I |
| MLC-5 | N* 47.8 N* + | BP 48.4 BP 53.5 I |
| MLC-6 | N* 48.1 N* + | BP 48.5 BP - I |
| MLC-7 | N* 51.0 N* + | BP 51.5 BP 56.0 I |

In addition, in Table 5, LCA-12 is 1,4-di(4-(6-(acryloyloxy)dodecyloxy)benzoyloxy)-2-methylbenzene, and DMPA is 2,2′-dimethoxyphenylacetophenone, and is a photopolymerization initiator.

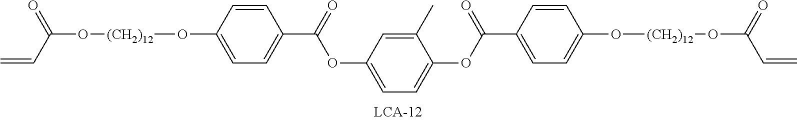

### Example 4 Cell in which a Polymer-Liquid Crystal Composite Material was Interposed

A liquid crystal composition (MLC) that was a mixture of a chiral liquid crystal composition (CLC) and a polymerizable monomer was interposed between a comb-like electrode substrate and a facing glass substrate (provided with no electrode) in which each substrate was subjected to no alignment treatment, and the resulting assembly was heated to a temperature at which a blue phase was developed. In the state in which the blue phase has developed, a polymerization reaction was carried out under the following UV exposure conditions 1 or UV exposure conditions 2, and a cell in which each of polymer-liquid crystal composite materials PSBP-1 to PSBP-7 was interposed therebetween was prepared (cell thickness: 7 to 9 μm).

UV exposure conditions 1: irradiation of ultraviolet light (ultraviolet light intensity: 23 mWcm⁻² (365 nm)) for 1 minute.

UV exposure conditions 2: irradiation of ultraviolet light (ultraviolet light intensity: 2 mWcm⁻² (365 nm)) for 7 minutes. A polymerization temperature is as shown in Table 7.

### Example 5 Optical System Using a Cell

A cell in which the polymer-liquid crystal composite material obtained in Example 4 was interposed therebetween was set in an optical system shown in FIG. 2. Specifically, a white light source for a polarizing microscope (ECLIPSE LV100POL, made by NIKON Corporation) was used as a light source to adjust an angle incident to the cell to be perpendicular to a cell plane, and a line direction of the comb-shaped electrode of the cell in which the polymer-liquid crystal composite material obtained in Example 4 was interposed therebetween became 45 degrees relative to each polarizing plate of Polarizer and Analyzer (FIG. 2).

A relationship between applied voltage and transmittance of the polymer-liquid crystal composite material obtained in Example 4 was examined at room temperature using the optical system. Values of physical properties of the polymer-liquid crystal composite material (PSBP) interposed by the cell are as shown in Table 7. In addition, data of the response time was during saturation voltage application or voltage removal.

TABLE 7

| | | | | | | Response | Response | |
|---|---|---|---|---|---|---|---|---|
| | | | | | | time | time | |
| | | UV | | | | during | during | |
| Measured | Used | exposure | Cell | Saturation | Contrast | voltage | voltage | Polymerization |
| PSBP | MLC | conditions | thickness/μm | voltage/V | ratio | application/ms | removal/ms | temperature/° C. |
| PSBP-1 | MLC-1 | 1 | 7.4 | 47.9 | 670.6 | 1.24 | 0.71 | 48.3 |
| PSBP-2 | MLC-2 | 1 | 8.6 | 48.1 | 945.2 | 1.38 | 0.62 | 49.1 |
| PSBP-3 | MLC-3 | 1 | 8.2 | 45.3 | 667.2 | 1.75 | 0.75 | 50.5 |
| PSBP-4 | MLC-4 | 1 | 7.5 | 34.0 | 610.7 | 1.32 | 0.69 | 49.1 |
| PSBP-5 | MLC-5 | 1 | 7.6 | 32.8 | 785.8 | 2.66 | 1.80 | 47.3 |
| PSBP-6 | MLC-6 | 1 | 7.8 | 37.9 | 823.1 | 1.49 | 0.64 | 47.7 |
| PSBP-7 | MLC-7 | 2 | 7.6 | 45.4 | 1062.6 | 0.71 | 0.56 | 51.3 |

### Example 6 Preparation of Nematic Liquid Crystal Composition (NLC)

Nematic liquid crystal compositions NLC-8 to NLC-14 were prepared by mixing the compound described in Table 8. A numerical value in the table is expressed in terms a composition proportion (% by weight).

TABLE 8

| Single LC compounds | Formula | NLC-8 | NLC-9 | NLC-10 | NLC-11 | NLC-12 | NLC-13 | NLC-14 |
|---|---|---|---|---|---|---|---|---|
| 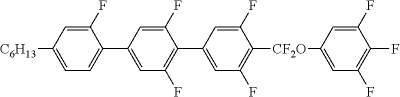 | 1′-1-1 | 2.20 | 2.20 | 2.20 | 2.20 | 2.20 | 2.20 | 2.20 |
| 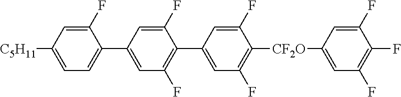 | 1′-1-1 | 2.20 | 2.20 | 2.20 | 2.20 | 2.20 | 2.20 | 2.20 |
| 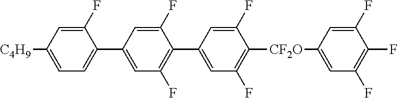 | 1′-1-1 | 2.20 | 2.20 | 2.20 | 2.20 | 2.20 | 2.20 | 2.20 |
| 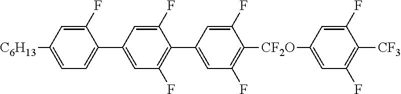 | 1′-1-2 | 3.80 | 3.80 | 3.80 | 3.80 | 3.80 | 3.80 | 3.80 |
| 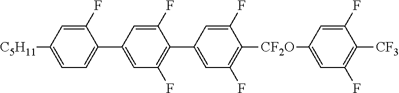 | 1′-1-2 | 3.80 | 3.80 | 3.80 | 3.80 | 3.80 | 3.80 | 3.80 |
| 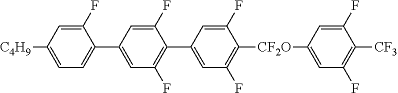 | 1′-1-2 | 3.80 | 3.80 | 3.80 | 3.80 | 3.80 | 3.80 | 3.80 |
| 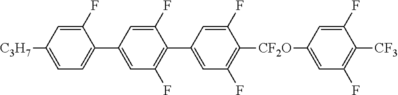 | 1′-1-2 | 3.80 | 3.80 | 3.80 | 3.80 | 3.80 | 3.80 | 3.80 |
| 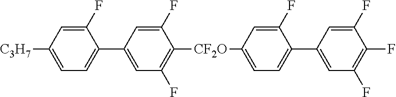 | 1′-2-1 | 5.00 | 10.00 | 9.00 | 10.00 | 10.00 | 10.00 | 10.00 |
| 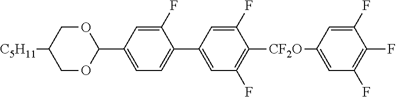 | 2′-1-1 | 13.00 | 11.00 | 11.00 | 11.00 | 11.00 | 7.00 | 11.00 |
| 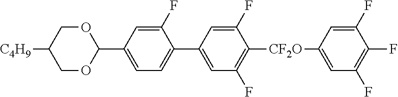 | 2′-1-1 | 13.00 | 11.00 | 11.00 | 11.00 | 11.00 | 7.00 | 11.00 |
| 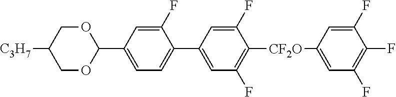 | 2′-1-1 | 13.00 | 11.00 | 11.00 | 11.00 | 11.00 | 7.00 | 11.00 |
| 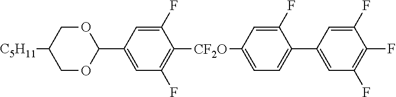 | 2′-2-1 | | 15.00 | | 15.00 | 15.00 | | 10.20 |
| 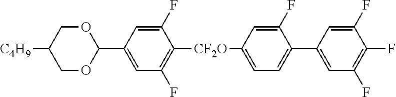 | 2′-2-1 | | | | | | 11.00 | |
| 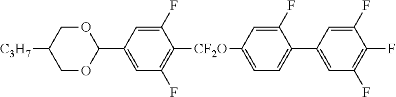 | 2′-2-1 | 9.20 | | 10.00 | | | 12.00 | 10.00 |
| 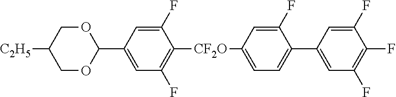 | 2′-2-1 | 10.00 | 5.00 | 10.00 | 5.20 | 5.20 | 5.20 | 10.00 |
| 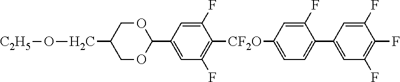 | 3-2-1 | 10.00 | 10.20 | 10.00 | 15.00 | 10.00 | 15.00 | 5.00 |
| 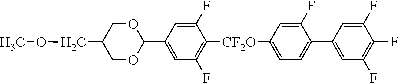 | 3-2-1 | 5.00 | | 5.00 | | 5.00 | | |
| 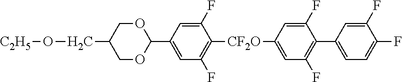 | 5-2-4 | | 5.00 | | | | | |
| 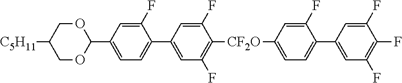 | 7-2-1 | | | 1.20 | | | 4.00 | |
| Total | | 100.00 | 100.00 | 100.00 | 100.00 | 100.00 | 100.00 | 100.00 |

A phase transition temperature of nematic liquid crystal compositions NLC-8 to NLC-14 is as shown in Table 9.

TABLE 9

| | Phase transition temperature/° C. |
|---|---|
| NLC-8 | N 86.6-86.9 I |
| NLC-9 | N 86.8-87.1 I |
| NLC-10 | N 86.8-87.3 I |
| NLC-11 | N 86.0-86.2 I |
| NLC-12 | N 86.8-87.0 I |
| NLC-13 | N 86.9-87.5 I |
| NLC-14 | N 87.6-87.8 I |

### Example 7 Preparation of Chiral Liquid Crystal Composition (CLC)

Chiral liquid crystal compositions CLC-8 to CLC-14 were prepared by mixing each of nematic liquid crystal compositions NLC-8 to NLC-14 shown in Table 8 with chiral agent CD1. A composition of the chiral liquid crystal composition is as shown in Table 10 below, and a phase transition temperature is as shown in Table 11.

TABLE 10

| | | | |
|---|---|---|---|
| CLC-8 | NLC-8 | 95.2% | by weight |
| | CD1 | 4.8% | by weight |
| CLC-9 | NLC-9 | 95.2% | by weight |
| | CD1 | 4.8% | by weight |
| CLC-10 | NLC-10 | 95.2% | by weight |
| | CD1 | 4.8% | by weight |
| CLC-11 | NLC-4 | 95.2% | by weight |
| | CD1 | 4.8% | by weight |
| CLC-12 | NLC-5 | 95.2% | by weight |
| | CD1 | 4.8% | by weight |
| CLC-13 | NLC-6 | 95.2% | by weight |
| | CD1 | 4.8% | by weight |
| CLC-14 | NLC-7 | 95.2% | by weight |
| | CD1 | 4.8% | by weight |

TABLE 11

| | Phase transition temperature/° C. | |
|---|---|---|
| CLC-8 | N* 78.4 N* + | BP 79.7 BP 80.3 I |
| CLC-9 | N* 78.2 N* + | BP 79.4 BP 80.2 I |
| CLC-10 | N* 78.9 N* + | BP 79.1 BP 81.1 I |
| CLC-11 | N* 77.5 N* + | BP 77.7 BP - I |
| CLC-12 | N* 79.0 N* + | BP 79.5 BP 81.4 I |
| CLC-13 | N* 77.7 N* + | BP 77.9 BP 80.0 I |
| CLC-14 | N* 79.2 N* + | BP 79.4 BP 81.0 I |

### Example 8 Preparation of Liquid Crystal Composition (MLC) being a Mixture with a Polymerizable Monomer

Liquid crystal compositions MLC-8 to MLC-14 were prepared by heating and mixing a mixture of each of chiral liquid crystal compositions (CLC) prepared in Example 7 and a polymerizable monomer in an isotropic phase. A composition of the liquid crystal compositions is as shown in Table 12 below, and a phase transition temperature is as shown in Table 13.

TABLE 12

| | | | |
|---|---|---|---|
| MLC-8 | CLC-8 | 88.8% | by weight |
| | n-hexadecyl acrylate | 5.4% | by weight |
| | LCA-2-12 | 5.4% | by weight |
| | DMPA | 0.4% | by weight |
| MLC-9 | CLC-9 | 88.8% | by weight |
| | n-hexadecyl acrylate | 5.4% | by weight |
| | LCA-2-12 | 5.4% | by weight |
| | DMPA | 0.4% | by weight |
| MLC-10 | CLC-10 | 88.8% | by weight |
| | n-hexadecyl acrylate | 5.4% | by weight |
| | LCA-2-12 | 5.4% | by weight |
| | DMPA | 0.4% | by weight |
| MLC-11 | CLC-11 | 88.8% | by weight |
| | n-hexadecyl acrylate | 5.4% | by weight |
| | LCA-2-12 | 5.4% | by weight |
| | DMPA | 0.4% | by weight |
| MLC-12 | CLC-12 | 88.8% | by weight |
| | n-hexadecyl acrylate | 5.4% | by weight |
| | LCA-2-12 | 5.4% | by weight |
| | DMPA | 0.4% | by weight |
| MLC-13 | CLC-13 | 88.8% | by weight |
| | n-hexadecyl acrylate | 5.4% | by weight |
| | LCA-2-12 | 5.4% | by weight |
| | DMPA | 0.4% | by weight |
| MLC-14 | CLC-14 | 88.8% | by weight |
| | n-hexadecyl acrylate | 5.4% | by weight |
| | LCA-2-12 | 5.4% | by weight |
| | DMPA | 0.4% | by weight |

TABLE 13

| | Phase transition temperature/° C. | |
|---|---|---|
| MLC-8 | N* 47.9 N* + | BP 48.3 BP 52.8 I |
| MLC-9 | N* 48.5 N* + | BP 48.8 BP - I |
| MLC-10 | N* 47.6 N* + | BP 48.0 BP 52.3 I |
| MLC-11 | N* 47.5 N* + | BP 47.8 BP 51.5 I |
| MLC-12 | N* 48.5 N* + | BP 48.8 BP 52.9 I |
| MLC-13 | N* 46.8 N* + | BP 47.2 BP - I |
| MLC-14 | N* 49.4 N* + | BP 49.8 BP 54.0 I |

In addition, in Table 12, LCA-2-12 is 1,3,4-tri(4-(6-(acryloyloxy)dodecyloxy)benzoyloxy)benzene, and DMPA is 2,2′-dimethoxyphenylacetophenone, and is a photopolymerization initiator.

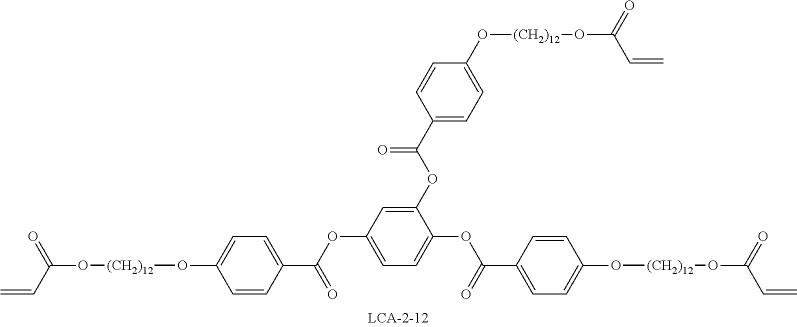

### Example 9 Cell in which a Polymer-Liquid Crystal Composite Material was Interposed

In a manner similar to the method in Example 4, a cell in which each of polymer-liquid crystal composite materials PSBP-8 to PSBP-14 was interposed therebetween was prepared (cell thickness: 7 to 9 μm). A polymerization temperature is as shown in Table 14.

### Example 10 Optical System Using a Cell

In a manner similar to the method in Example 5, a relationship between applied voltage and transmittance of the polymer-liquid crystal composite material was examined at room temperature. Values of physical properties of the polymer-liquid crystal composite material (PSBP) interposed by the cell are as shown in Table 14. In addition, data of the response time was during saturation voltage application or voltage removal.

TABLE 14

| | | | | | | Response | Response | |
|---|---|---|---|---|---|---|---|---|
| | | | | | | time | time | |
| | | UV | | | | during | during | |
| Measured | Used | exposure | Cell | Saturation | Contrast | voltage | voltage | Polymerization |
| PSBP | MLC | conditions | thickness/μm | voltage/V | ratio | application/ms | removal/ms | temperature/° C. |
| PSBP-8 | MLC-8 | 1 | 7.2 | 27.7 | 769.0 | 4.47 | 2.33 | 47.6 |
| PSBP-9 | MLC-9 | 1 | 7.8 | 35.3 | 1166.3 | 1.85 | 0.96 | 47.7 |
| PSBP-10 | MLC-10 | 1 | 7.6 | 30.3 | 774.4 | 5.84 | 2.61 | 47.3 |
| PSBP-11 | MLC-11 | 2 | 7.6 | 35.3 | 1187.4 | 1.03 | 0.87 | 48.2 |
| PSBP-12 | MLC-12 | 2 | 7.6 | 35.2 | 1181.6 | 1.00 | 0.99 | 48.7 |
| PSBP-13 | MLC-13 | 2 | 7.3 | 35.3 | 1269.0 | 2.63 | 1.25 | 47.1 |
| PSBP-14 | MLC-14 | 2 | 7.8 | 43.0 | 1049.5 | 0.78 | 0.59 | 49.2 |

### Example 11 Preparation of Nematic Liquid Crystal Composition (NLC)

Nematic liquid crystal compositions NLC-15 to NLC-21 were prepared by mixing the compound shown in Table 15. A numerical value in the table is expressed in terms of a composition proportion (% by weight).

TABLE 15

| Single LC compounds | Formula | NLC-15 | NLC-16 | NLC-17 | NLC-18 | NLC-19 | NLC-20 | NLC-21 |
|---|---|---|---|---|---|---|---|---|
| 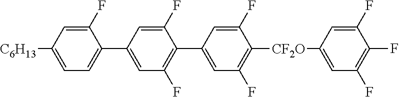 | 1′-1-1 | 2.20 | 2.20 | 2.20 | 2.20 | 2.20 | 2.20 | 2.20 |
| 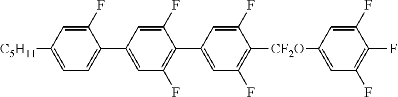 | 1′-1-1 | 2.20 | 2.20 | 2.20 | 2.20 | 2.20 | 2.20 | 2.20 |
| 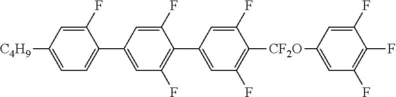 | 1′-1-1 | 2.20 | 2.20 | 2.20 | 2.20 | 2.20 | 2.20 | 2.20 |
| 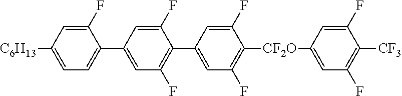 | 1′-1-2 | 3.80 | 3.80 | 3.80 | 3.80 | 3.80 | 3.80 | 3.80 |
| 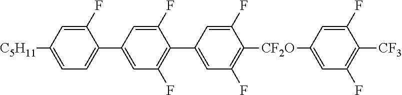 | 1′-1-2 | 3.80 | 3.80 | 3.80 | 3.80 | 3.80 | 3.80 | 3.80 |
| 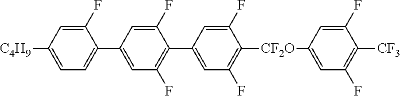 | 1′-1-2 | 3.80 | 3.80 | 3.80 | 3.80 | 3.80 | 3.80 | 3.80 |
| 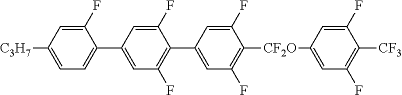 | 1′-1-2 | 3.80 | 3.80 | 3.80 | 3.80 | 3.80 | 3.80 | 3.80 |
| 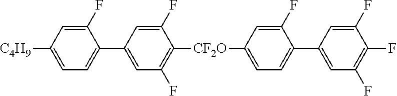 | 1′-2-1 | | 10.00 | 10.00 | | 10.00 | 10.00 | 10.00 |
| 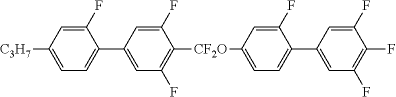 | 1′-2-1 | 10.00 | 10.00 | 10.00 | 10.00 | 10.00 | 10.00 | 10.00 |
| 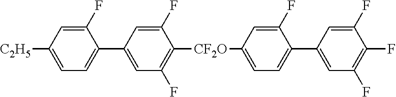 | 1′-2-1 | | | | | 10.00 | 10.00 | 7.20 |
| 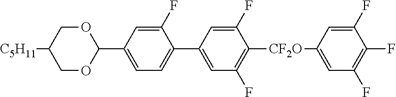 | 2′-1-1 | 8.00 | 11.00 | 11.00 | 11.00 | 10.00 | 10.00 | 10.00 |
| 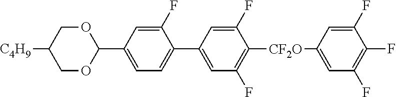 | 2′-1-1 | 8.00 | | | 11.00 | | 10.00 | |
| 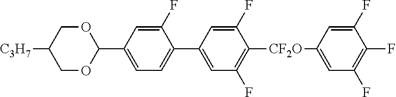 | 2′-1-1 | 8.00 | 11.00 | 11.00 | 11.00 | 10.00 | 10.00 | 10.00 |
| 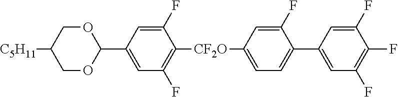 | 2′-2-1 | 4.20 | 7.20 | 7.20 | 15.00 | | | |
| 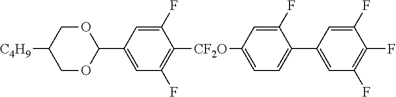 | 2′-2-1 | 11.00 | | | | | | |
| 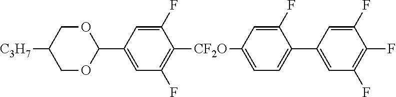 | 2′-2-1 | 11.00 | 7.00 | 7.00 | | 7.00 | | 8.00 |
| 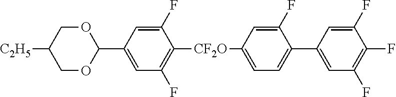 | 2′-2-1 | 11.00 | 7.00 | | 5.20 | 7.00 | 4.00 | 8.00 |
| 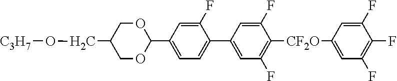 | 3-1-1 | | | | | | | 5.00 |
| 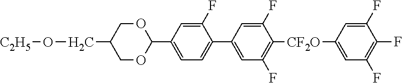 | 3-1-1 | | 10.00 | 10.00 | 15.00 | 14.20 | 14.20 | 10.00 |
| 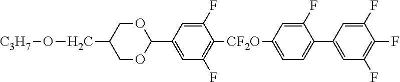 | 3-2-1 | | | 7.00 | | | | |
| 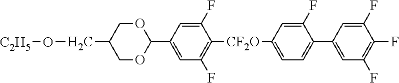 | 3-2-1 | 7.00 | 5.00 | 5.00 | | | | |
| Total | | 100.00 | 100.00 | 100.00 | 100.00 | 100.00 | 100.00 | 100.00 |

A phase transition temperature of nematic liquid crystal compositions NLC-15 to NLC-21 is as shown in Table 15.

TABLE 16

| | Phase transition temperature/° C. |
|---|---|
| NLC-15 | N 82.7-82.9 I |
| NLC-16 | N 85.3-85.5 I |
| NLC-17 | N 86.5-86.7 I |
| NLC-18 | N 91.2-91.4 I |
| NLC-19 | N 87.0-87.2 I |
| NLC-20 | N 90.5-90.7 I |
| NLC-21 | N 85.0-85.1 I |

### Example 12 Preparation of Chiral Liquid Crystal Composition (CLC)

Chiral liquid crystal compositions CLC-15 to CLC-21 were prepared by mixing each of nematic liquid crystal compositions NLC-15 to NLC-21 shown in Table 15 with chiral agent CD1. A composition of the chiral liquid crystal is as shown in Table 17, and a phase transition temperature is as shown in Table 18.

TABLE 17

| | | | |
|---|---|---|---|
| CLC-15 | NLC-15 | 95.2% | by weight |
| | CD1 | 4.8% | by weight |
| CLC-16 | NLC-16 | 95.2% | by weight |
| | CD1 | 4.8% | by weight |
| CLC-17 | NLC-17 | 95.2% | by weight |
| | CD1 | 4.8% | by weight |
| CLC-18 | NLC-18 | 95.2% | by weight |
| | CD1 | 4.8% | by weight |
| CLC-19 | NLC-19 | 95.2% | by weight |
| | CD1 | 4.8% | by weight |
| CLC-20 | NLC-20 | 95.2% | by weight |
| | CD1 | 4.8% | by weight |
| CLC-21 | NLC-21 | 95.2% | by weight |
| | CD1 | 4.8% | by weight |

TABLE 18

| | Phase transition temperature/° C. | |
|---|---|---|
| CLC-15 | N* 74.2 N* + | BP 74.3 BP 76.0 I |
| CLC-16 | N* 76.7 N* + | BP 76.9 BP 78.6 I |
| CLC-17 | N* 78.3 N* + | BP 79.6 BP 80.2 I |
| CLC-18 | N* 82.8 N* + | BP 83.0 BP 84.6 I |
| CLC-19 | N* 78.2 N* + | BP 79.4 BP 80.2 I |
| CLC-20 | N* 81.6 N* + | BP 81.8 BP 83.6 I |
| CLC-21 | N* 76.5 N* + | BP 76.7 BP 78.3 I |

### Example 13 Preparation of Liquid Crystal Composition (MLC) being a Mixture with a Polymerizable Monomer

Liquid crystal compositions MLC-15 to MLC-21 were prepared by heating and mixing each of chiral liquid crystal compositions (CLC) prepared in Example 12 and a polymerizable monomer in an isotropic phase. A composition of the liquid crystal compositions is as shown in Table 19 below, and a phase transition temperature is as shown in Table 20.

TABLE 19

| | | | |
|---|---|---|---|
| MLC-15 | CLC-15 | 88.8% | by weight |
| | n-hexadecyl acrylate | 5.4% | by weight |
| | LCA-2-12 | 5.4% | by weight |
| | DMPA | 0.4% | by weight |
| MLC-16 | CLC-16 | 88.8% | by weight |
| | n-hexadecyl acrylate | 5.4% | by weight |
| | LCA-2-12 | 5.4% | by weight |
| | DMPA | 0.4% | by weight |
| MLC-17 | CLC-17 | 88.8% | by weight |
| | n-hexadecyl acrylate | 5.4% | by weight |
| | LCA-2-12 | 5.4% | by weight |
| | DMPA | 0.4% | by weight |
| MLC-18 | CLC-18 | 88.8% | by weight |
| | n-hexadecyl acrylate | 6.0% | by weight |
| | LCA-2-12 | 4.8% | by weight |
| | DMPA | 0.4% | by weight |
| MLC-19 | CLC-19 | 88.8% | by weight |
| | n-hexadecyl acrylate | 5.4% | by weight |
| | LCA-2-12 | 5.4% | by weight |
| | DMPA | 0.4% | by weight |
| MLC-20 | CLC-20 | 88.8% | by weight |
| | n-hexadecyl acrylate | 5.4% | by weight |
| | LCA-2-12 | 5.4% | by weight |
| | DMPA | 0.4% | by weight |
| MLC-21 | CLC-21 | 88.8% | by weight |
| | n-hexadecyl acrylate | 5.4% | by weight |
| | LCA-2-12 | 5.4% | by weight |
| | DMPA | 0.4% | by weight |

TABLE 20

| | Phase transition temperature/° C. | |
|---|---|---|
| MLC-15 | N* 45.1 N* + | BP 45.4 BP - I |
| MLC-16 | N* 46.4 N* + | BP 46.7 BP - I |
| MLC-17 | N* 46.4 N* + | BP 46.8 BP - I |
| MLC-18 | N* 49.9 N* + | BP 50.3 BP 55.0 I |
| MLC-19 | N* 46.8 N* + | BP 49.8 BP 51.3 I |
| MLC-20 | N* 49.8 N* + | BP 50.2 BP 55.0 I |
| MLC-21 | N* 47.5 N* + | BP 50.1 BP 52.0 I |

### Example 14 Cell in which a Polymer-Liquid Crystal Composite Material was Interposed

In a manner similar to the method in Example 4, a cell in which each of polymer-liquid crystal composite materials PSBP-15 to PSBP-21 was interposed therebetween was prepared (cell thickness: 7 to 9 μm). A polymerization temperature is as shown in Table 21.

### Example 15 Optical System Using a Cell

In a manner similar to the method in Example 5, a relationship between applied voltage and transmittance of the polymer-liquid crystal composite material was examined at room temperature. Values of physical properties of the polymer-liquid crystal composite material (PSBP) interposed by the cell are as shown in Table 21. In addition, data of the response time was during saturation voltage application or voltage removal.

TABLE 21

| | | | | | | Response | Response | |
|---|---|---|---|---|---|---|---|---|
| | | | | | | time | time | |
| | | UV | | | | during | during | |
| Measured | Used | exposure | Cell | Saturation | Contrast | voltage | voltage | Polymerization |
| PSBP | MLC | conditions | thickness/μm | voltage/V | ratio | application/ms | removal/ms | temperature/° C. |
| PSBP-15 | MLC-15 | 2 | 7.4 | 41.6 | 1207.8 | 1.00 | 0.53 | 45.3 |
| PSBP-16 | MLC-16 | 2 | 7.4 | 32.7 | 1103.8 | 1.00 | 1.10 | 46.4 |
| PSBP-17 | MLC-17 | 2 | 7.2 | 27.8 | 916.3 | 1.70 | 2.75 | 46.9 |
| PSBP-18 | MLC-18 | 2 | 7.3 | 30.3 | 858.2 | 1.05 | 1.36 | 49.7 |
| PSBP-19 | MLC-19 | 2 | 7.2 | 26.5 | 865.6 | 1.43 | 1.62 | 46.7 |
| PSBP-20 | MLC-20 | 2 | 7.2 | 27.8 | 844.5 | 1.44 | 1.41 | 49.9 |
| PSBP-21 | MLC-21 | 2 | 7.1 | 32.8 | 1001.9 | 1.08 | 1.07 | 46.8 |

### Example 16 Preparation of Nematic Liquid Crystal Composition (NLC)

Nematic liquid crystal compositions NLC-22 and NLC-23 were prepared by mixing a compound shown in Table 22. A numerical value in the table is expressed in terms of a composition proportion (% by weight).

TABLE 22

| Single LC compounds | Formula | NLC-22 | NLC-23 |
|---|---|---|---|
| 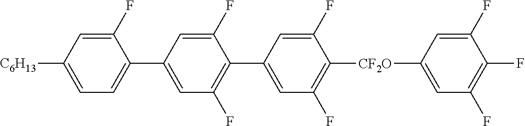 | 1′-1-1 | 2.20 | 2.20 |
| 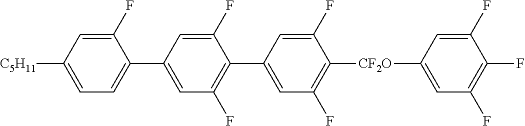 | 1′-1-1 | 2.20 | 2.20 |
| 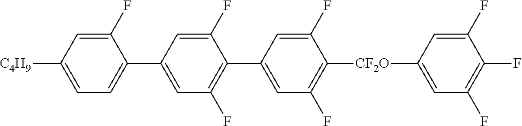 | 1′-1-1 | 2.20 | 2.20 |
| 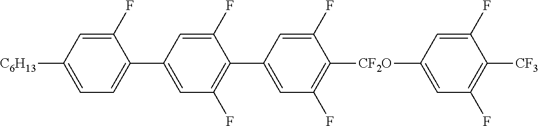 | 1′-1-2 | 3.80 | 3.80 |
| 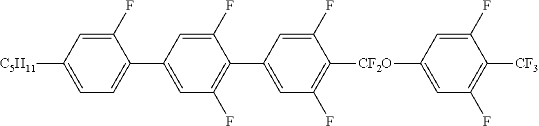 | 1′-1-2 | 3.80 | 3.80 |
| 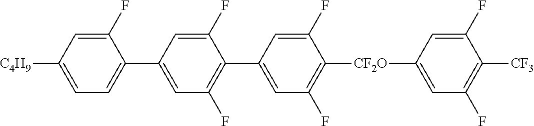 | 1′-1-2 | 3.80 | 3.80 |
| 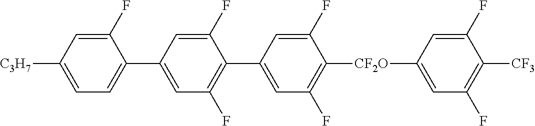 | 1′-1-2 | 3.80 | 3.80 |
| 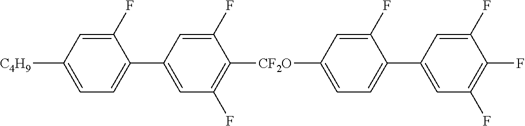 | 1′-2-1 | 10.00 | 10.00 |
| 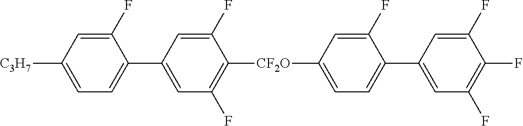 | 1′-2-1 | 10.00 | 10.00 |
| 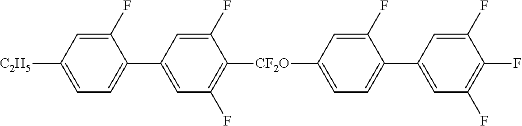 | 1′-2-1 | 7.20 | |
| 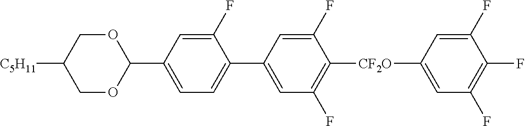 | 2′-1-1 | 10.00 | 10.00 |
| 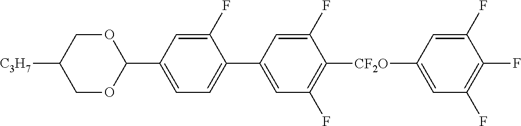 | 2′-1-1 | 10.00 | 10.00 |
| 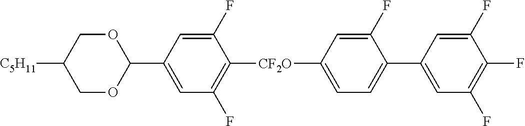 | 2′-2-1 | | 7.20 |
| 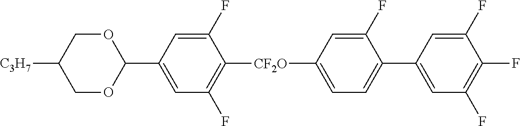 | 2′-2-1 | 8.00 | 8.00 |
| 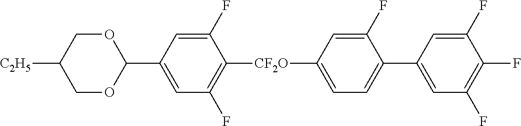 | 2′-2-1 | 8.00 | 8.00 |
| 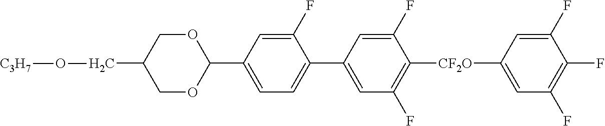 | 3-1-1 | | 5.00 |
| 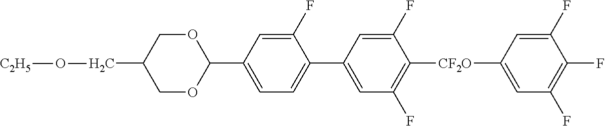 | 3-1-1 | 10.00 | 5.00 |
| 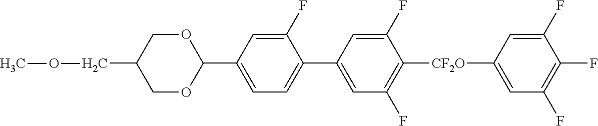 | 3-1-1 | 5.00 | 5.00 |
| Total | | 100.00 | 100.00 |

A phase transition temperature of nematic liquid crystal compositions NLC-22 and NLC-23 is as shown in Table 23.

TABLE 23

| | Phase transition temperature/° C. |
|---|---|
| NLC-22 | N 85.3-85.4 I |
| NLC-23 | N 86.6-86.9 I |

### Example 17 Preparation of Chiral Liquid Crystal Composition (CLC)

Chiral liquid crystal compositions CLC-22 and CLC-23 were prepared by mixing each of nematic liquid crystal compositions NLC-22 and NLC-23 described in Table 22 with chiral agent CD1. A composition of the chiral liquid crystal composition is as shown in Table 24, and a phase transition temperature is as shown in Table 25.

TABLE 24

| | | | |
|---|---|---|---|
| CLC-22 | NLC-22 | 95.2% | by weight |
| | CD1 | 4.8% | by weight |
| CLC-23 | NLC-23 | 95.2% | by weight |
| | CD1 | 4.8% | by weight |

TABLE 25

| | Phase transition temperature/° C. | |
|---|---|---|
| CLC-22 | N* 76.7 N* + | BP 76.9 BP 78.5 I |
| CLC-23 | N* 78.6 N* + | BP 78.8 BP - I |

### Example 18 Preparation of Liquid Crystal Composition (MLC) being a Mixture with a Polymerizable Monomer

Liquid crystal compositions MLC-22 and MLC-23 were prepared by heating and mixing a mixture of each chiral liquid crystal compositions (CLC) prepared in Example 17 and a polymerizable monomer in an isotropic phase. A composition of the liquid crystal compositions is as shown in Table 26 below, and a phase transition temperature is as shown in Table 27.

TABLE 26

| | | | |
|---|---|---|---|
| MLC-22 | CLC-22 | 88.8% | by weight |
| | n-hexadecyl acrylate | 5.4% | by weight |
| | LCA-2-12 | 5.4% | by weight |
| | DMPA | 0.4% | by weight |
| MLC-23 | CLC-23 | 88.8% | by weight |
| | n-hexadecyl acrylate | 5.4% | by weight |
| | LCA-2-12 | 5.4% | by weight |
| | DMPA | 0.4% | by weight |

TABLE 27

| | Phase transition temperature/° C. | |
|---|---|---|
| MLC-22 | N* 46.4 N* + | BP 46.8 BP 51.3 I |
| MLC-23 | N* 48.0 N* + | BP 48.3 BP 52.7 I |

### Example 19 Cell in which a Polymer-Liquid Crystal Composite Material was Interposed

In a similar manner to the method in Example 4, a cell in which each of polymer-liquid crystal composite materials PSBP-22 and PSBP-23 was interposed therebetween was prepared (cell thickness: 7 to 9 μm). A polymerization temperature is as shown in Table 28.

### Example 20 Optical System Using a Cell

In a manner similar to the method in Example 5, a relationship between applied voltage and transmittance of the polymer-liquid crystal composite material was examined at room temperature. Values of physical properties of the polymer-liquid crystal composite material (PSBP) interposed by the cell are as shown in Table 28. In addition, data of the response time was during saturation voltage application or voltage removal.

TABLE 28

| | | | | | | Response | Response | |
|---|---|---|---|---|---|---|---|---|
| | | | | | | time | time | |
| | | UV | | | | during | during | |
| Measured | Used | exposure | Cell | Saturation | Contrast | voltage | voltage | Polymerization |
| PSBP | MLC | conditions | thickness/μm | voltage/V | ratio | application/ms | removal/ms | temperature/° C. |
| PSBP-22 | MLC-22 | 2 | 7.1 | 27.8 | 942.5 | 1.21 | 1.49 | 46.2 |
| PSBP-23 | MLC-23 | 2 | 7.5 | 30.7 | 1066.8 | 1.06 | 1.11 | 47.2 |

### Comparative Example 1 Preparation of Nematic Liquid Crystal Composition (NLC)

As Comparative Example, nematic liquid crystal composition NLC-R in which compound (3-1-1) (10% by weight) was excluded from NLC-7 described above was prepared. A composition and a phase transition temperature are shown.

| | | |
|---|---|---|
| 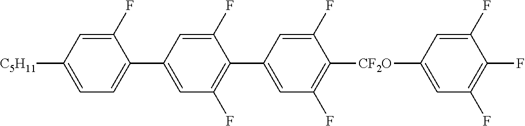 | (1′-1-1) | 2.30% by weight |
| 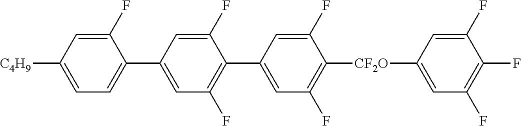 | (1′-1-1) | 2.30% by weight |
| 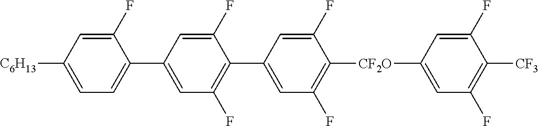 | (1′-1-2) | 3.75% by weight |
| 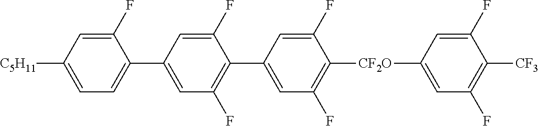 | (1′-1-2) | 3.75% by weight |
| 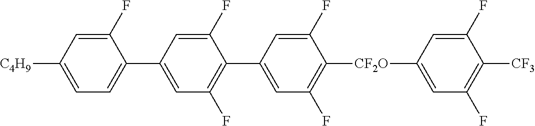 | (1′-1-2) | 3.75% by weight |
| 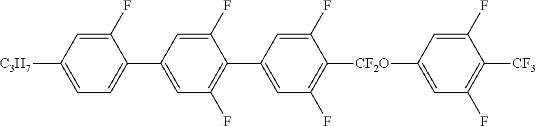 | (1′-1-2) | 3.75% by weight |
| 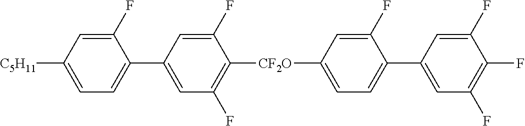 | (1′-2-1) | 3.00% by weight |
| 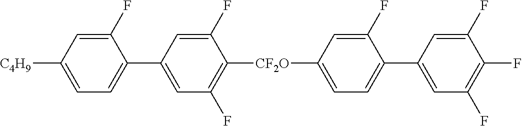 | (1′-2-1) | 3.00% by weight |
| 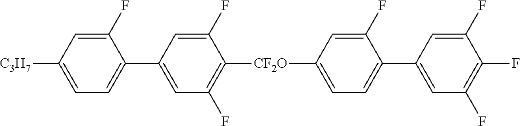 | (1′-2-1) | 3.00% by weight |
| 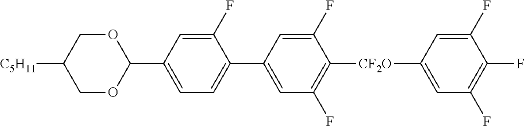 | (2′-1-1) | 9.00% by weight |
| 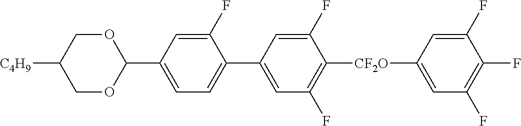 | (2′-1-1) | 9.00% by weight |
| 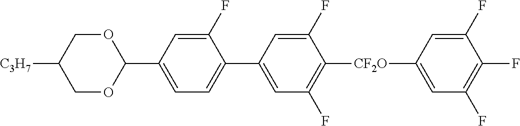 | (2′-1-1) | 8.40% by weight |
| 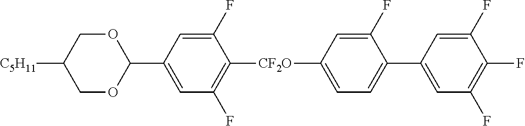 | (2′-2-1) | 15.00% by weight |
| 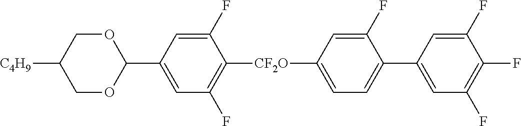 | (2′-2-1) | 15.00% by weight |
| 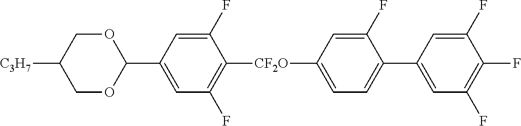 | (2′-2-1) | 15.00% by weight |

Phase transition temperature: N 88.7-89.0 I

### Comparative Example 2 Preparation of Chiral Liquid Crystal Composition (CLC)

Chiral liquid crystal composition CLC-R was prepared by mixing nematic liquid crystal composition NLC-R and chiral agent CD1. A composition and a phase transition temperature are shown.

| | | |
|---|---|---|
| NLC-R | 95.2% | by weight |
| CD1 | 4.8% | by weight |

Phase transition point: N*80.4-80.5 BP 82.3 I

### Comparative Example 3

Liquid crystal composition MLC-R was prepared by heating and mixing a mixture of the thus prepared chiral liquid crystal composition CLC-R with a polymerizable monomer in an isotropic phase. A composition and a phase transition temperature are shown.

| | | |
|---|---|---|
| CLC-R | 88.4% | by weight |
| n-hexadecyl acrylate | 6.2% | by weight |
| LCA-12 | 5.2% | by weight |
| DMPA | 0.4% | by weight |

Phase transition point: N*52.8-53.2 BP 57.0 I

### Comparative Example 4 Cell in which a Polymer-Liquid Crystal Composite Material was Interposed

In a manner similar to the method in Example 4, a polymerization reaction was performed by irradiation for 7 minutes under UV exposure conditions 2: ultraviolet light (ultraviolet light intensity: 23 nWcm⁻² (365 nm)) to prepare a cell in which polymer-liquid crystal composite material PSBP-R was interposed therebetween (cell thickness: 7.6 μm).

### Comparative Example 5 Optical System Using a Cell

In a manner similar to the method in Example 5, a relationship between applied voltage and transmittance of the polymer-liquid crystal composite material was examined at room temperature. Values of physical properties of the polymer-liquid crystal composite material (PSBP) interposed by the cell were as described below.

Saturation voltage: 60.4 V, contrast ratio: 1080, response time during voltage application: 0.56 ms, response time during no voltage application: 0.53 ms, polymerization temperature: 52.8° C.

Even if all of the thus obtained polymer-liquid crystal composite materials PSBP-1 to PSBP-23 and PSBP-R were cooled to room temperature, the materials maintained an optically isotropic liquid crystal phase.

CLC-7 is a composition in which compound (3) was added to CLC-R.

In PSBP-7, the saturation voltage was 45.4 V, the contrast ratio was 1062.6, and in comparison with PSBP-R (the saturation voltage was 60.4 V, and the contrast ratio was 1080), the contrast ratio was equivalent, but driving voltage was decreased. The compound in which compound (3) was combined with compound (1′) and compound (2′) was found to be effective in a decrease of the driving voltage.

As is obvious from the Examples, the optical device of the invention is low in a driving voltage, high in contrast and fast in a response time, and therefore is superior to a conventional technology.

### INDUSTRIAL APPLICABILITY

Specific examples of methods of utilizing the invention include an optical device such as a display device in which a polymer-liquid crystal composite is used.

### REFERENCE SIGNS LIST

1. Electrode
2. Electrode
3. Light source
4. Polarizer
5. Comb-shaped electrode cell
6. Analyzer
7. Photodetector

1. A liquid crystal composition that contains achiral component T including at least one compound selected from compounds represented by formula (1) and at least one compound selected from compounds represented by formula (2), and a chiral agent to develop an optically isotropic liquid crystal phase: 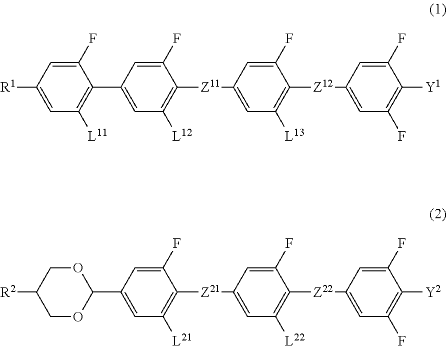
wherein, in formulas (1) and (2), R¹ and R² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12, in which at least one of R¹ and R² is alkoxyalkyl in which a total of the number of carbons is 1 to 12; Z¹¹, Z¹², Z²¹ and Z²² are independently a single bond, —COO— and —CF₂O—, in which one of Z¹¹ and Z¹² is —CF₂O— or —COO—, and the other is a single bond, and one of Z²¹ and Z²² is —CF₂O— or —COO—, and the other is a single bond; L¹¹ to L¹³, L²¹ and L²² are independently hydrogen, fluorine or chlorine; and Y¹ and Y² are independently fluorine, chlorine, —CF₃ or —OCF₃.

2. The liquid crystal composition according to claim 1, wherein a proportion of the compound represented by formula (1) is in the range of 5% by weight to 65% by weight, and a proportion of the compound represented by formula (2) is in the range of 25% by weight to 90% by weight, based on the weight of the liquid crystal composition.

3. The liquid crystal composition according to claim 1, containing at least one compound selected from compounds represented by formula (1′) as a first component, at least one compound selected from compounds represented by formula (2′) as a second component, and at least one compound selected from compounds represented by formula (3) as a third component: 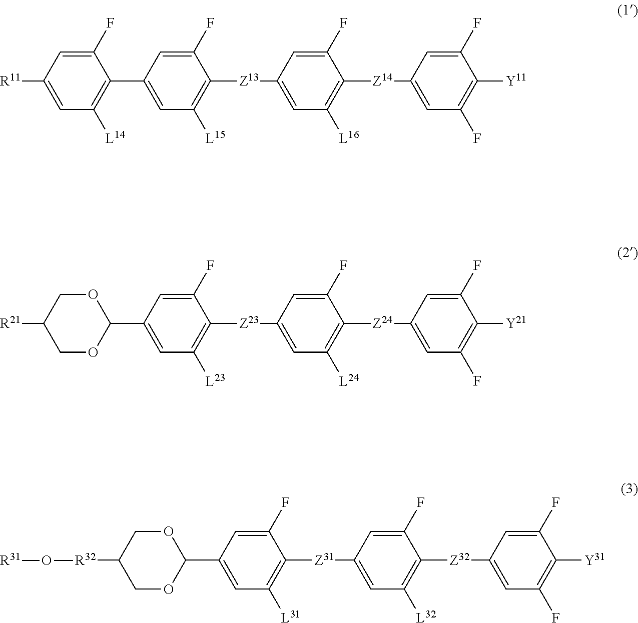
wherein, in formulas (1′), (2′) and (3), R¹¹ and R²¹ are independently alkyl having 1 to 12 carbons, alkenyl having 2 to 12 carbons, alkynyl having 2 to 12 carbons or alkoxy having 1 to 11 carbons; R³¹ is independently alkyl having 1 to 12 carbons, alkenyl having 2 to 12 carbons, alkynyl having 2 to 12 carbons or alkoxy having 1 to 11 carbons; R³² is alkylene having 1 to 5 carbons, alkenylene having 2 to 5 carbons or alkynylene having 2 to 5 carbons; Z¹³, Z¹⁴, Z²³, Z²⁴, Z³¹ and Z³² are independently a single bond, —COO— and —CF₂O—, in which one of Z¹³ and Z¹⁴ is —CF₂O— or —COO—, and the other is a single bond, one of Z²³ and Z²⁴ is —CF₂O— or —COO—, and the other is a single bond, and one of Z³¹ and Z³² is —CF₂O— or —COO—, and the other is a single bond; L¹⁴ to L¹⁶, L²³, L²⁴, L³¹ and L³² are independently hydrogen, fluorine or chlorine; and Y¹¹, Y²¹ and Y³¹ are independently fluorine, chlorine, —CF₃ or —OCF₃.

4. The liquid crystal composition according to claim 3, wherein a proportion of the compound represented by formula (1′) is in the range of 5% by weight to 65% by weight, a proportion of the compound represented by formula (2′) is in the range of 15% by weight to 80% by weight, and a proportion of the compound represented by formula (3) is in the range of 2% by weight to 40% by weight, based on the weight of the liquid crystal composition.

5. The liquid crystal composition according to claim 3, containing at least one compound selected from compounds represented by formula (1′-1), and at least one compound selected from compounds represented by formula (1′-2) as the first component: 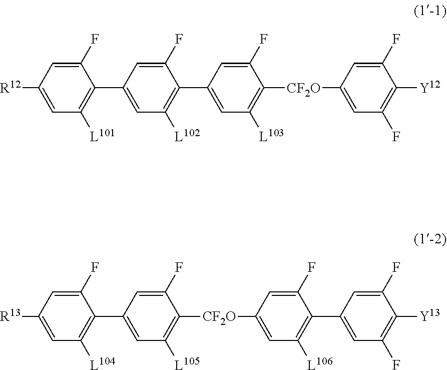
wherein, in formulas (1′-1) and (1′-2), R¹² and R¹³ are independently alkyl having 1 to 12 carbons, alkenyl having 2 to 12 carbons, alkynyl having 2 to 12 carbons or alkoxy having 1 to 11 carbons; L^{1O1} to L¹⁰⁵ and L¹⁰⁶ are independently hydrogen, fluorine or chlorine; and Y¹² and Y¹³ are independently fluorine, chlorine, —CF₃ or —OCF₃.

6. The liquid crystal composition according to claim 5, containing at least one compound selected from the group of compounds represented by formulas (1′-1-1) to (1′-1-3), and at least one compound selected from the group of compounds represented by formulas (1′-2-1) to (1′-2-6) as the first component: 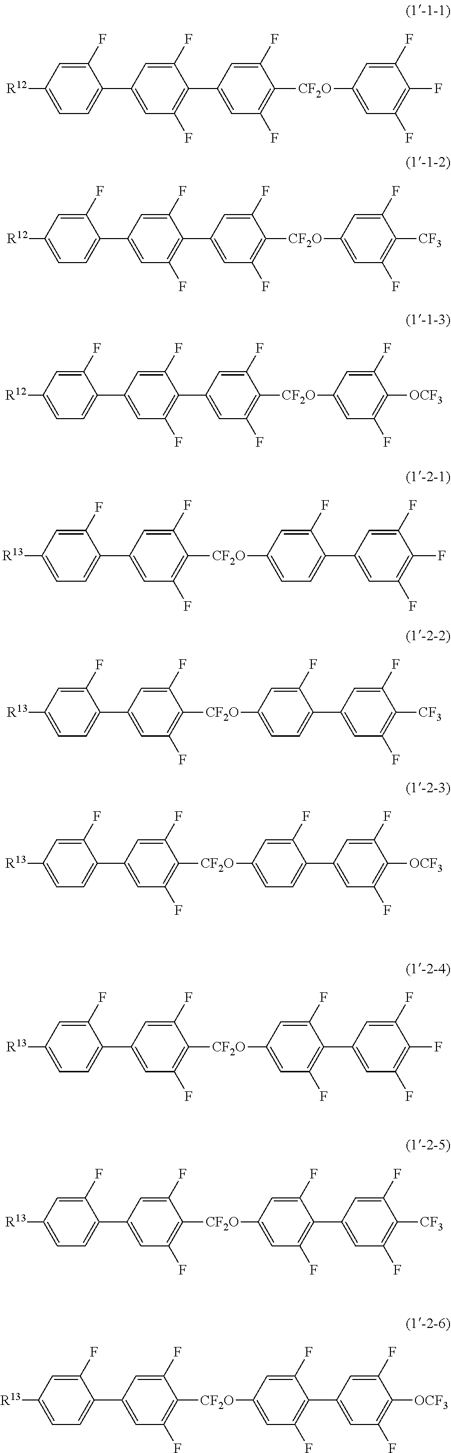
wherein, in the formulas, R¹² and R¹³ are independently alkyl having 1 to 12 carbons, alkenyl having 2 to 12 carbons, alkynyl having 2 to 12 carbons or alkoxy having 1 to 11 carbons.

7. The liquid crystal composition according to claim 3, containing at least one compound selected from compounds represented by formula (2′-1), and at least one compound selected from compounds represented by formula (2′-2) as the second component: 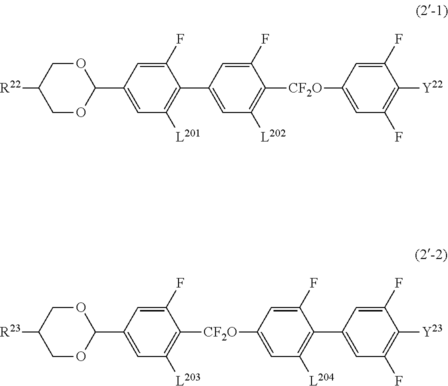
wherein, in formulas (2′-1) and (2′-2), R²² and R²³ are independently alkyl having 1 to 12 carbons, alkenyl having 2 to 12 carbons, alkynyl having 2 to 12 carbons or alkoxy having 1 to 11 carbons; L²⁰¹ to L²⁰³ and L²⁰⁴ are independently hydrogen, fluorine or chlorine; and Y²² and Y²³ are independently fluorine, chlorine, —CF₃ or —OCF₃.

8. The liquid crystal composition according to claim 7, containing at least one compound selected from the group of compounds represented by formulas (2′-1-1) to (2′-1-3), and at least one compound selected from the group of compounds represented by formulas (2′-2-1) to (2′-2-6) as the second component: 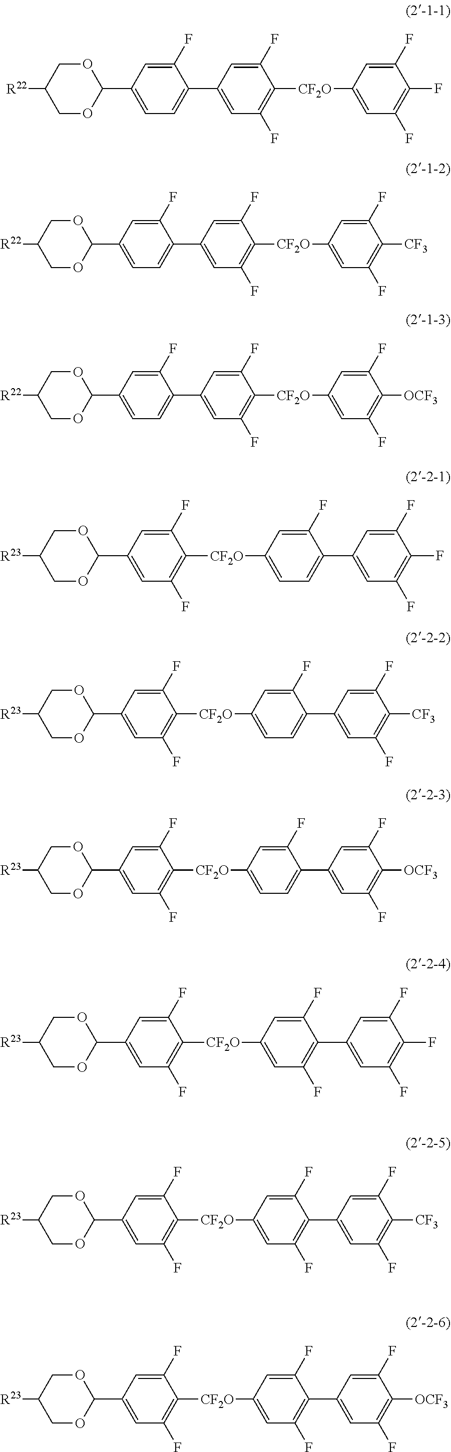
wherein, in the formulas, R²² and R²³ are independently alkyl having 1 to 12 carbons, alkenyl having 2 to 12 carbons, alkynyl having 2 to 12 carbons or alkoxy having 1 to 11 carbons.

9. The liquid crystal composition according to claim 3, containing at least one compound selected from the group of compounds represented by formulas (3-1) and (3-2) as the third component: 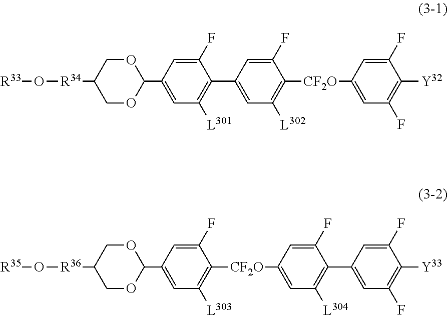
wherein in formulas (3-1) and (3-2), R³³ and R³⁵ are independently alkyl having 1 to 12 carbons, alkenyl having 2 to 12 carbons, alkynyl having 2 to 12 carbons or alkoxy having 1 to 11 carbons, and O atoms are not directly connected with each other; R³⁴ and R³⁶ are independently alkylene having 1 to 5 carbons, alkenylene having 2 to 5 carbons or alkynylene having 2 to 5 carbons; L³⁰¹ to L³⁰³ and L³⁰⁴ are independently hydrogen, fluorine or chlorine; and Y³² and Y³³ are independently fluorine, chlorine, —CF₃ or —OCF₃.

10. The liquid crystal composition according to claim 9, containing at least one compound selected from the group of compounds represented by formulas (3-1-1) to (3-1-3) or formulas (3-2-1) to (3-2-6) as the third component: 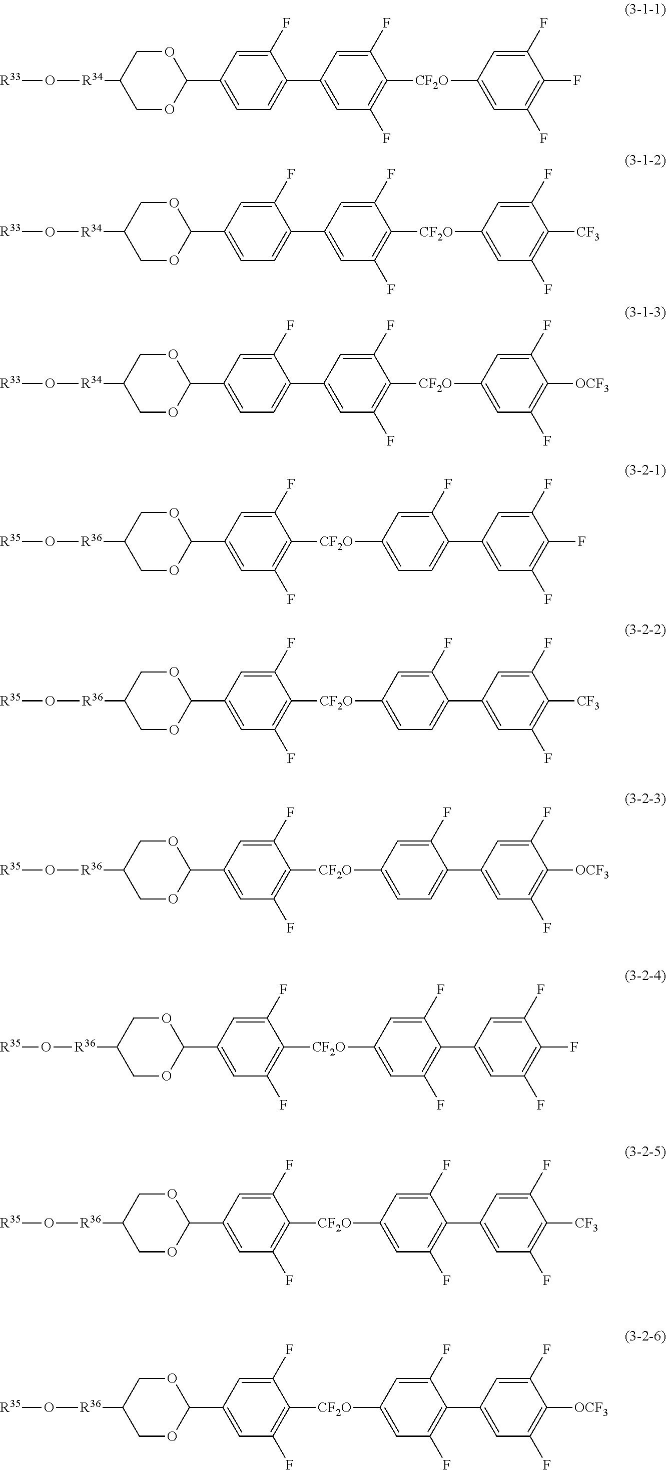
wherein, in the formulas, R³³ and R³⁵ are independently alkyl having 1 to 12 carbons, alkenyl having 2 to 12 carbons, alkynyl having 2 to 12 carbons or alkoxy having 1 to 11 carbons, and O atoms are not directly connected with each other; and R³⁴ and R³⁶ are independently alkylene having 1 to 5 carbons, alkenylene having 2 to 5 carbons or alkynylene having 2 to 5 carbons.

11. The liquid crystal composition according to claim 1, further containing at least one compound selected from the group of compounds represented by formulas (4) and (5): 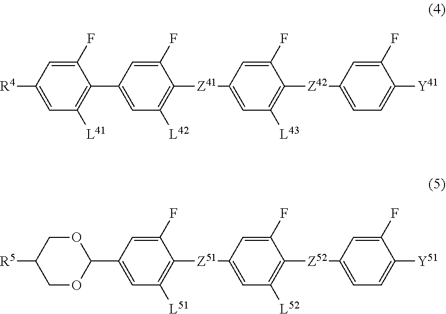
wherein, in formulas (4) and (5), R⁴ and R are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; Z⁴¹, Z⁴², Z⁵¹ and Z⁵² are independently a single bond, —COO— and —CF₂O—, in which one of Z⁴¹ and Z⁴² is —CF₂O— or —COO—, and the other is a single bond, and one of Z⁵¹ and Z⁵² is —CF₂O— or —COO—, and the other is a single bond; L⁴¹ to L⁴³, L⁵¹ and L⁵² are independently hydrogen, fluorine or chlorine; and Y⁴¹ and Y⁵¹ are independently fluorine, chlorine, —CF₃ or —OCF₃.

12. The liquid crystal composition according to claim 11, wherein a proportion of the compound represented by formulas (4) and (5) is in the range of 1% by weight to 25% by weight based on the weight of the liquid crystal composition.

13. The liquid crystal composition according to claim 11, containing at least one compound selected from the group of compounds represented by formulas (4-1), (4-2), (5-1) and (5-2): 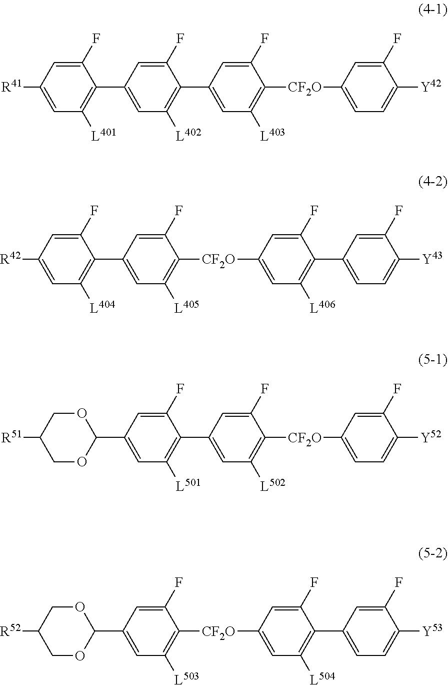
wherein, in formulas (4-1), (4-2), (5-1) and (5-2), R⁴¹, R⁴², R⁵¹ and R⁵² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; L⁴⁰¹ to L⁴⁰⁶, L⁵⁰¹ to L⁵⁰³ and L⁵⁰⁴ are independently hydrogen, fluorine or chlorine; and Y⁴², Y⁴³, Y⁵² and Y⁵³ are independently fluorine, chlorine, —CF₃ or —OCF₃.

14. The liquid crystal composition according to claim 13, containing at least one compound selected from the group of compounds represented by formulas (4-1-1) to (4-1-3), formulas (4-2-1) to (4-2-6), formulas (5-1-1) to (5-1-3) or formulas (5-2-1) to (5-2-6): 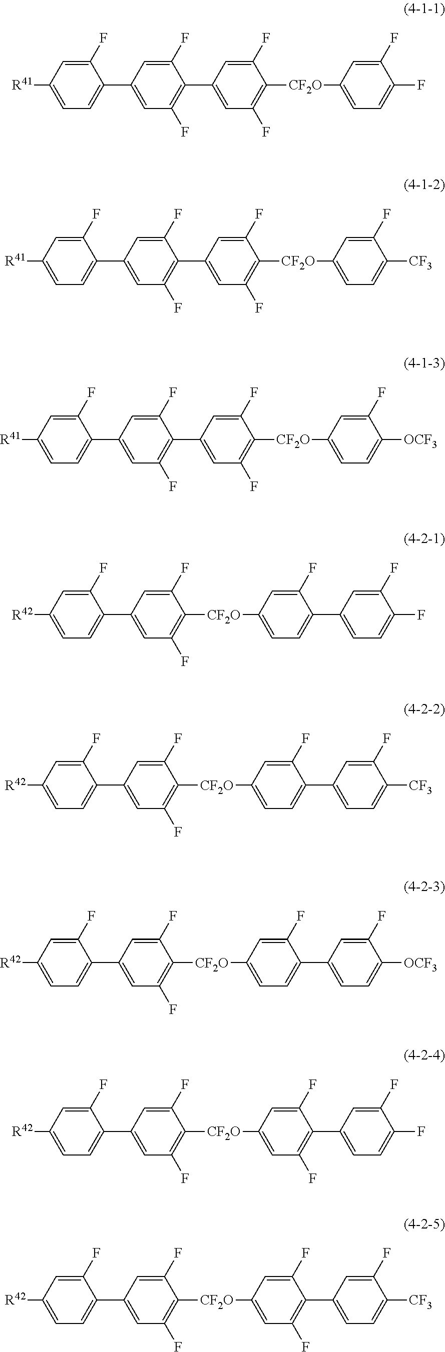 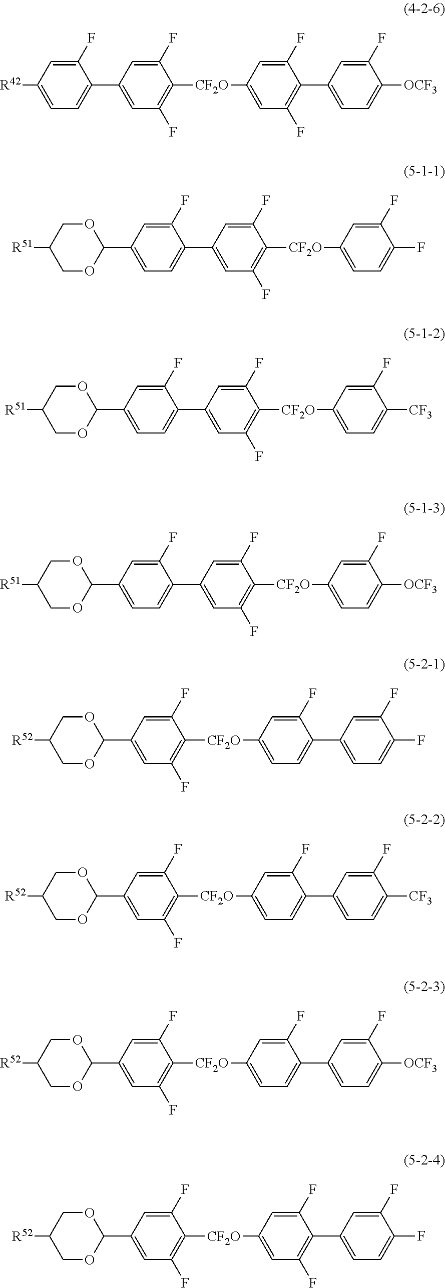 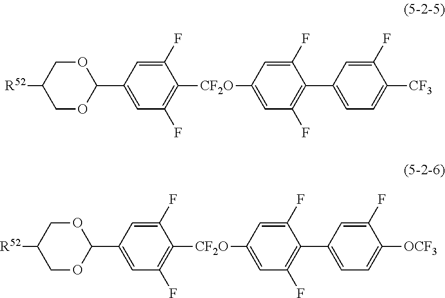
wherein, in the formulas, R⁴¹, R⁴², R⁵¹ and R⁵² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12.

15. The liquid crystal composition according to claim 1, further containing at least one compound selected from the group of compounds represented by formulas (6) and (7): 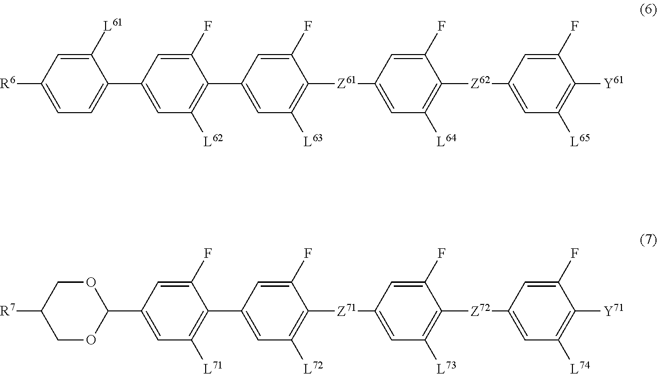
wherein, in formulas (6) and (7), R⁶ and R⁷ are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; Z⁶¹, Z⁶², Z⁷¹ and Z⁷² are independently a single bond, —COO— and —CF₂O—, in which one of Z⁶¹ and Z⁶² is —CF₂O— or —COO—, and the other is a single bond, and one of Z⁷¹ and Z⁷² is —CF₂O— or —COO—, and the other is a single bond; L⁶¹ to L⁶⁵, L⁷¹ to L⁷³ and L⁷⁴ are independently hydrogen, fluorine or chlorine; and Y⁶¹ and Y⁷¹ are independently fluorine, chlorine, —CF₃ or —OCF₃.

16. The liquid crystal composition according to claim 15, wherein a proportion of the compound represented by formulas (6) and (7) is in the range of 0.1% by weight to 20% by weight based on the weight of the liquid crystal composition.

17. The liquid crystal composition according to claim 15, containing at least one compound selected from the group of compounds represented by formulas (6-1), (6-2), (7-1) and (7-2): 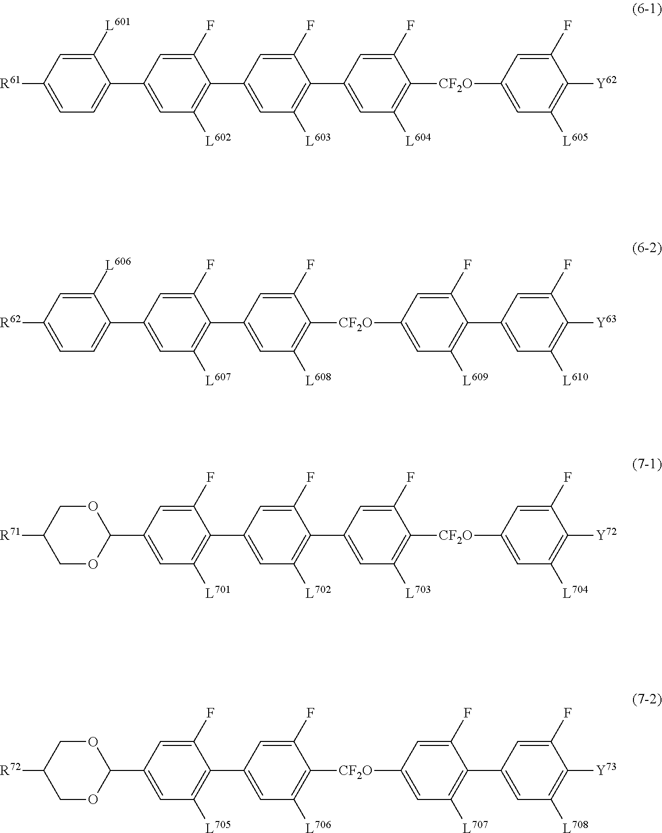
wherein, in formulas (6-1), (6-2), (7-1) and (7-2), R⁶¹, R⁶², R⁷¹ and R⁷² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; L⁶⁰¹ to L⁶¹⁰, L⁷⁰¹ to L⁷⁰⁷ and L⁷⁰⁸ are independently hydrogen, fluorine or chlorine; and Y⁶², Y⁶³, Y⁷² and Y⁷³ are independently fluorine, chlorine, —CF₃ or —OCF₃.

18. The liquid crystal composition according to claim 17, containing at least one compound selected from the group of compounds represented by formulas (6-1-1) to (6-1-6), formulas (6-2-1) to (6-2-6), formulas (7-1-1) to (7-1-6) or formulas (7-2-1) to (7-2-6): 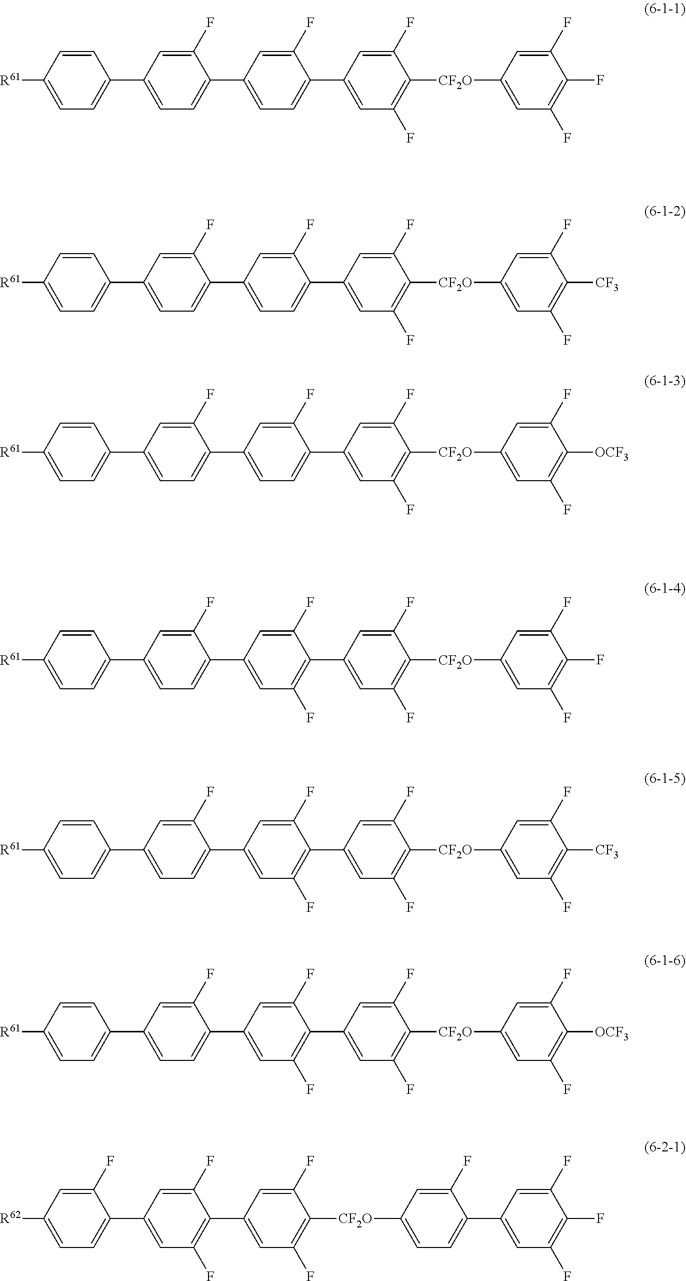 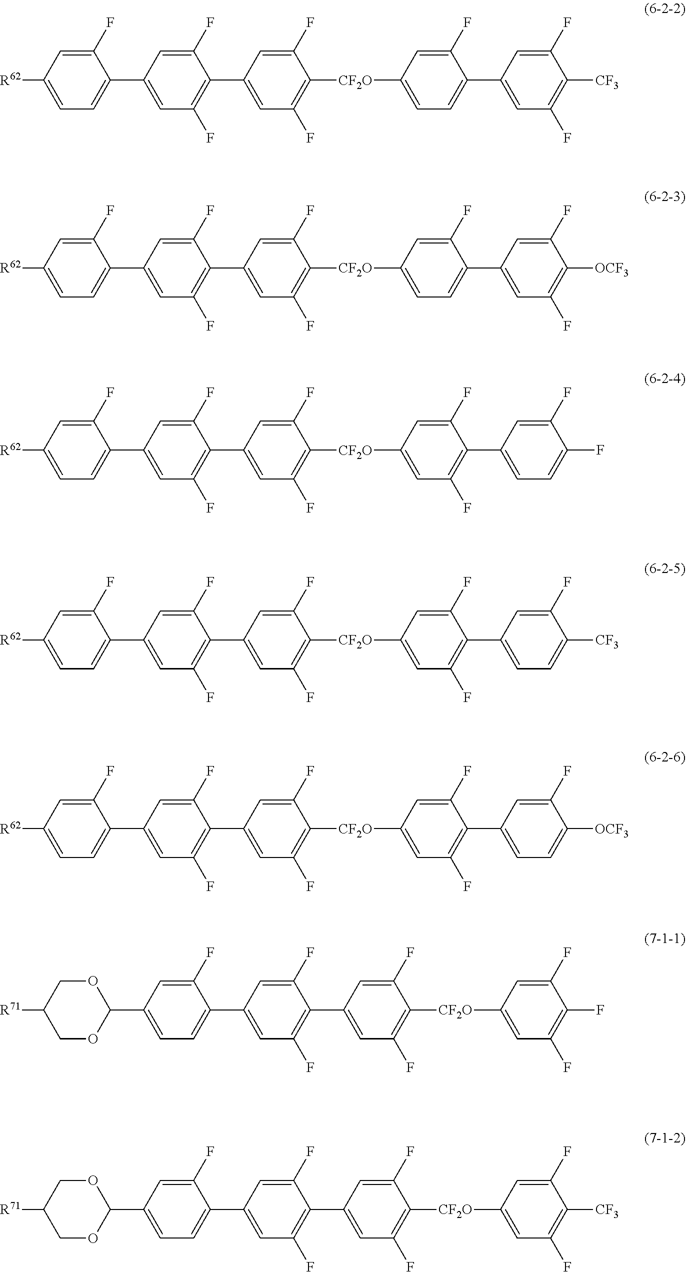 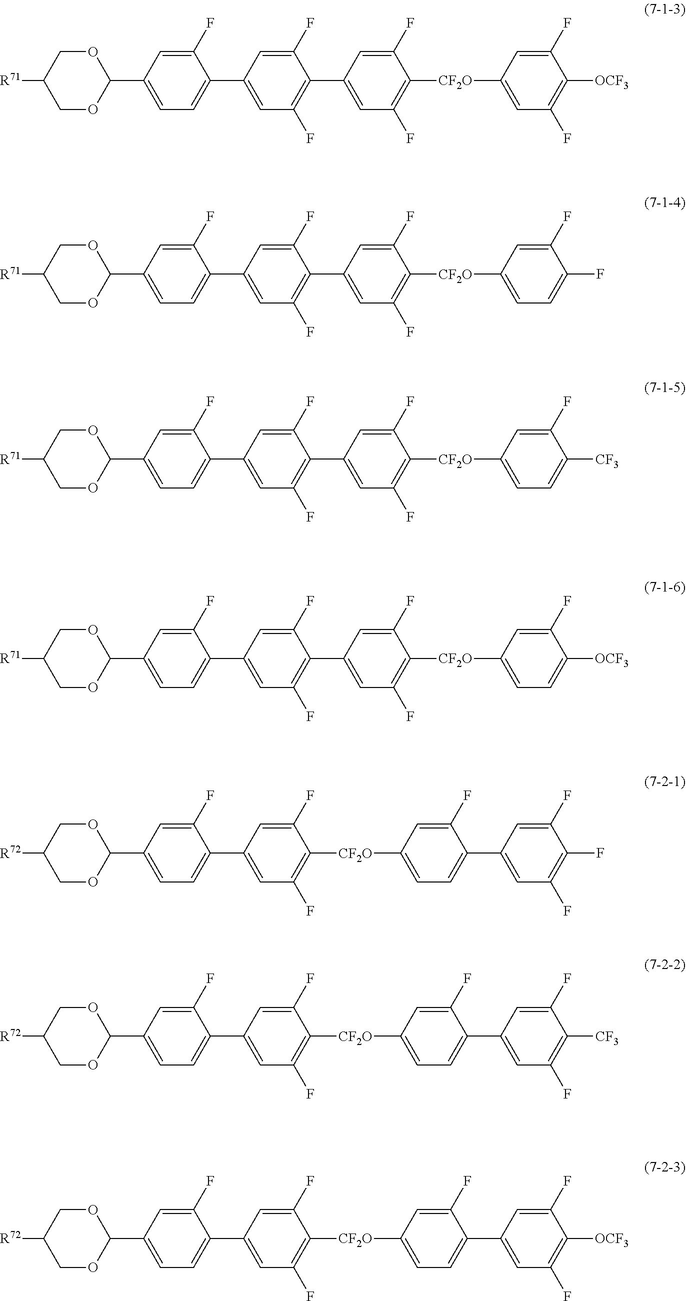 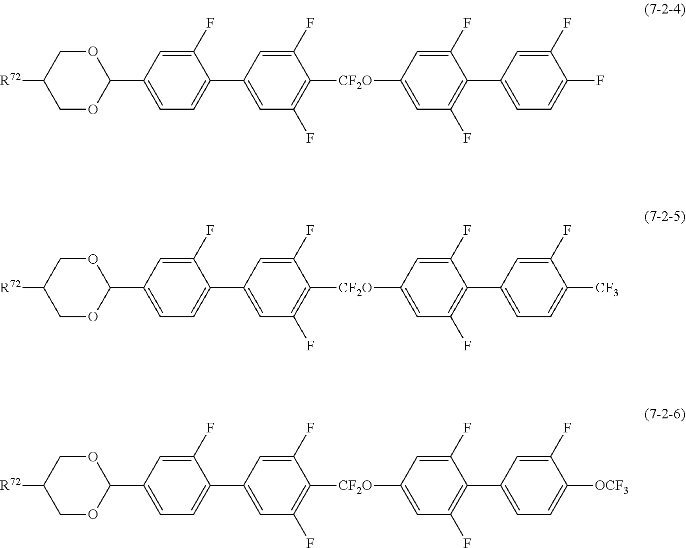
wherein, in the formulas, R⁶¹, R⁶², R⁷¹ and R⁷² are independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12.

19. The liquid crystal composition according to claim 1, further containing at least one compound selected from compounds represented by formula (8): 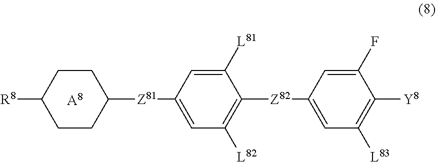
wherein, in formula (8), R⁸ is alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12; ring A⁸ is 1,4-cyclohexylene, 1,4-phenylene, 2-fluoro-1,4-phenylene, 3-fluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl; Z⁸¹ and Z⁸² are independently a single bond, —COO—, —CH₂CH₂—, —CH₂O— and —CF₂O—; L⁸¹, L⁸² and L⁸³ are independently hydrogen, fluorine or chlorine; and Y⁸ is fluorine, chlorine, —CF₃ or —OCF₃.

20. The liquid crystal composition according to claim 19, wherein a proportion of the compound represented by formula (8) is in the range of 0.1% by weight to 15% by weight based on the weight of the liquid crystal composition.

21. The liquid crystal composition according to claim 19, containing at least one compound selected from the group of compounds represented by formulas (8-1) to (8-11): 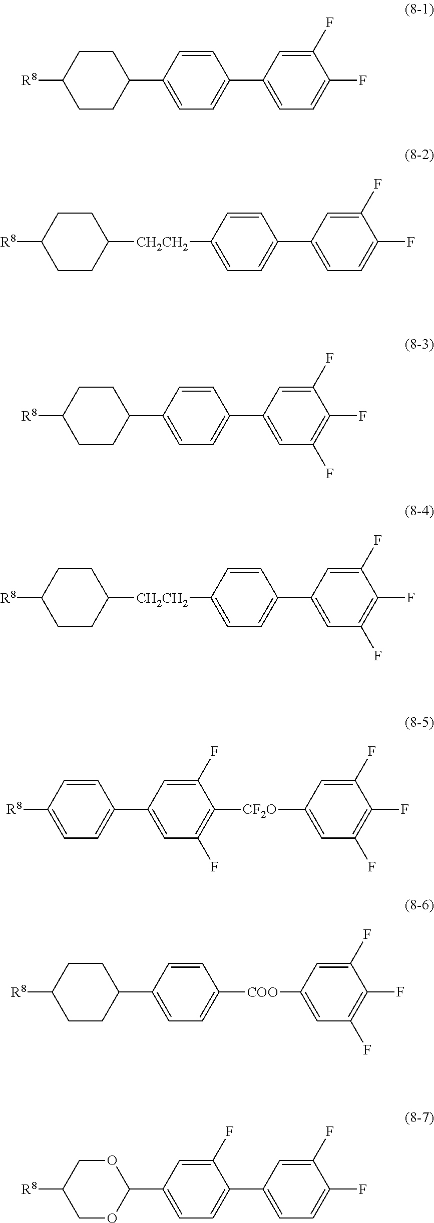 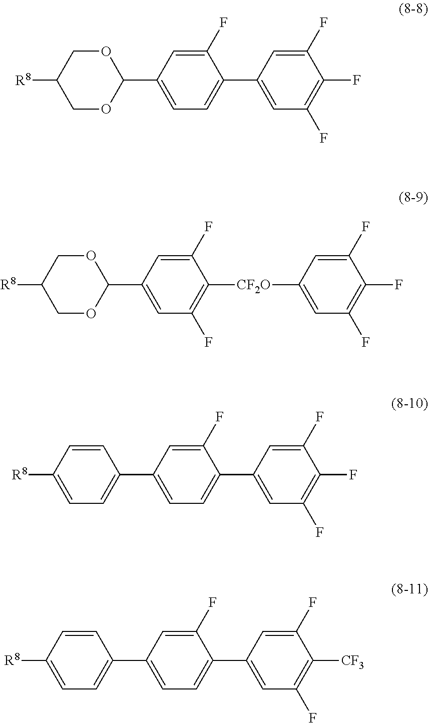
wherein, in the formulas, R⁸ is independently alkyl having 1 to 12 carbons, alkenyl having 2 to 12 carbons, alkynyl having 2 to 12 carbons, alkoxy having 1 to 11 carbons, or alkoxyalkyl in which a total of the number of carbons is 1 to 12.

22. The liquid crystal composition according to claim 1, wherein the chiral agent is at least one compound selected from the group of compounds represented by formulas (K1) to (K6): 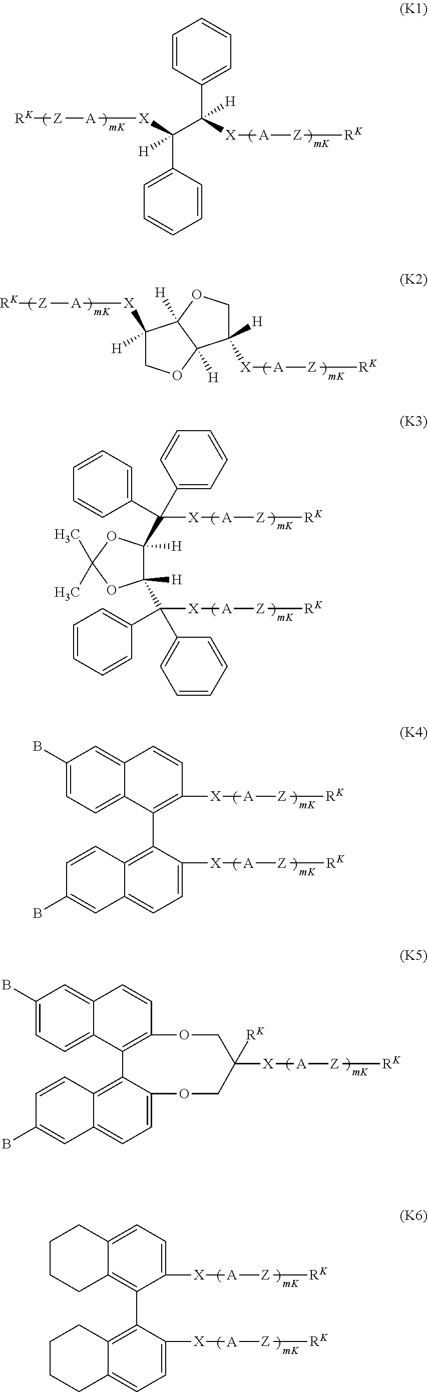
wherein, in the formulas, R^{K} is each independently hydrogen, halogen, —C≡N, —N═C═O, —N═C═S or alkyl having 1 to 20 carbons, and at least one —CH₂— in the alkyl may be replaced by —O—, —S—, —COO— or —OCO—, at least one —CH₂—CH₂— in the alkyl may be replaced by —CH═CH—, —CF═CF— or —C≡C—, and at least one hydrogen in the alkyl may be replaced by fluorine or chlorine;
A is each independently an aromatic 6-membered to 8-membered ring, a non-aromatic 3-membered to 8-membered ring or a fused ring having 9 or more carbons, and at least one hydrogen in the rings may be replaced by halogen, or alkyl or haloalkyl each having 1 to 3 carbons, —CH₂— in the rings may be replaced by —O—, —S— or —NH—, and —CH═ may be replaced by —N═;
B is each independently hydrogen, halogen, alkyl having 1 to 3 carbons, haloalkyl having 1 to 3 carbons, an aromatic 6-membered to 8-membered ring, a non-aromatic 3-membered to 8-membered ring or a fused ring having 9 or more carbons, and at least one hydrogen in the rings may be replaced by halogen, or alkyl or haloalkyl each having 1 to 3 carbons, —CH₂— in the alkyl may be replaced by —O—, —S— or —NH—, and —CH═ may be replaced by —N═;
Z is each independently a single bond or alkylene having 1 to 8 carbons, and at least one —CH₂— in the alkylene may be replace by —O—, —S—, —COO—, —OCO—, —CSO—, —OCS—, —N═N—, —CH═N— or —N═CH—, at least one —CH₂—CH₂— in the alkylene may be replaced by —CH═CH—, —CF═CF— or —C≡C—, and at least one hydrogen in the alkylene may be replaced by halogen;
X is each independently a single bond, —COO—, —OCO—, —CH₂O—, —OCH₂—, —CF₂O—, —OCF₂— or —CH₂CH₂—; and
mK is each independently an integer from 1 to 4.

23. The liquid crystal composition according to claim 1, exhibiting a chiral nematic phase in any temperature from −20° C. to 70° C., and having a helical pitch of 700 nanometers or less in at least part of the temperature range.

24. A mixture, containing the liquid crystal composition according to claim 1 and a polymerizable monomer.

25. A polymer-liquid crystal composite material, obtained by polymerizing the mixture according to claim 24 and used in a device driven in an optically isotropic liquid crystal phase.

26. An optical device, having electrodes arranged on one or both of substrates, and having a liquid crystal medium arranged between the substrates, and an electric field applier for applying an electric field to the liquid crystal medium through the electrodes, wherein the liquid crystal medium is the liquid crystal composition according to claim 1.

27. Use of the liquid crystal composition according to claim 1 in an optical device.

28. An optical device, having electrodes arranged on one or both of substrates, and having a liquid crystal medium arranged between the substrates, and an electric field applier for applying an electric field to the liquid crystal medium through the electrodes, wherein the liquid crystal medium is the polymer-liquid crystal composite material according to claim 25.

29. Use of the polymer-liquid crystal composite material according to claim 25 in an optical device.
